(19) United States
(12) Patent Application Publication
(10) Pub. No.: US 2008/0147567 A1
(43) Pub. Date: Jun. 19, 2008

(54) METHOD FOR PROVIDING A WEALTH MANAGEMENT SERVICE

(75) Inventors: HENRY A. PERRY, Tequesta, FL (US); STEPHEN E. BARIMO, Jupiter, FL (US); KIRBY S. ROSPLOCK, Jupiter, FL (US); DARRYL SMITH, Mena, AR (US); DEVON LAZARUS, Santa Barbara, CA (US)

Correspondence Address: MAYER BROWN LLP, P.O. BOX 2828, CHICAGO, IL, 60690, US

(73) Assignee: ASSET MANAGEMENT ADVISORS, LLC

(21) Appl. No.: 11/612,474

(22) Filed: Dec. 19, 2006

(51) Int. Cl. G06Q 40/00

(52) U.S. Cl. 705/36 R

(57) ABSTRACT

A method for providing wealth management services to a family is provided. This wealth management method comprises the steps of collecting family information, collecting information about legal entities where family members are involved, performing a plurality of wealth management reviews, surveying a plurality of considerations related to wealth management, establishing a family governance system, and formulating a family plan for wealth preservation, wherein the family plan is a multi-generational plan. The benefits of this plan include integrating three dimensions of family wealth—human, intellectual and financial capital for long-term preservation of wealth. The value of this invention comes from the combination of activities that begins with building the tactical aspects of wealth management, continues with the strategic aspects and results in long-term wealth preservation.

### PRIORITY INFORMATION

This application claims priority of provisional application Ser. No. 60/751,369, filed on Dec. 16, 2005.

### BACKGROUND OF THE INVENTION

1. Field of the Invention

The present invention relates to providing wealth management services, and, more particularly, to providing a method for wealth management services that incorporates financial as well as non-financial considerations.

2. Description of Related Art

As more families are contemplating the transfer of massive amounts of financial wealth, by some estimates, more than $40 trillion over the next forty (40) years, families are acutely focused on whether their financial success will be sustained. Statistically, more than ninety seven per cent (97%) of families with considerable wealth see their financial capital dissipate within three generations, and seventy per cent (70%) fail to sustain their wealth from one generation to the next.

Currently, when typical wealth management systems work with clients to assess and plan their financial success, they focus only on the investable (liquid) financial assets of a family. Such systems often do not consider all of a client's financial assets nor integrate them into an overall strategy. Furthermore, such wealth management systems do not take into account or alert families to such other disciplines as risk management over all financial assets, stated objectives or “investment policies” for investments, and estate planning. Also, most importantly, providers have historically failed to integrate the management of a clients financial assets with its non-financial or human and intellectual assets, including the disciplines of family governance, philanthropy and learning.

Thus, currently available wealth management systems only employ investment and other financial planning solutions and strategies in organizing and planning a family's wealth, ignoring the impact that non-financial aspects of family wealth have on financial success. For example, research shows that the failure of current systems to address, study, or plan for the family governance structure or the non-financial values that are shared by the family members has led to the historic failure of families to sustain their wealth beyond three generations—a phenomenon that is universally knows as “shirtsleeves to shirtsleeves in three generations”. This saying is commonly found in different cultures around the world and is used to describe the inability or failure rate (by some estimates up to 97%) of families to retain their wealth. Ultimately, current wealth management systems are limited in scope and do not encompass the broad range of activities, financial and non-financial, that are required.

While investment solutions are important to wealth management, everything related to long-term preservation of a family's wealth cannot be addressed strictly through financial solutions. As a result, the current wealth management systems cannot and do not plan for many aspects of family wealth.

The current systems also merely analyze the clients' present wealth, without implementing safeguards against the dissipation of the wealth over the future generations. In other words, they do not consider or perform generational planning. There are numerous problems associated with that approach. Besides the prevailing problem of the dissipation of wealth, such approach causes families to be shortsighted and unnecessarily narrow in their wealth management goals.

The current approach to wealth management also causes family member to view and treat themselves as sovereign units, un-integrated with other family members or the members' present and future progeny. Consequently, such systems do not provide a wealth management solution that addresses the shared financial as well as non-financial objectives of all the family members; those present now and those not yet born. The currently available wealth management systems also do not concern themselves with education and mentoring of family members. As a result, the dissipation of wealth over succeeding generations is overlooked and sometimes unavoidable under the presently practiced schemes.

It would therefore be desirable to provide a better method of providing wealth management services. Ultimately, it would be desirable to provide a better way for families to manage their wealth in a way that will allow it to last through the generations.

### SUMMARY OF THE INVENTION

The method of providing wealth management according to the present invention ensures that clients are constantly considering the comprehensive and long-term view of their wealth and helps wealthy families preserve their wealth over generations. This new method represents a disciplined approach to putting in place the organization, programs, and structure that will preserve and grow family wealth across generations. It addresses three dimensions of family wealth—human, intellectual and financial capital and encompasses unique practices that will help families sustain their success. The present method is the means by which to help families to create a roadmap to the achievement of their broadest family wealth objectives and is what helps families perpetuate their wealth.

As mentioned, three dimensions of family wealth—human, intellectual and financial capital are evaluated, monitored and served in the wealth management system. Human capital is related to who the individual family members are and who the family is as a whole. Intellectual capital is what the individual family members know and what the family as a collective unit holds in terms of intellectual capital. Financial capital relates to what the family actually owns in physical assets such as property, liquid assets, homes, etc. The compilation of these three capitals is taken into account in this particular wealth management system.

The value of this invention comes from the combination and order of activities that begins with building the tactical aspects of wealth management, continues with the strategic aspects and results in long-term wealth preservation. Success is predicated on family discovery and the various planning activities that take place in Phases I and II but the key to success lies with the shift in focus toward strategic wealth management. Wealth Priorities™ considerations is the bridge that connects tactical to strategic wealth management and sets in motion the institution of a governance system that leads to long-term family wealth creation.

Through each phase, this new wealth management process increases exponentially the chances for families to sustain their wealth across generations. Because anyone can spend wealth in one generation, the present method helps prevent that by encouraging collaboration and partnership, including the cooperation of people not yet born. A family's success depends on more than sound investing. Managing family wealth to last across the generations involves bringing people together, finding common goals, and managing human and intellectual resources, as well as financial capital.

Thus, in one respect, an embodiment of the present invention may comprise (1) collecting family information, (2) collecting information about legal entities where family members are involved, (3) performing a plurality of wealth management reviews, (4) surveying a plurality of considerations related to wealth management, (5) establishing a family governance system, and (6) developing a family plan for wealth preservation during the course of performing the preceding steps.

In another respect, the method of providing wealth management services according to the present invention may comprise (1) collecting family information, (2) collecting information about legal entities where family members are involved, (3) performing a financial review, (4) performing an estate plan review, (5) performing a risk management assessment, wherein the assessment addresses exposure to future liability, (6) performing an at least one investment policy statement, (7) performing an investment portfolio review, (8) identifying personal values of family members, (9) compiling a shared values report for the family based on the personal values of family members, (10) drafting a family mission statement based on the shared values report, (11) surveying a plurality of considerations related to wealth management, wherein the plurality of considerations related to wealth management is not exclusively financial in nature, and wherein the plurality of considerations comprises considerations related to family cohesiveness, family governance, mentoring, philanthropy, strategic issues and wealth objectives, and trusts and estates, (12) establishing a family constitution, (13) creating family entities to support the family constitution, (14) developing a legacy, (15) engaging family members in family learning programs, wherein family learning programs are programs where family members develop skills for supervising family wealth, and (16) developing a family plan for wealth preservation during the course of performing the preceding steps.

These and other aspects and advantages will become apparent to those of ordinary skill in the art by reading the following detailed description, with reference where appropriate to the accompanying drawings. Further, it should be understood that the foregoing summary is merely exemplary and is not intended to limit the scope of the invention as claimed.

### BRIEF DESCRIPTION OF THE DRAWINGS

FIG. 1 is a flow chart in accordance with an exemplary embodiment of the present invention.

FIG. 2 is a flow chart in accordance with an exemplary embodiment of the present invention.

FIG. 3 is a diagram of an exemplary embodiment in accordance with the present invention.

FIG. 4A is a graphic of an exemplary survey according to an exemplary embodiment of the present invention.

FIG. 4B is a graphic of an exemplary survey according to an exemplary embodiment of the present invention.

FIG. 5 is a graphic of a sample report table according to an exemplary embodiment of the present invention.

FIG. 6 is a flow chart in accordance with an exemplary embodiment of the present invention.

FIG. 7 is a block diagram of an exemplary embodiment of the present invention.

FIG. 8 is a block diagram of an exemplary embodiment of the present invention.

FIG. 9 is a diagram of an exemplary embodiment of the present invention.

FIG. 10 is a diagram of an exemplary embodiment of the present invention.

FIG. 11 is a diagram of an exemplary embodiment of the present invention.

FIG. 12 is table of an exemplary embodiment of the present invention.

### DETAILED DESCRIPTION OF AN EXEMPLARY EMBODIMENT

Overview of the Wealth Management Process

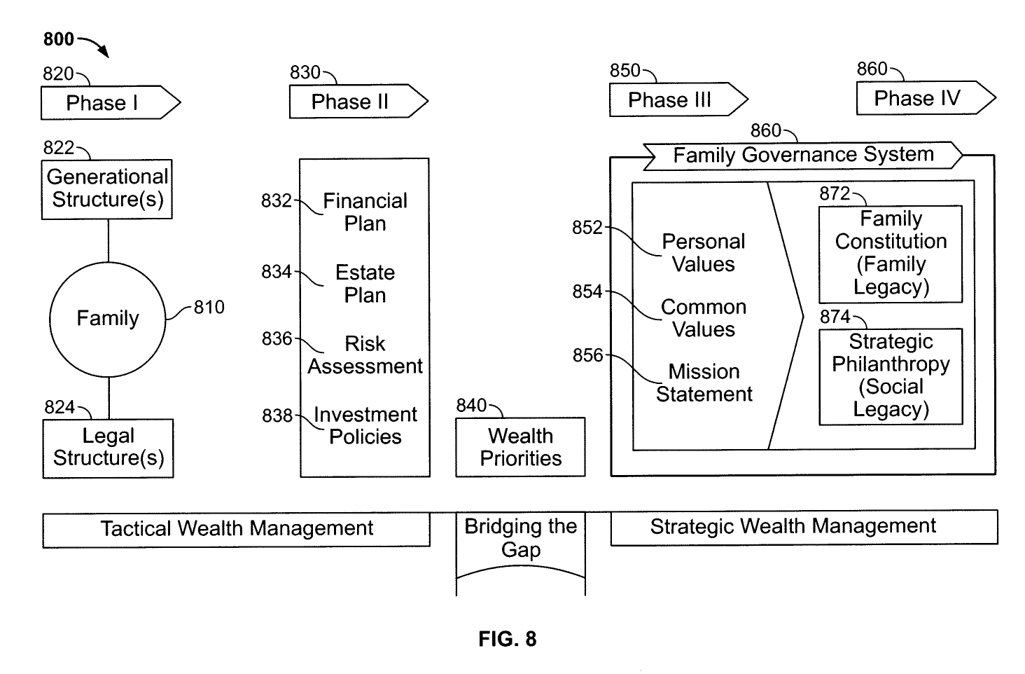

FIG. 8 is a simplified block diagram of the wealth management process 800 according to a preferred embodiment of the present invention. As shown in FIG. 8, the wealth management process 800 preferably consists of four phases. Phase I (820) and Phase II (830) may be considered tactical wealth management phases, whereas Phases III and IV may be considered strategic wealth management phases. Phase I (830) is the discovery phase. It entails breaking the family 810 down into its two main elements: the generational structures 822 and legal structures 824. These two elements are the common link across all phases. The generational structures 822 may be mapped out using a genogram which diagrams the individual family members and their relationship to each other. The legal structures 824 include abstracting and diagraming the family's legal entities. Taking these structures into consideration, the family 810 begins to document its financial goals as well as its method of communication and decision making.

Phase II (830) is the organization and planning phase. It includes a comprehensive review of a family's financial and legal lives and is conducted through integrating the planning and management of the two structures defined in Phase I (820). This includes documenting the family's financial assets and cash flow in a financial plan 832, analyzing the family's estate plan 834, conducting an assessment of the family's risk 836, and finally defining the family's investment philosophy and policies 838. These foundational activities provide a family with clarity and control over their financial capital. Phase I (820) and Phase II (830) also enable the family to concentrate on long-term planning in Phases III (850) and IV (860).

Between Phase II and III families may engage in surveying their Wealth Priorities™ considerations 840. Surveying Wealth Priorities™ considerations 840 bridges the gap from the foundational activities of wealth management in Phases I and II to strategic family governance, which is outlined in phases III and IV of the wealth management process. This bridge is where a family gains clarity around its priorities. This occurs through an assessment that outlines the 25 recognized considerations that help sustain wealth. The family prioritizes these considerations, which results in a long-term strategic action plan for wealth preservation and family governance.

Phase III (850) is the values and mission phase. It is the beginning of a family's 810 work toward the formal family governance of its generational and legal structures. This phase results in family governance system 860 and family governance policies—a family values list 854 and a family mission statement 856. The family values 854 are compiled from the personal values 852 of the members of the family 810. These documents outline the family's purpose and define a mission or direction toward which family members and legal entities should be managed. Phases III and IV together represent the creation of the formal governance system 860. Phase IV then represents the formalization of a governance system for a family's defined legacy. The values work in Phase III (850) serves as the underpinnings for the family's social legacy 874 and the family's family legacy 872, as further described in Phase IV (870).

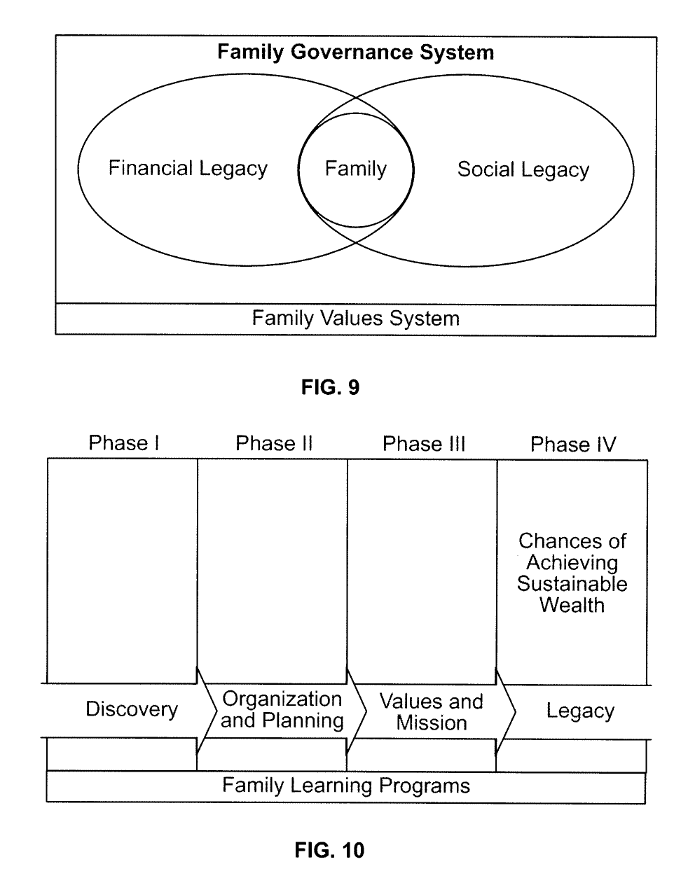

Phase IV (870) is the Legacy phase. It begins with continuing to define the family's governance. This occurs through helping the family define how they currently make decisions and to determine the style in which they want to make decisions as they evolve. Once this structure has been determined the family begins to document and formalize the family's policies and agreements in a family constitution and creates the entities, such as a family council or family board to support the constitution. This final phase of the process helps a family put in place the structures and programs that will lead to the fulfillment of their family legacy 872 and social legacy 874. Social legacy 874, as contemplated by this invention, is accomplished through strategic philanthropy. In Phase IV (870) families realize they are given the opportunity to build a social legacy 874 and are given the support to build a sustainable structure around their philanthropic activities. See FIG. 9.

The financial legacy of a family (not pictured), as contemplated by this invention, is defined by what the family wants its money to accomplish for its heirs. This legacy may be actualized through wealth, transfer activities. Examples of these activities include establishing an estate plan and plan for succession.

Communicating to family members about these documents is critical for successful wealth transfer. As mentioned previously, a cause of failure to sustain wealth is because wealth changes hands to a generation who has not been adequately prepared for this responsibility. An essential part of the process entails mentoring both the grantor and the beneficiaries. This education occurs throughout the process and through family learning programs.

Family Learning Programs, see FIG. 10, are a common thread that is carried throughout the wealth management process. Successful wealth preservation requires that family members develop the values, skills, and competencies needed to be good stewards of wealth. The invention includes family learning programs that occur throughout the process. They are mapped in three ways. First, the programs are mapped to values. Second, the programs are mapped to 4 of the 6 dimensions of wellness as defined and copyrighted by the National Wellness Institute. These four dimensions are emotional, social, intellectual, and occupational (the other two are spiritual and physical). Third, the programs are mapped to the “3-circle model” of family business as defined and copyrighted by Tagiuri and Davis, 1982. These three mappings are used separately and collectively to identify the most applicable programs for client families and family members. The programs prepare family members for the specific roles they will play in their family system and for their responsibilities of life with wealth. Family learning is critical for successful wealth transfer.

The wealth management process will now be discussed in greater detail with reference, where appropriate, to the drawings.

Phase I—Discovery

Referring to the drawings, FIG. 1 is an exemplary flow chart, depicting a method of providing wealth management services in accordance with Phase I of an exemplary embodiment of the present invention. At step 105, the wealth management process of the present invention collects historical and current information about family members. The historical and current information may be the generational structure of the family, which, in turn, may be presented in the form of a family genogram, illustrating all the members of the family and their relationship to each other. The historical and current information may also include the family's background, names, contact information for family members, marital status of its members, and other personal data. During this step, the family may also be asked to provide the history of its wealth and its goals for how to manage its wealth. Additionally, the family may be asked to discuss its current decision-making process.

At step 110, the wealth management process collects information about legal entities where family members are involved. Some legal entities contemplated by this step are trusts, individual retirement accounts (IRAs), foundations, donor advised funds, family investment vehicles, and family businesses. At this step, the individual family members may be asked to provide information about what legal entities they are involved with and how the entities may relate to one another. Information that may be considered pertinent about such legal entities is: date of formation, state of governing law, tax status, investment authority, purpose of the entity, structure of the entity, date of creation, etc. For example, if the legal entity is a trust, then the family may provide, in addition to the preceding, the name of grantor, fiduciary, and beneficiary, the legal classification of the trust, income payout provisions, financial information, any unusual provisions, etc. Additionally, the family member may be asked to provide information about any estate planning it may have done.

At step 115, the system may collect information about the legal entities where the family as a whole is involved. This is essentially identical to step 110, but encompasses the whole family, instead of individual family members. At the end of Phase I, all collected information may be compiled into summaries, reports, memoranda, or other similar memorializing device. Compiling of the information may be computerized, performed by a human, or a mix of both. The information provided in Phase I serves to familiarize the advisor of the wealth management system with the family and to obtain a detailed look at the family's background, structure, and current involvements.

During this phase, the family will also determine wealth objectives, or longer-term strategic goals that it may have for the family wealth. These wealth objectives are captured by the advisor in the family's strategic plan which is co-created with the client over the lifetime of the relationship. In addition, the family may also disclose to the administrator any pressing or time-sensitive issues or concerns, or critical issues that should be considered in the family's strategic plan. As a family moves on from Phase I to Phase II, the advisor of the family's wealth management process will continually reflect back on what was disclosed and documented in Phase I.

Phase II—Organization and Planning

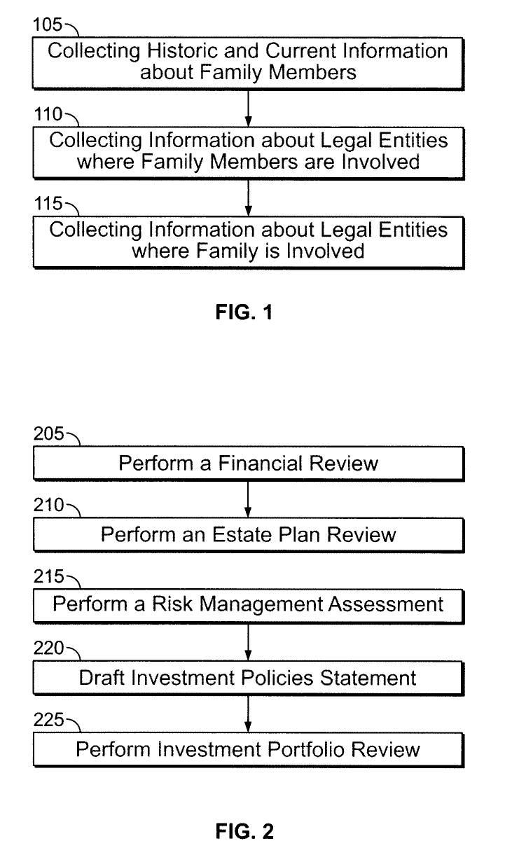

Referring to the drawings, FIG. 2 is a an exemplary flow chart depicting a method of providing wealth management services in accordance with Phase II of an exemplary embodiment of the present invention. During this phase, the process preferably performs a series of reviews aimed at assessing the family's financial assets, estate plan, if one is available, exposure to risk, and investment philosophy and performance, if available. At step 205, the wealth management process performs a financial review. The financial review addresses current financial situation and projections for future savings and spending by analyzing all or some of the family's assets. The kinds of data presented by the financial review are: net wealth accumulation, net worth, cash flow, tax information, estates information, retirement benefits, regular income, expenses, lifestyle assets, business entity assets, stock options, cash accounts, portfolio assets, life insurance policies, deficit coverage strategies, major purchase expenses, trusts, gifts, and estate distribution, to name a few.

According to the present invention, the kinds of documentation that may need to be submitted by the family in order to complete this review are income tax returns, brokerage statements, pension plan statements, bank statement, life insurance policies, disability insurance policies, mortgage and other loan documentation, most recent wills, powers of attorney, etc.

At step 210, the wealth management process performs an estate plan review. The estate plan review may be in the form of an illustration of the family's estate plan based on assumed life events. The estate plan review may also include financial projections. This review addresses any wills, living trust, provisions thereof, and inheritance. For example, the estate plan review deliverable may incorporate an estate taxes report, an estate planning flowchart, estate planning liquidity report, summary of payments to beneficiaries, estate planning synopsis, and a summary of gifts, to name a few. According to the present invention, the kinds of documentation that may need to be submitted by the family in order to complete this review are income tax returns, brokerage statements, pension plan statements, bank statement, life insurance policies, disability insurance policies, mortgage and other loan documentation, most recent wills, powers of attorney, etc.

At step 215, the wealth management process performs a risk management assessment that addresses possible exposure to future liabilities. This assessment also includes a review of current insurance policies, with an eye toward identifying gaps in risk management. As a result of this assessment, the advisor of the wealth management process may recommend to the family other or additional insurance plans, for example, a different carrier for property and casualty personal insurance, or a different policy that will better protect the family assets.

At step 220, the wealth management process includes drafting, preferably by the advisor of the wealth management process, of at least one investment policies statement. Such statements may address the written policies that govern investment decisions related to the family's portfolio. The policies tackle such considerations as the policies of the relevant legal entities, investment objectives, risk tolerance, liquidity requirements, time horizons, legal and tax constraints, asset allocation, benchmark construction, strategic risk analysis, investment parameters, degree of required liquidity, unique preferences, and reporting frequency, to name a few. The goal of this review is to capture the family's requirements from and goals for investment capital in quantitative terms.

The investment policies statement also dimensions the family's financial and emotional tolerance for risk. To prepare the investment policy statements, the advisor may also use the data collected in Phase I. Ultimately, such statements reflect the strategic asset allocation designed to meet the family's objectives or risks and returns. Once the investment policy statements are prepared, the family will review them to make sure they are in accordance with their goals and intentions.

Referring back to FIG. 2, at step 225, the wealth management process performs investment portfolio review. That is a review of the most recent reports detailing the performance and status of the family's investment portfolios. This review serves to affirm that the portfolio is performing consistent with the guidelines established by the investment policy statement discussed above. Moreover, this review confirms that the investment portfolio provides adequate liquidity for anticipated future expenditures, that is, if a family has a need to always have $2,000,000 available within 30 days that need will be addressed and met.

Performing the various reviews described above is particularly useful for getting a snapshot of a family's current position. It also allows the advisor to identify any critical issues that may exist in the family's financial or estate plan. Performing the reviews also allows the advisor of the family wealth management plan and the family to mutually understand what planning entails. Finally, performing the review's gives an integrated look as the various disciplines and components involved in successful wealth management. As the family moves on from Phase II to Phase III, the advisor will still refer back to Phases I and II, and, sometimes update and modify the information compiled therein.

Surveying the Family's Wealth Priorities™ Considerations

Surveying the Wealth Priorities™ considerations helps a family identify what is important in the management of its wealth, what philosophies are being practiced, and what effect such practices have on the family. The survey helps capture the family's view across a wide variety of wealth management topics, all of which are non-investment in quality. After all the survey responses are scored, two reports may be produced: a Wealth Priorities™ considerations report and a family balance sheet. The Wealth Priorities™ considerations report tells a family whether it practices that, which it considers important to it. The family balance sheet provides a mechanism for measuring what a family feels is the impact of implementing or not implementing the 20 or 25 recognized Wealth Priorities™ considerations. The family balance sheet also provides to the family its non-financial net worth—the human and intellectual capital.

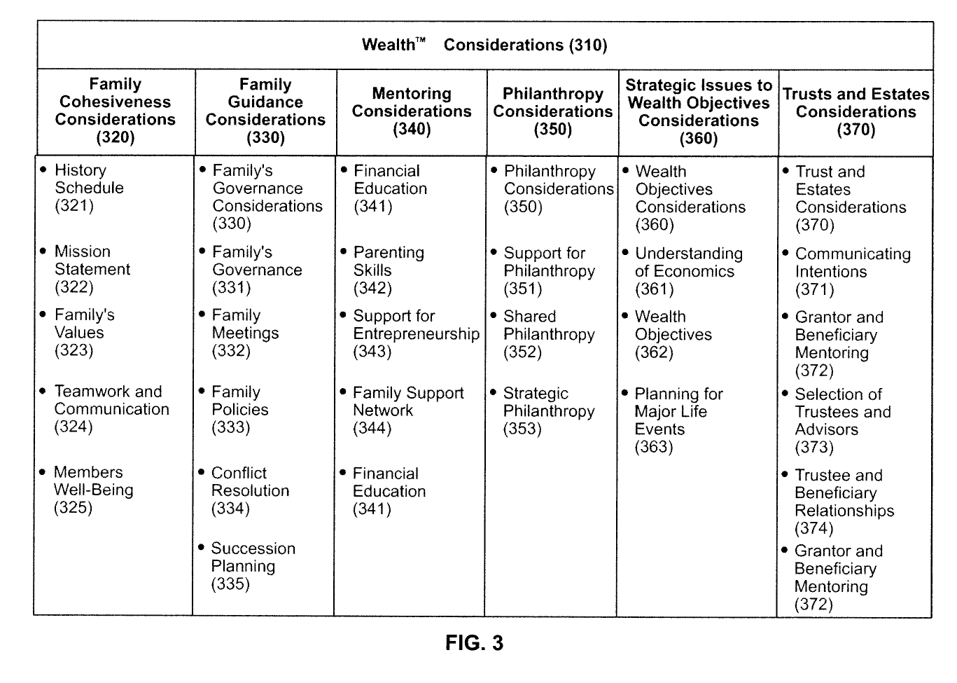

Referring to the drawings, FIG. 3 is a diagram of family Wealth Priorities™ considerations. This is a step that bridges Phases I and II with the remaining phases. Surveying family Wealth Priorities™ considerations helps assess the non-financial assets—the human and intellectual capital—of the family. The Wealth Priorities™ considerations 310 are represented by recognized non-investment related considerations that help sustain family wealth. These considerations, along with the key benefits associated with each, help guide the advice given to, and the actions taken by the family.

The Wealth Priorities™ considerations 310 can be broken down into six categories of considerations, including: (1) family cohesiveness considerations 320, (2) family governance considerations 330, (3) mentoring considerations 340, (4) philanthropy considerations 350, (5) strategic issues and wealth objectives considerations 360, and (6) trusts and estates considerations 370.

The family cohesiveness considerations 320 include such considerations as family history and culture 321, family mission statement 322, family values 323, teamwork and communication 324, and member well-being 325.

The family governance considerations 330 include such considerations as family governance 331, which addresses a family's decision-making process, family meetings 332, family policies 333, conflict resolution 334, and succession planning 335. Succession planning 335 may be omitted for families without heirs. The mentoring considerations 340 include such considerations as financial education 341, parenting skills 342, support for entrepreneurs hip 343, family support network 344, and money-related education 345. Financial education 341, parenting skills 342, and support for entrepreneurship 343 may be omitted for families without heirs.

The philanthropy considerations 350 include such considerations as support for philanthropy 351, shared philanthropy 352, which takes into account the values and interests of all family members prior to making family philanthropic decisions, and strategic philanthropy 353.

Strategic issues and wealth objectives considerations 360 include such considerations as understanding of economics 361, wealth objectives 362, and planning for major life events 363. Finally, the trusts and estates considerations 370 include such considerations as communicating intentions 371, grantor and beneficiary mentoring 372, selection of trustees and advisors 373, and trustee and beneficiary relationships 374. Grantor and beneficiary mentoring 372 may be omitted for families without heirs.

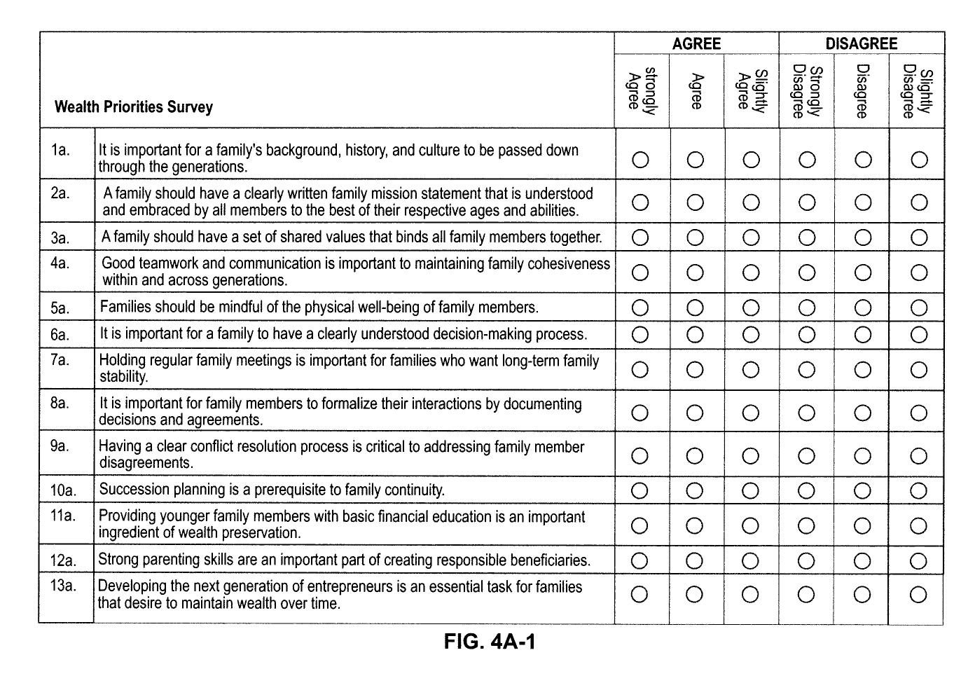

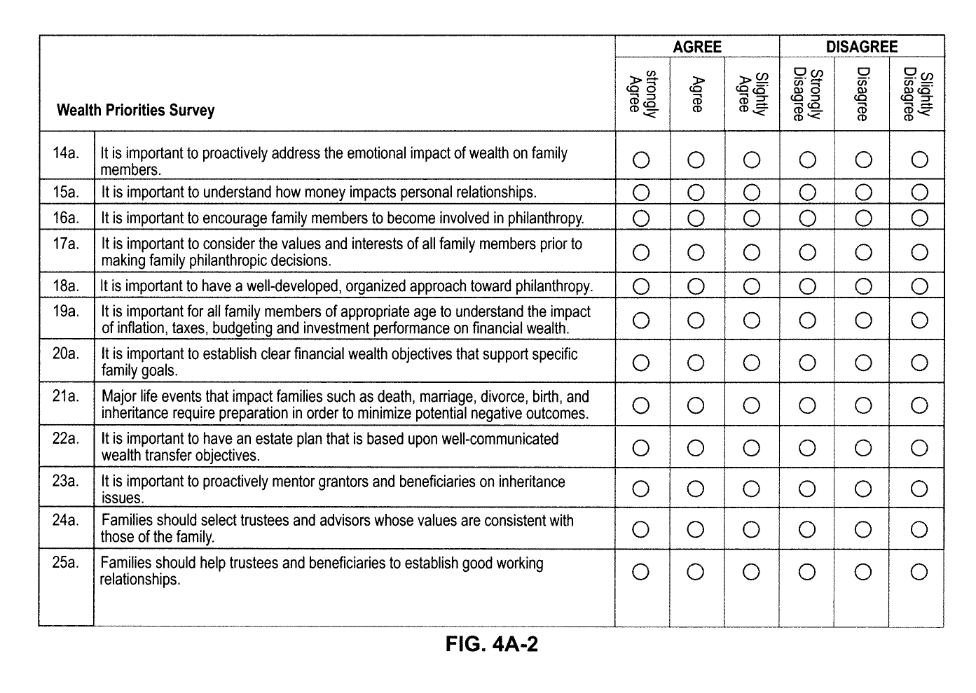

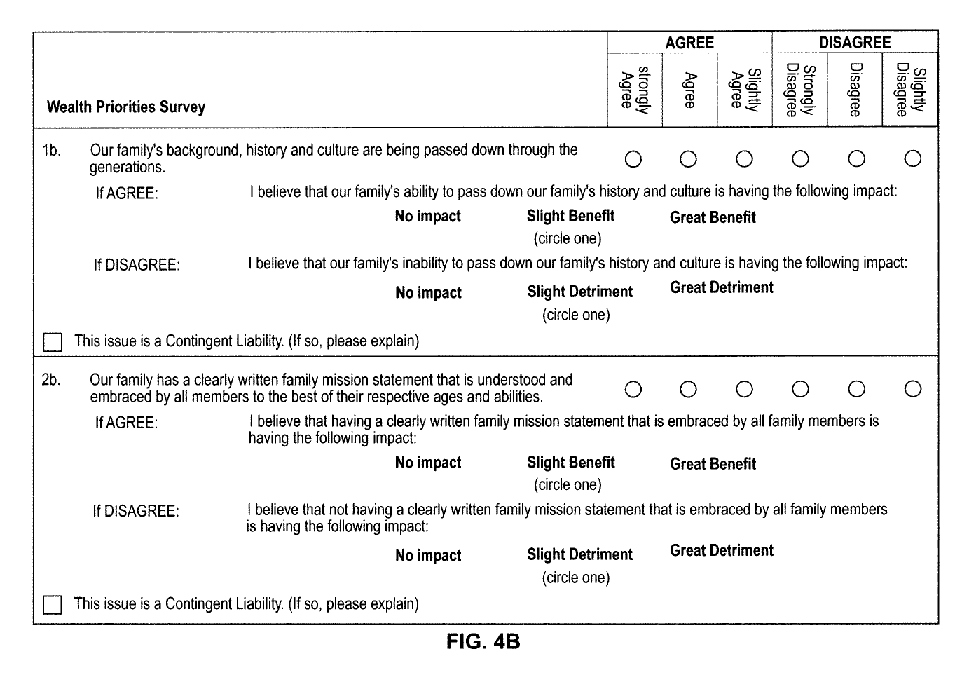

The surveying of the twenty five, or, if a family is without heirs, 20 Wealth Priorities™ considerations is a two-fold process. The family members are first asked to independently reflect on the considerations and identify to what degree they agree or disagree that they are important to them. See FIG. 4A. These are the importance questions. For example, an importance questions may be, “It is important for a family's background, history, and culture to be passed down through the generations.” The possible answers may be: “Strongly Agree,” “Agree,” “Slightly Agree,” “Slightly Disagree,” “Disagree,” and “Strongly Disagree.”

After completing the importance questions, the family member will be presented with the practice questions. See FIG. 4B. These questions ask the family members to identify to what degree they agree or disagree that the Wealth Priorities™ considerations are consistent with their family's current practices. For example, a practice question 410 may be, “Our family's background, history, and culture are being passed down through the generations. ” The possible answers may be in two groups, (1) the “Agree” group 420, listing “Strongly Agree,” “Agree,” “Slightly Agree,” and (2) the “Disagree” group 430, listing “Slightly Disagree,” “Disagree,” and “Strongly Disagree.”

In addition, however, each practice question has conditional impact statements 440 that asks the respondent whether they perceive current family practices as having a beneficial or detrimental impact on their family. If the respondent agreed with the practice question, the impact statements 440 may be, “I believe that our family's ability to pass down our family's history and culture is having the following impact.” Or, if the respondent disagreed with the practice question, the impact statement 440 may be, “I believe that our family's inability to pass down our family's history and culture is having the following impact.” In the affirmative, the respondent may then select one of the following possible answers: “No Impact,” “Slight Benefit,” or “Great Benefit,” if the respondent agrees with the statement. Alternatively, if the respondent does not agree with the statement, he may answer, “No Impact,” “Slight Detriment,” or “Great Detriment.”

With each impact question, the respondent will also have an option to identify a “Contingent Liability.” A contingent liability 450 is a situation in which the respondent believes his family's current practice (or lack thereof) could be materially impacted by future seen or unseen changes. Such future changes may be an occurrence of a major life event, inheritance, sale of a business, etc.

Evaluating a Family's Wealth Priorities™ Considerations

This occurs once all the participating family members have completed the importance, practice and impact questions. At this step, the answers provided by the participants get scored. After the answers are scored, the system will produce two types of reports: a Wealth Priorities™ considerations report and a family balance sheet. There may be three versions of the Wealth Priorities™ considerations report: an individual Wealth Priorities™ considerations report, a family Wealth Priorities™ considerations report, and an advisor version of the family Wealth Priorities™ considerations report.

An individual Wealth Priorities™ considerations report is created for every participating family member and one family Wealth Priorities™ considerations report is created for the family. The advisor's version of the family Wealth Priorities™ considerations report is exactly the same as the one the family receives except that it also shows the advisor the results from the individual reports. That way the advisor is able to determine why the group averages are the way the are. All of the reports illustrate and compare the scoring of the importance and practice questions. For the family, this report effectively shows whether the family is practicing what it indicated is important to it.

The family balance sheet is a report that shows the average impact scores across all family members for each of the considerations. If an average score is positive then it is included on the assets side of the family balance sheet. If an average score is negative then it is included on the liabilities side of the family balance sheet. The assets and liabilities are then totaled and used to calculate the family's net worth. Because surveying the family Wealth Priorities™ considerations preferably occurs every 2-4 years, a family's balance sheet will measure and show a family's progress in generating higher levels of non-financial capital.

Calculating the Wealth Priorities™ Considerations Survey Results

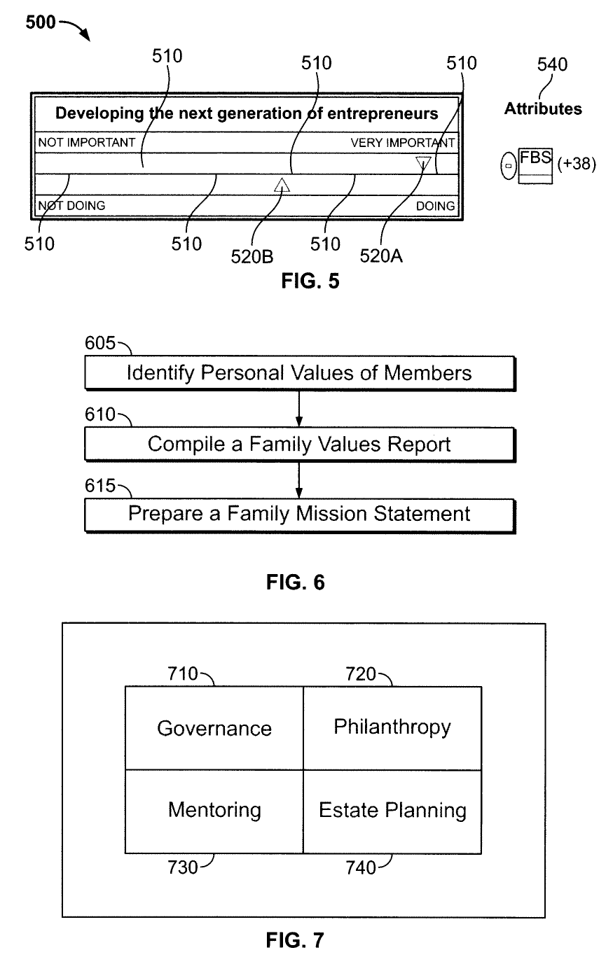

A separate calculation is made for the Importance and Practice question answers. The answers are assigned a value from 1 to 6 for the answers “Strongly Disagree,” “Disagree,” “Slightly Disagree,” “Slightly Agree,” “Agree,” and “Strongly Agree.” Referring to FIG. 5, a graphic of a sample report table, these values may be represented by six segments 510 in a table scale 500. For the group report the answers from the respondents are summed for each question and then divided by the number of respondents. The result is then rounded up for calculation results from n.50 to n.99. n being an integer from 1 to 5. The result is then rounded down for calculation results from n.01 to n.49. n being an integer from 1 to 5. For the individual report the answer values are used without any additional calculation process.

The result of the above calculation is then used to locate the indicator arrows 520 on the table scale 500. The following interpretation is suggested for each of the items on the report. For each table, note the relative positions of the Importance indicator arrows 520A and the Doing indicator arrow 520B. If the Importance and Doing indicators are close to (in adjacent segments and not spanning the middle divider) or pointing directly at each other, then the family (on average) believes it is balancing the time it spends practicing the topic with the degree it feels the topic is important. This condition would be indicated by a “+” symbol (not pictured). If the Importance and Doing indicator arrows are not close to each other or span the middle divider, then the family (on average) believes it is not appropriately balancing the time it spends practicing the topic with the degree it feels the topic is important. This condition is indicated by a “−” symbol in the attributes section 540. This condition typically involves a topic that the group thinks is important but is not practicing. Also in the attributed section 540 are an “FBS” symbol and a numeric score. The “FBS” symbol and associated numeric score illustrate the perceived benefit or detriment of the family's practices (or lack thereof) related to the topic as summarized on the family balance sheet.

Calculating the Assets and Liabilities Scores on the Family Balance Sheet

For each Wealth Priorities™ considerations survey question (25 for families with heirs, 20 for families without heirs) in the practice question section of the survey, there is preferably an impact score to be indicated. These Impact scores are used to calculate the assets and liabilities score for the family balance sheet. The scoring of each response within the Wealth Priorities™ considerations survey's impact question set is as follows: Great Benefit=+100, Slight Benefit=+30, No Impact=0, Slight Detriment=−30, Great Detriment=−100. For example, if there are 3 people in the group taking the survey and the answers chosen are: (1)—Great Benefit=+100, (2)—Slight Detriment=−30, and (3)—Great Detriment=−100.

To calculate whether the item is considered by the group to be an asset or a liability, the system sums the answers and divides by the number of answers. In this example: +100−30−100=−30/3=−10. Thus the score is a Liability of −10. Also, if one or more respondents has checked the “Contingent Liability” box for a particular question when taking the survey, a “CL” may be shown next to the appropriate asset or liability calculation.

Reviewing the Wealth Priorities™ considerations reports and the family balance sheets provides details about the alignment of family members' views and practices related to the Wealth Priorities™ considerations categories. The reports help provide insight into a family's perspective on its wealth. The wealth priority reports ultimately define and help prioritize a family's wealth objectives.

Phase III: Values and Mission

Referring to the drawings, FIG. 6 is a flow chart, depicting a method of providing wealth management services in accordance with Phase III of an exemplary embodiment of the present invention. This phase begins with the wealth management process assessing family values of the client family. To that end, the process first identifies personal values of members of the family 605. At step 610, the process compiles a family values report for the family based on those individual values. After compiling the family values report, at step 615, a family mission statement based on the family values may then be prepared by an advisor of the wealth management process. The family values report and the mission statement may be shared with and modified by the family, together with the advisor of the plan. See TABLE 1 for values list.

Values are primarily non-financial principles, standards and qualities that are given distinctive names and definitions. The values may further be divided into “goal” values and “means” values. Goal values are a distinction to describe a value or behavior that a person strives to achieve. Means values are a distinction to describe a way to achieve a person's goals. Goal values may be, for example, control, security, self-worth, belief philosophy, etc. Means values may be, for example, food, shelter, affection, territory, productivity, being liked, etc.

TABLE 2
List of values and definitions, skills and behaviors associated with each value.

| Num./ | | |
|---|---|---|
| Type/ | | |
| Stage | Value Name | Definition & Behavior/Skill |
| 1M6 | Accountability/Ethics | Being aware of and acting on your own system of moral principles so that others are inspired. |
| | | (This value assumes the capacity to understand another person's level of ethical maturity.) |
| | Skill: | Demonstrating principled behavior by understanding your rights and responsibilities and |
| | | employing sound ethics in your daily behavior. |
| | Skill Phrase: | Ethics |
| | Skill Development: | Learn and put into practice how to: |
| | | Identify and demonstrate the principles hat govern your behavior |
| | | Exercise: |
| | | Establish a list of ethical standards that represent what is important to you, such as being honest, |
| | | admitting mistakes, avoiding hidden agendas. etc. |
| | | Identify two or three behaviors that would demonstrate you are following your ethical standards. |
| | | Review Your day each evening for a week to determine if a situation came up that pertained to |
| | | your ethical standards. |
| | | On the days where you made ethical choices, evaluate your behavior against your chosen ethical |
| | | standards. |
| | | Ask yourself if you held closely to your ethical standards, and if there might have been a better |
| | | way to demonstrate such principles. |
| 2M4 | Achievement/Success | Accomplishing something noteworthy and admirable that you feel good about and of which |
| | | your family and friends would be proud. |
| | Skill: | Setting, committing to, and tracking progress towards challenging goals. |
| | Skill Phrase: | Goal setting |
| | Skill Development: | Learn and put into practice how to: |
| | | Gauge whether a goal is challenging yet attainable |
| | | Establish milestones that represent measurable steps toward your goal |
| | | Enroll others in the accomplishment of your goals |
| | | Track progress toward your goal |
| | | Exercise: |
| | | Identify a success you have had recently. |
| | | Identify the actions you took that made you successful and write them down. |
| | | Put the items in the order in which they actually occurred. |
| | | For each item on the list, identify the positive and negative outcomes of each action. |
| | | Ask yourself if the negative outcomes were avoidable and try to determine how you could have |
| | | been more successful? |
| | | List the skills that you used, Identify those skills that are well developed and those that need |
| | | improvement. |
| | | Create an action plan to achieve other goals and specifically identify those skills that will be |
| | | required to achieve successful outcomes. |
| 3M5 | Adaptability/Flexibility | Readily adjusting to changing conditions and remaining flexible even under stressful |
| | | circumstances. |
| | Skill: | Delaying decisions to seek the input of others. |
| | | Maintaining a positive and open attitude towards new ideas. |
| | Skill Phrase: | Flexibility |
| | Skill Development: | Learn and put into practice how to: |
| | | Assure you are taking the opportunity to gather ideas before making a decision. |
| | | Exercise: |
| | | Identify a recent situation where you felt pressured to make a quick decision. |
| | | Write down the reasons you felt pressured and who or what was exerting the pressure. |
| | | For each reason, identify at least one alternative action you could have taken to be more prepared |
| | | or informed or otherwise would have made you feel less pressured. |
| | | Test these alternative actions. |
| | | Make the ones that fit part at your daily routine. |
| 4M4 | Administration/Control | Administering control over that for which I have authority. |
| | Skill: | Directing the actions of a department or functional area for a business or family group so that the |
| | | responsibilities are fully and effectively carried out. |
| | Skill Phrase: | Planning |
| | Skill Development: | Learn and put into practice how to: |
| | | Delineate responsibilities among functional areas. |
| | | Make sure that the chain of command and lines of communication are clear. |
| | | Create procedures for accomplishing tasks. |
| | | Delegate tasks to others |
| | | Exercise: |
| | | Identify a task your area was responsible for performing or completing; |
| | | Identify who was involved or affected; |
| | | Identify what you needed (information people etc.) to perform or complete this task successfully |
| | | Identify the actions you took. |
| | | Put the actions in the order in which on performed them. |
| | | Grade yourself as to the level of success of each of these actions towards the objective it was to |
| | | accomplish. (not effective, slightly effect, highly effective) |
| | | Identify what actions you could have taken to improve the outcome but did not. |
| | | Create a new plan with the new actions/objectives inserted it their appropriate places. |
| | | When you are faced with a new task, create such a plan to prospectively identify the people, skills, |
| | | and actions that will be required to achieve success. |
| 5M2 | Affection/Physical | Expressing fondness or devotion to family members or loved ones by caressing. |
| | Skill: | Being able to care for injured or disabled persons. Knowing how to touch and hold a person to |
| | | make them feel nurtured and safe. |
| | Skill Phrase: | Affection |
| | Skill Development: | Learn and put into practice how to: |
| | | Care for a person in such a way that they feel safe, secure and nurtured. |
| | | Exercise: |
| | | Identify a situation in your past when someone took care of you or you felt cared for. |
| | | Ask yourself what the person did to make you feel eared for or nurtured. |
| | | List as many of the helpful actions and words that were used by the person who cared for you. |
| | | The next time you have an opportunity to care for someone, try to put yourself in their situation. |
| | | Refer to the list you made, and ask yourself what actions and words might be comforting to the |
| | | person and use them. Put the person's needs above your own. |
| 6G6 | Art/Beauty | Experiencing enjoyment through the arts or that which is otherwise aesthetically pleasing. |
| | Behavior: | Appreciating art for art's sake. |
| 7M5 | Authority/Honesty | Expressing your full range of feelings and thoughts in a straightforward, objective manner. |
| | Skill: | Being straightforward, honest and assertive in the expression of authority and feelings while |
| | | not alienating others. |
| | Skill Phrase: | Candor |
| | Skill development: | Learn and put into practice how to: |
| | | Express yourself openly and honestly while keeping the respect and attention of others. |
| | | Exercise: |
| | | Try to remember an instance within the last week in which you spoke with someone at length over |
| | | a disagreement. |
| | | Try to remember the topics that were discussed and the opinions that were expressed. |
| | | Ask yourself if you purposefully withheld any pertinent information or personal beliefs. If so, |
| | | what was your motivation for doing so? |
| | | Ask yourself if you showed respect for the other person's opinions and comments. Could you |
| | | have, in some way, alienated the other person with something that you said? |
| | | In future conversations, try to clearly point out your views by saying “I agree” or “I disagree”. |
| 8M3 | Being Liked | Experiencing positive reinforcement from our peers. |
| | Skill: | Showing genuine interest in another person in ways that create a mutual respect and friendship. |
| | Skill Phrase: | Interaction |
| | Skill Development: | Learn and put into practice how to: |
| | | Engage with someone in conversation or activities in a way that demonstrates your genuine |
| | | interest and enjoyment. |
| | | Exercise: |
| | | Identify an instance within the last week in which von were with a friend. |
| | | List two or three areas of interest that you share with this person. |
| | | Think about how you are attentive to this person when talking about these things. |
| | | Try to be equally attentive to and engaged with another person whom you have recently met. |
| | | Listen to them without interrupting and show an interest in them by letting them lead the |
| | | conversation. Try not to change the subject. |
| 9G6 | Being Self | Possessing an objective awareness of your strengths and weaknesses which frees you to be |
| | | yourself. |
| | Behavior: | Knowing yourself and acting out of that knowledge. |
| 10G4 | Belief/Philosophy | Adhering to a belief system or set of principles that guides your life and actions. For some |
| | | people, this is a set of religious beliefs. |
| | Behavior: | Acting on strongly held beliefs. |
| 11M3 | Care/Nurture | Physically or emotionally caring for and taking a genuine interest in others. |
| | Skill: | Caring for and taking a genuine interest in others. |
| | Skill Phrase: | Caring |
| | Skill Development: | Learn and put into practice how to: |
| | | Physically assist others, and openly discuss emotional topics. |
| | | Exercise: |
| | | Think of a time recently when someone you know needed to talk about a personal topic or needed |
| | | a helping hand. |
| | | Remember and list how you felt and what you offered. |
| | | Ask yourself if you felt inhibited from having such a discussion. If so, what negative outcome did |
| | | you fear? |
| | | Ask yourself what would make these types of encounters more comfortable. |
| 12M6 | Collaboration | Cooperating with others to create an environment where all can freely contribute their views |
| | | and ideas. |
| | Skill: | Engaging with others to create an environment in which all feel and believe they are |
| | | encouraged to contribute in any decisions to be made. |
| | Skill Phrase: | Collaboration |
| | Skill Development: | Learn and put into practice how to: |
| | | Encourage participation and share responsibility and authority. |
| | | Exercise: |
| | | Think of a meeting in which you recently participated. |
| | | Assess the level and depth of interaction between you and the other meeting participants. |
| | | List the actions/behaviors you believe encouraged participation.. |
| | | List other behaviors that you believe would have created an even greater level of collaboration |
| | | among the participants. |
| | | Try to implement such practices in your next meeting. If necessary, openly discuss the goals and |
| | | ground rules for the meeting prior to beginning. |
| 13M4 | Communication/Information | Communicating ideas and information effectively and efficiently. |
| | Skill: | Communicating ideas and information in a clear and succinct manner for the intended |
| | | audience. |
| | Skill Phrase: | Communication |
| | Skill Development: | Learn and put into practice how to: |
| | | Plan your vocabulary and delivery style for the recipients of your communication. This can be |
| | | applied to one-on-one conversations and communicating with a group. |
| | | Exercise: |
| | | Think of a meeting in which you recently participated. |
| | | Assess the level of communication between you and the other meeting participants. |
| | | List the items you communicated that you believe were understood and kept the meeting |
| | | participants engaged. Why do you believe people were listening? |
| | | Try to identify points that you had to make multiple times. Why were you not understood clearly |
| | | the first time you made your point? |
| | | Try to assess what you could have said or done differently to improve other's reception of your |
| | | communication. |
| 14M7 | Community/Personalist | Demonstrating commitment to a community, its members, and its purpose such that others |
| | | are inspired and better able to participate toward common goals. |
| | Skill: | Acting in a manner such that, for all the communities in which you take part, your |
| | | commitment shows and you foster commitment to full participation among the other |
| | | community members, |
| | Skill Phrase: | Participation |
| | Skill Development: | Learn and put into practice how to: |
| | | Structure your participation in your communities in a way that promotes interdependent thinking |
| | | and collaboration among members. A community may be any group in which you participate. |
| | | (Note that community refers to any group in which you participate as a member) |
| | | Exercise: |
| | | Assess your recent experiences as a member of your community. |
| | | Identify a meeting of people in which you had the opportunity to contribute to the conversation. |
| | | Ask yourself if you did so to promote your own agenda or that of the community. Did you |
| | | participate in a constructive way? |
| | | Discuss with other participants in the meeting what they perceived as the positive and negative |
| | | dynamics of the meeting. Try to reconcile their perceptions with your own. |
| 15M6 | Community/Supportive | Creating a group of peers in an environment where members feel free to act with clarity on |
| | | and mutually support each other's shared beliefs, values and lifestyle. |
| | Skill: | Being supportive of community members in the expression of their beliefs. Acting in such a |
| | | way that providing such support becomes an example to other members. A community could |
| | | be any group in which you participate. |
| | Skill Phrase: | Support |
| | Skill Development: | Learn and put into practice how to: |
| | | Listen to, and be supportive of, your community members. |
| | | Exercise: |
| | | Think of a recent conversation in which there was a new idea presented, that you accepted, but |
| | | was overwhelmingly rejected by other participants. Did you openly express your support for the |
| | | idea? If not, why did you feel inhibited from expressing your views? |
| | | Try to put yourself in a similar situation in which you are the sole defender of a minority opinion |
| | | in a group of ten people. How much more comfortable would you feel if you had one of the ten |
| | | people openly sharing your view? What if it were five of the ten? |
| | | Try to consistently express your views and provide support to other community members. |
| 16G4 | Competence/Confidence | Feeling confident that you have the skills and capacities to deal successfully with the tasks |
| | | you choose |
| | Behavior: | Building skills and attitude to better accomplish tasks. |
| 17M4 | Competition | Matching your skills and talents against those of your rival(s) with the intent of winning. |
| | Skill: | Being acutely aware of your strengths and weaknesses and striving to improve so as to do better |
| | | than other people, within your values structure, to be the first to reach the goal. |
| | Skill Phrase: | Competition |
| | Skill Development: | Learn and put into practice how to: |
| | | Understand the factors that are critical to being the best in a particular pursuit. |
| | | Assess the people in the same pursuit as you according to those factors. |
| | | Exercise: |
| | | Think back to a recent event in which you felt a competitive environment existed. |
| | | Identify the criteria by which outstanding performance is determined in this environment and |
| | | situation. |
| | | Evaluate your own performance against these criteria. |
| | | Identify the ways in which you could improve your performance in those areas where you fell |
| | | short of outstanding. |
| 18M6 | Complementarity | The ability to recognize, identify, and match the skills of individuals such that the collective |
| | | ability of, and cooperation within, the group is enhanced. |
| | Skill: | Fostering cooperation between family members and colleagues by developing give-and- |
| | | take relationships. |
| | | Balancing offering your ideas with accepting those of others. |
| | | Building trust through authenticity and honesty. |
| | Skill Phrase: | To be supplied |
| | Skill Development: | To be supplied |
| 19M5 | Congruence | Expressing your feelings and thoughts in such a way that what you say and do is consistent |
| | | with what you think and feel. |
| | Skill: | Showing consistency among principles, feelings, values and behaviors. |
| | | Building trust through authenticity and honesty. |
| | | Making sure your thoughts are consistent with your deeds. |
| | Skill Phrase: | To be supplied |
| | Skill Development: | To be supplied |
| 20G6 | Construction/New Order | Developing and initiating a new institution or transforming the organization in which you |
| | | belong to foster your vision of the world. |
| | Behavior: | Altering the status quo to accomplish something new. |
| 21G6 | Contemplation | Having the self discipline to remove yourself from, and reflect on, the questions that arise in |
| | | your life in order to gain greater perspective. |
| | Behavior: | Deliberate mental distancing from issues/problems to gain new perspective. |
| 22M3 | Control/Order/Discipline | Being in control by adhering to rules and established practices that provide the structure for |
| | | your personal actions. |
| | Skill: | Being disciplined and in control to create stability in your life |
| | Skill Phrase: | To be supplied |
| | Skill Development: | To be supplied |
| 23M8 | Convivial Technology | Identifying the need and applying technological expertise creatively to improve quality of life |
| | | at a global level. |
| | Skill: | Attempting to empower other's by helping them use technology. |
| | | Applying technology toward the solution of human or ecological issues. |
| | Skill Phrase: | To be supplied |
| | Skill Development: | To be supplied |
| 24M6 | Corporation/Stewardship | Taking ownership of the vision and feeling responsibility to guide an organization in which you |
| | | are engaged. |
| | Skill: | Taking the initiative to lead others. |
| | | Determining the core values and interest of your family. |
| | | Helping to develop a vision or strategy for your family or organization. |
| | Skill Phrase: | To be supplied |
| | Skill Development: | To be supplied |
| 25M3 | Courtesy/Hospitality | Offering polite and respectful treatment to others. This includes enjoying the same |
| | | treatment. |
| | Skill: | Being aware of common courtesies. |
| | | Going out of your way to make others feel appreciated. |
| | | Genuinely listening to people and noticing the clues they give about their interests. |
| | Skill Phrase: | To be supplied |
| | Skill Development: | To be supplied |
| 26M6 | Creativity | Displaying original thought and expression that bring new ideas and images into a practical |
| | | and concrete reality in ways that did not previously exist. |
| | | Ability to see things differently think outside the box. |
| | Skill: | Trying to come up with totally new ideas from seemingly unrelated data. |
| | | Suspending critical judgment and avoiding the notion that “it will not work.” |
| | Skill Phrase: | To be supplied |
| | Skill Development: | To be supplied |
| 27M5 | Decision/Initiation | Feeling responsibility to begin a creative course of action or to act on your conscience without |
| | | external prompting. |
| | Skill: | Taking responsibility for your own actions. |
| | | Seeking challenges. |
| | | Approaching day-to-day challenges confidently. |
| | Skill Phrase: | To be supplied |
| | Skill Development: | To be supplied |
| 28M4 | Design/Pattern/Order | Being aware of the natural arrangement of things plus the ability to create new arrangements |
| | | through art, ideas, or technology (e.g. architecture). |
| | Skill: | Developing your computer skills, particularly in the use of graphics and various design, |
| | | drawing, and presentation programs. |
| | | Developing your abilities in drafting or architectural design. |
| | Skill Phrase: | To be supplied |
| | Skill Development: | To be supplied |
| 29M6 | Detachment/Solitude | Using discipline of non-attachment to people, things, and outcomes that leads to quality |
| | | relationships with others and the universal order. |
| | Skill: | Regularly enjoying leisure activities. |
| | | Relaxing by paying attention to your breathing. |
| | | Practicing meditation. |
| | Skill Phrase: | To be supplied |
| | Skill Development: | To be supplied |
| 30M3 | Dexterity/Coordination | Combining interaction of mental and physical functions to perform basic instrumental skills. |
| | Skill: | Being physically agile and skilled. |
| | | Developing the physical skills to be successful professionally. |
| | Skill Phrase: | To be supplied |
| | Skill Development: | To be supplied |
| 31M6 | Discernment | Enabling a group or organization to come to consensus decisions on long-term planning |
| | | through openness, reflection, and honest interaction. |
| | Skill: | Stating problems in a way that all involved can understand. |
| | | Discouraging people from jumping to a conclusion before all relevant information has been |
| | | heard and considered. |
| | | Testing decisions for consensus. |
| | Skill Phrase: | To be supplied |
| | Skill Development: | To be supplied |
| 32M4 | Duty/Obligation | Following established customs and regulations out of dedication to your peers and a sense of |
| | | responsibility to institutional codes. |
| | Skill: | Following through on your commitments. |
| | | Allowing for and contributing necessary resources, particularly your own time. |
| | Skill Phrase: | To be supplied |
| | Skill Development: | To be supplied |
| 33M2 | Economics/Profit | Accumulating physical wealth that ensures security and respect. |
| | Skill: | Incorporating financial and quantitative data into your decision-making. |
| | | Being comfortable using quantitative information. |
| | | Being involved in financial budgeting and planning. |
| | Skill Phrase: | To be supplied |
| | Skill Development: | To be supplied |
| 34M4 | Economics/Success | Attaining favorable and prosperous financial results in business through effective control and |
| | | efficient management of resources, which provides added value to stakeholders. |
| | Skill: | Using financial resources to accomplish your goals. |
| | | Paying attention to details in financial data, particularly questioning assumptions and |
| | | reviewing conclusions. |
| | Skill Phrase: | To be supplied |
| | Skill Development: | To be supplied |
| 35GB | Ecology/Global | Enabling persons to take authority for the created order of the world and to enhance its |
| | | beauty and balance through creative technology in ways that have worldwide influence. |
| | Behavior: | Acting out of concern for nature's systems. |
| 36M4 | Education/Certification | Completing a formally prescribed process of learning and receiving documentation of such |
| | | achievement. |
| | Skill: | Keeping up-to-date on the knowledge required by your profession. |
| | | Acquiring and maintaining the credentials needed in your field through formal education |
| | | and certification programs. |
| | Skill Phrase: | To be supplied |
| | Skill Development: | To be supplied |
| 37M6 | Education/Knowledge | Experiencing ongoing learning as a means of gaining new facts, truths, and principles. Being |
| | | motivated by the occasional reward of new understanding that is gained intuitively. |
| | Skill: | Studying fields of interest in which you have no expertise as a means of broadening your |
| | | perspective. |
| | | Understanding how teaching methodology varies with personality type and ethnic and |
| | | cultural heritage. |
| | | Volunteering your time and energy with social, political or religious groups. |
| | Skill Phrase: | To be supplied |
| | Skill Development: | To be supplied |
| 38M4 | Efficiency/Planning | Proactively thinking about and acting in ways to be most productive. |
| | Skill: | Using a calendar or day planner to schedule and track your activities. |
| | | Being on the lookout for new technology that can help you and your family be more |
| | | efficient. |
| | Skill Phrase: | To be supplied |
| | Skill Development: | To be supplied |
| 39M5 | Empathy | Reflecting and experiencing another's feelings and state of being, which results in people |
| | | seeing themselves with more clarity (without any words necessarily having been spoken). |
| | Skill: | Showing and sharing emotions with others; stating anger objectively. |
| | | Being alert to non-verbal signals of rejection or withdrawal. |
| | | Showing compassion. |
| | | Recognizing the needs of others and trying to understand what they are seeking. |
| | Skill Phrase: | To be supplied |
| | Skill Development: | To be supplied |
| 40M3 | Endurance/Patience | Bearing difficult and painful experiences, situations, or persons, with calm, stability, and |
| | | perseverance. |
| | Skill: | Showing resilience in the race of constraints, frustration or adversity. |
| | | Understanding and relating to people of different age, gender and ethnicity. |
| | Skill Phrase: | To be supplied |
| | Skill Development: | To be supplied |
| 41G5 | Equality/Liberation | Feeling that you have the same values and rights as all other human beings, which sets you |
| | | free to be yourself and help others to be themselves. |
| | Behavior: | Being treated and treating others equally. |
| 42M3 | Equilibrium | Maintaining a peaceful environment by averting upsets and avoiding conflicts. |
| | Skill: | Maintaining personal calmness even in crisis situations. |
| | | Considering the opinions of others and remaining flexible. |
| | Skill Phrase: | To be supplied |
| | Skill Development: | To be supplied |
| 43M5 | Equity/Rights | Being aware of the moral and ethical claim of all persons (including yourself) to legal, social, |
| | | and economic equality and fairness while feeling a personal commitment to defend this claim. |
| | Skill: | Considering needs in the context of fairness for all. |
| | | Addressing feelings of inequity in a confidential manner. |
| | | Being aware of laws and rules regarding civil liberties and human rights. |
| | Skill Phrase: | To be supplied |
| | Skill Development: | To be supplied |
| 44M5 | Expressiveness/Joy | Sharing your feelings and fantasies openly and spontaneously. |
| | Skill: | Expressing anger and frustrations creatively and positively. |
| | | Reacting to situations spontaneously but thoughtfully. |
| | Skill Phrase: | To be supplied |
| | Skill Development: | To be supplied |
| 45G6 | Faith/Risk/Vision | Committing to values that are considered life giving even at risk to your own way of life. |
| | Behavior: | Risking comfort and security for a vision. |
| 46G3 | Family/Belonging | Spending quality time with, and having a sense of support from, people to whom you feel |
| | | primary bonds of relationship. |
| | Behavior: | Doing things that keep family relationships healthy and close. |
| 47G3 | Fantasy/Play | Experiencing personal worth through unrestrained imagination and personal amusement. |
| | Behavior: | Imagining the wonderful possibilities of the future. |
| 48M1 | Food/Warmth/Shelter | Expressing personal concern about having adequate physical nourishment, warmth, and |
| | | comfort and a place of refuge from the elements. |
| | Skill: | Choosing the appropriate food to eat for minimal expenditure and maximum nutrition and |
| | | health. |
| | | Being able to dress properly in order to have protection from the weather. |
| | | Surviving in a hostile environment with limited resources. |
| | Skill Phrase: | To be supplied |
| | Skill Development: | To be supplied |
| 49G3 | Friendship/Belonging | Having a group of people with whom you can share ideas and experiences on a day-to-day |
| | | basis. |
| | Behavior: | Actively engaging in a church, service club, or other community activity. |
| | | Learning about other people's interests and seeking to develop new relationships. |
| 50M1 | Function/Physical | Performing minimal manipulations of your body, caring for yourself, and ensuring that your |
| | | body's internal systems function adequately. |
| | Skill: | Paying attention to your diet and learning about nutrition. |
| | | Allowing time to exercise regularly. |
| | Skill Phrase: | To be supplied |
| | Skill Development: | To be supplied |
| 51M5 | Generosity/Compassion | Being aware of others' needs and limitations, which lead to sharing your unique gifts and |
| | | skill as a way of serving others without expecting reciprocation. |
| | Skill: | Taking time to listen to the joys and tribulations of others in a caring way. |
| | | Avoiding defensive reactions when other people are talking to you. |
| | | Making creative use of silence, which allows others to reflect and formulate thoughts. |
| | Skill Phrase: | To be supplied |
| | Skill Development: | To be supplied |
| 52G8 | Global Harmony | Knowing the practical relationship between human needs, freedom, and creative ecological |
| | | balance so that you can influence changes that promote the interdependence of peoples and |
| | | nations, equality, and creativity |
| | Behavior: | When the opportunity arises, making decisions and taking actions that promote greater |
| | | cooperation among nations and peoples. |
| 53M8 | Global Justice | Committing to the fact that all persons have equal value, but different gifts and abilities to |
| | | contribute. Eliciting Inter-Institutional and governmental collaboration that will help provide |
| | | the basic life necessities for the disadvantaged. |
| | Skill: | Judging the fairness of individuals and organizations based on your strict definition of |
| | | human equality. |
| | | Feeling the need to act as the protector of those who are disadvantaged. |
| | Skill Phrase: | To be supplied |
| | Skill Development: | To be supplied |
| 54M6 | Growth/Expansion | Enabling an organization to develop and grow creatively. This assumes skills in management, |
| | | organization, production and marketing, at a division or corporate level. |
| | Skill: | Assessing past accomplishments, the present situation, and setting long-term goals. |
| | | Develop a game plan that has challenging yet attainable milestones. |
| | Skill Phrase: | To be supplied |
| | Skill Development: | To be supplied |
| 55M5 | Health/Healing | Maintaining soundness of mind and body that flows from meeting your emotional and |
| | | physical needs through self-awareness and discipline. This includes understanding that |
| | | commitment to maintaining your inner rhythm and balance relates to positive feelings and |
| | | fantasy. |
| | Skill: | Paying attention to your diet and learning about nutrition. |
| | | Practicing the contemplative arts, such as meditation. |
| | Skill Phrase: | To be supplied |
| | Skill Development: | To be supplied |
| 56M4 | Hierarchy/Order | Ranking people and things above one another in conformity with established standards of |
| | | what is good and proper. |
| | Skill: | Applying standard measures For allocating responsibility and establishing order. |
| | | Providing adequate information when delegating authority. |
| | Skill Phrase: | To be supplied |
| | Skill Development: | To be supplied |
| 57M4 | Honor | Holding high respect and offering support for the worth, merit, or rank of those in authority |
| | | (for example, parents, superiors, and national leaders). |
| | Skill: | Demonstrating loyalty to those who have influence over you. |
| | | Recognizing past achievements of family, friends and peers. |
| | | Showing enthusiasm for corporate or family leadership. |
| | Skill Phrase: | To be supplied |
| | Skill Development: | To be supplied |
| 58G6 | Human Dignity | Supporting the basic right of every human being to have respect and to have basic needs |
| | | met. |
| | Behavior: | Creating and/or supporting systems and organization that assure respect for all and meet |
| | | people's basic needs. |
| 59M8 | Human Rights | Committing your talent, education, training, and resources to creating the means for every |
| | | person in the world to experience his/her basic right to such life giving resources as food, |
| | | habitat, employment, health, and minimal education. |
| | Skill: | Using your talents to foster collaboration among global institutions for the good of all |
| | | human beings. |
| | | Identifying and supplying the education, training, and resources necessary to satisfy the |
| | | basic needs of others. |
| | Skill Phrase: | To be supplied |
| | Skill Development: | To be supplied |
| 60M5 | Independence | Thinking and acting for yourself in matters of opinion and conduct without being subject to |
| | | external constraint or authority. |
| | Skill: | Standing behind your iceas in the face of disagreement. |
| | | Asserting yourself and your opinions with others. |
| | | Speaking persuasively to champion your ideas. |
| | Skill Phrase: | To be supplied |
| | Skill Development: | To be supplied |
| 61G5 | Integration/Wholeness | Organization the personality (mind and body) into a coordinated, harmonious totality. |
| | Behavior: | Achieving personal alignment in spirit and behavior. |
| 62M7 | Interdependence | Seeing and acting on the awareness that personal and inter-institutional cooperation are |
| | | always preferable to individual decision-making. |
| | Skill: | Recognizing that cooperating with others will enable you to achieve more than what you |
| | | could if acting alone. |
| | | Realizing when you are being competitive at the expense of cooperation. |
| | Skill Phrase: | To be supplied |
| | Skill Development: | To be supplied |
| 63M6 | Intimacy | Sharing yourself (thoughts, feelings, fantasies, and realities) mutually and freely with another |
| | | on a regular basis. |
| | Skill: | Feeling unrestrained in expressing emotions with another. |
| | | Sharing without fear of reprisal. |
| | Skill Phrase: | To be supplied |
| | Skill Development: | To be supplied |
| 64G7 | Intimacy/Solitude | Experiencing personal harmony that results from a combination of meditative practice, |
| | | mutual openness, and total acceptance of another person. |
| | Behavior: | Working to achieve openness at home and work. |
| | | Balancing time spent with others and time spent alone. |
| 65M6 | Justice/Social Order | Taking a course of action that addresses, Confronts and helps correct conditions of human |
| | | oppression in order to actualize the truth that every human being is of equal value. |
| | Skill: | Speaking out about your perceptions of inequity. |
| | | Acting on your beliefs without fear of retribution. |
| | Skill Phrase: | To be supplied |
| | Skill Development: | To be supplied |
| 66G6 | Knowledge/Insight | Pursuing truth through patterned investigation. |
| | Behavior | Using planned knowledge gathering end insight to solve problems or set direction. |
| 67M5 | Law/Guide | Seeing authoritative principles and regulations as a means for creating your own criteria and |
| | | moral conscience. Questioning those rules until they are clear and meaningful. |
| | Skill: | Knowing the rules and regulations that govern your family and its members. |
| | | Testing rules and regulations against your own values and beliefs. |
| | Skill Phrase: | To be supplied |
| | Skill Development: | To be supplied |
| 68M4 | Law/Rule | Governing your conduct, action, and procedures by the established legal system or code. |
| | | Living your life by the rules. |
| | Skill: | Knowing the law and rules that govern society, |
| | | Live within acceptable norms. |
| | Skill Phrase: | To be supplied |
| | Skill Development: | To be supplied |
| 69M6 | Leisure | Using time in a way coat requires as much skill and concentration as your work, but that |
| | | totally detaches you from work so that you are free to be playful and share yourself with |
| | | others. |
| | Skill: | Being active in sporting activities. |
| | | Expressing contagious enthusiasm for relaxation. |
| | Skill Phrase: | To be supplied |
| | Skill Development: | To be supplied |
| 70M5 | Limitation/Acceptance | Accepting the reality that everyone has boundaries and limits to abilities. This includes an |
| | | objective self-awareness of your strengths and potential as well as weaknesses and |
| | | limitations. It also means having the capacity for self-criticism. |
| | Skill: | Looking at problems as opportunities. |
| | | Identify your strengths and weaknesses. |
| | | Having the ability to learn from your mistakes. |
| | Skill Phrase: | To be supplied |
| | Skill Development: | To be supplied |
| 71M6 | Limitation/Celebration | Recognizing that your limits are the framework for exercising your talents. The ability to |
| | | laugh at your own imperfection. |
| | Skill: | Being able to laugh at your own mistakes and help others to do the same. |
| | | Taking calculated risks and supporting others in taking calculated risks. |
| | | Seeing unexpected outcomes as opportunities to learn. |
| | Skill Phrase: | To be supplied |
| | Skill Development: | To be supplied |
| 72M4 | Loyalty/Fidelity | Observing promises and duties to those in authority and to those in close personal |
| | | relationships. |
| | Skill: | Demonstrating enthusiasm and personal commitment to your family and friends. |
| | | Supporting others who nave good ideas that have been overlooked or rejected. |
| | | Keeping secrets when asked. |
| | Skill Phrase: | To be supplied |
| | Skill Development: | To be supplied |
| 73M8 | Macroeconomics | Managing and directing the use of financial resources at an institutional and inter-institutional |
| | | global level toward creating a more stable and equitable world economic order. |
| | Skill: | Using financial information to accomplish your goals. |
| | | Paying attention to and understanding details in financial data. |
| | | Seeing the dependencies between global economies. |
| | Skill Phrase: | To be supplied |
| | Skill Development: | To be supplied |
| 74M4 | Management | Controlling and manipulating your affairs in accordance with your philosophy and beliefs. It is |
| | | also the process of giving direction to your family in order to optimize its goals. |
| | Skill: | Encouraging and motivating others to set and achieve high standards. |
| | | Making timely and sound decisions. |
| | | Facilitating communication among all. |
| | Skill Phrase: | To be supplied |
| | Skill Development: | To be supplied |
| 75M4 | Membership/Institution | Taking pride in belonging to and working in the organization. |
| | Skill: | Knowing how each member contributes to the fabric of the organization. |
| | | Promoting unity and spirit among different people. |
| | | Communicating the achievements of others. |
| | Skill Phrase: | To be supplied |
| | Skill Development: | To be supplied |
| 76M7 | Minessence | Miniaturizing and simplifying complex ideas or technical instruments (tools) into concrete and |
| | | practical objectifications so the user's consciousness becomes more creative. |
| | Skill: | Taking an idea and creating practical and actionable steps. |
| | | Critically evaluating traditional practices and authority. |
| | | Identifying the source of problems and defining solutions. |
| | Skill Phrase: | To be supplied |
| | Skill Development: | To be supplied |
| 77M6 | Mission/Objectives | Establishing goals arid executing long-term planning in light of group needs. |
| | Skill: | Helping to define a vision or strategy for your family or organization. |
| | | Understanding your strengths and limitations. |
| | | Manage by objectives, including defining roles and goals, selecting and setting objectives, |
| | | and establishing deadlines. |
| | Skill Phrase: | To be supplied |
| | Skill Development: | To be supplied |
| 78M6 | Mutual Accountability | Maintaining a reciprocal balance of tasks and assignments with others so that everyone is |
| | | answerable for their own area of responsibility. This requires the ability to mobilize anger and |
| | | deal with human differences in creative and supportive ways in order to develop more |
| | | cooperative relationships. |
| | Skill: | Moving relationships to increasing levels of cooperation. |
| | | Experiencing camaraderie. |
| | | Making and accepting reciprocating offers of assistance and responsibility. |
| | Skill Phrase: | To be supplied |
| | Skill Development: | To be supplied |
| 79M5 | Mutual Obedience | Having mutual and equal responsibility for establishing and being subject to a common |
| | | set of rules and guidelines in a group of persons. |
| | Skill: | Participate in establishing group rules. |
| | | Demonstrating commitment to the rules by not breaking them. |
| | | Keeping private information confidential. |
| | Skill Phrase: | To be supplied |
| | Skill Development: | To be supplied |
| 80M3 | Obedience/Duty | Complying with rules and moral/legal obligations established by parents and civic/religious |
| | | authorities. |
| | Skill: | Demonstrating commitment to the rules by not breaking them. |
| | | Accepting commands without critical evaluation. |
| | Skill Phrase: | To be supplied |
| | Skill Development: | To be supplied |
| 81M4 | Ownership | Possessing personal skills, powers, and property that give you a sense of personal authority. |
| | Skill: | Keeping up-to-date on the knowledge required by your profession. |
| | | Establishing a chain of command for decision-making. |
| | | Creating procedures to complete a task. |
| | Skill Phrase: | To be supplied |
| | Skill Development: | To be supplied |
| 82M4 | Patriotism/Esteem | Honoring your country, based on personal devotion, love, and support. |
| | Skill: | Actively supporting local Veteran associations. |
| | | Seeking to buy domestic products. |
| | | Learning about local and national history. |
| | Skill Phrase: | To be supplied |
| | Skill Development: | To be supplied |
| 83G2 | Physical Delight | Experiencing joy through all the senses of your body. |
| | Behavior: | Achieving pleasure and joy through physical sensations. |
| 84M6 | Pioneerism/Innovation | Giving leadership through pioneering new creative ideas. |
| | Skill: | Promoting the development of creative ideas and research. |
| | | Being a catalyst for change. |
| | Skill Phrase: | To be supplied |
| | Skill Development: | To be supplied |
| 85G4 | Play/Recreation | Enjoying a pastime or diversion from the anxiety of day-to-day living for the purpose of |
| | | undirected, spontaneous refreshment. |
| | Behavior: | Spontaneously playing to relax and unwind. |
| 86G6 | Presence | Spending quality time with others so that they are enlightened. |
| | Behavior: | Being aware and in tune with others in such a way that they better understand |
| | | themselves. |
| 87M3 | Prestige/Image | Maintaining physical appearance that reflects success and achievement, gains the esteem of |
| | | others, and promotes success. |
| | Skill: | Making an honest self-assessment of your appearance. |
| | | Learning to “dress for success” by emulating those you aspire to be like. |
| | | Accepting flattering remarks about your appearance and paying attention to what is |
| | | generally accepted. |
| | Skill Phrase: | To be supplied |
| | Skill Development: | To be supplied |
| 88M4 | Productivity | Feeling energized by generating and completing tasks and activities and achieving externally |
| | | established goals and expectations. |
| | Skill: | Creating or updating a “to do” list at the beginning/end of each day. |
| | | Keeping priorities clear and delegating routine tasks. |
| | Skill Phrase: | To be supplied |
| | Skill Development: | To be supplied |
| 89M2 | Property/Control | Accumulating and controlling property and financial assets, which provide you with a sense of |
| | | security that comes from having the ability to meet your needs. |
| | Skill: | Knowing how to take care of your personal property, home and garden. |
| | | Having the necessary legal knowledge to ensure that personal property is safe and |
| | | protected. |
| | Skill Phrase: | To be supplied |
| | Skill Development: | To be supplied |
| 90M7 | Prophet/Vision | Communicating the truth about global issues in a lucid manner so the hearer is able to |
| | | transcend his/her limited personal awareness and gain new perspective on self and family |
| | | needs. |
| | Skill: | Recognizing the needs of others and trying to understand what they are seeking. |
| | | Formulating new ideas from seemingly unrelated data. |
| | Skill Phrase: | To be supplied |
| | Skill Development: | To be supplied |
| 91M5 | Quality/Evaluation | Appreciating objective self-appraisal and recognizing that other's reflections about you are |
| | | necessary to improve your self-awareness, personal growth, and service to others. |
| | Skill: | Soliciting feedback from peers and colleagues. |
| | | Being open to criticism. |
| | Skill Phrase: | To be supplied |
| | Skill Development: | To be supplied |
| 92M4 | Reason | Thinking logically and reasonably based on a formal body of information. The capacity to |
| | | exercise reason before emotions. |
| | Skill: | Establishing objective criteria for decision-making. |
| | | Suspending judgment to consider alternative solutions. |
| | | Having confidence in your own ability to solve any problem. |
| | Skill Phrase: | To be supplied |
| | Skill Development: | To be supplied |
| 93M5 | Relaxation | Diversion from physical or mental work, which reduces your stress and provides you with a |
| | | balance of work and play. |
| | Skill: | Keeping an appropriate balance between work and play. |
| | | Positively responding to and coping with interpersonal conflict. |
| | Skill Phrase: | To be supplied |
| | Skill Development: | To be supplied |
| 94M6 | Research | Investigating and contemplating systematically the nature of truths and principles about |
| | | people and human experience for the purpose of creating new insights and awareness. |
| | Skill: | Using a systematic process of investigation when making decisions and solving problems. |
| | | Using questioning to elevate and clarify your awareness of topics and issues. |
| | Skill Phrase: | To be supplied |
| | Skill Development: | To be supplied |
| 95M4 | Responsibility | Being personally accountable for your life and family. |
| | Skill: | Stating your beliefs an affirming your actions. |
| | | Keeping others informed. |
| | | Gaining consensus in areas where others' support is required. |
| | Skill Phrase: | To be supplied |
| | Skill Development: | To be supplied |
| 96M3 | Rights/Respect | Esteeming the worth (and property) of another as you expect others to esteem yours. |
| | Skill: | Considering needs in the context of fairness to all. |
| | | Remembering to always attack the issue, never the individual. |
| | | Accepting the fact that some people may be happier (and more productive) outside of |
| | | your inner circle. |
| | Skill Phrase: | To be supplied |
| | Skill Development: | To be supplied |
| 97M6 | Ritual/Communication | Using skills, rituals, and the arts as communication mediums for raising critical consciousness |
| | | of complex and difficult issues, such as world social conditions and transcendental knowledge. |
| | Skill: | Sponsoring events that increase knowledge of other cultures' beliefs, religions, and |
| | | rituals, and that highlight social injustices. |
| | Skill Phrase: | To be supplied |
| | Skill Development: | To be supplied |
| 98M4 | Rule/Accountability | Explaining or justifying your behavior in relation to established codes of conduct and |
| | | procedures. |
| | Skill: | Feeling confident that you are acting within acceptable standards. |
| | | Judging others based on traditional practices. |
| | Skill Phrase: | To be supplied |
| | Skill Development: | To be supplied |
| 99M1 | Safety/Survival | Having concern about the ability to avoid personal injury and danger of loss and doing what is |
| | | necessary to protect yourself in adverse circumstances. |
| | Skill: | Planning for your safety in potentially dangerous situations. |
| | | Being physically defensive. |
| | Skill Phrase: | To be supplied |
| | Skill Development: | To be supplied |
| 100M5 | Search/Meaning/Hope | Exploring how to integrate your feelings, imagination, and objective knowledge in order to |
| | | discover your unique place in the world. |
| | Skill: | Having an intense curiosity about your purpose and meaning in the world. |
| | | Encouraging others to explore all dimensions of an issue. |
| | Skill Phrase: | To be supplied |
| | Skill Development: | To be supplied |
| 101M2 | Security | Finding a safe place or relationship where you experience protection and are free from cares |
| | | and anxieties. |
| | Skill: | Ensuring that your family's physical and financial needs are met. |
| | Skill Phrase: | To be supplied |
| | Skill Development: | To be supplied |
| 102G5 | Self Development | Experiencing and expressing the totality of your being through spiritual, psychological, |
| | | physical, and mental exercises that lead you to realize your maximum potential. |
| | Behavior: | Continuously improving to maximize your own potential. |
| 103M5 | Self Assertion | Stepping forward boldly to express a personal line of thought or action. |
| | Skill: | Being persuasive in challenging the status quo. |
| | | Being quick to offer your ideas in groups rather than waiting for others to express their |
| | | ideas first. |
| | | leading others without hang asked. |
| | Skill Phrase: | To be supplied |
| | Skill Development: | To be supplied |
| 104G1 | Self Interest/Control | Restraining your feelings and controlling your personal interests in order to survive physically |
| | | in the world. |
| | Behavior: | Putting your own interests first. |
| 105G1 | Self Preservation | Doing what is necessary to protect yourself from physical harm or destruction. |
| | Behavior: | Protecting physical as well as financial interests from harm. |
| 106G3 | Self Worth | Knowing that when people you respect and esteem really know you, they will confirm that |
| | | you are worthy of that respect. |
| | Behavior: | Knowing that you are worthy of respect and esteem. |
| 107M2 | Sensory Pleasure | Gratifying your sensual desires and experiencing your sexual identity. |
| | Skill: | Pleasing another person with physical tenderness. |
| | | Touching in such a way as to enable a person to feel safe and secure. |
| | Skill Phrase: | To be supplied |
| | Skill Development: | To be supplied |
| 108G5 | Service/Vocation | Using your unique gifts and skills to contribute to society through your occupation, business, |
| | | profession, or calling. |
| | Behavior: | Using your skills to serve others well. |
| 109M5 | Sharing/Listening/Trust | Hearing another person's thoughts and feelings accurately and expressing your own thoughts |
| | | and feelings in a climate of mutual confidence in each other's integrity. |
| | Skill: | Listening in a caring way to the joys and tribulations of others. |
| | | Avoiding defensive reactions when other people are talking to you. |
| | | Not being limited by your own expectations of others. |
| | Skill Phrase: | To be supplied |
| | Skill Development: | To be supplied |
| 110M6 | Simplicity/Play | Combining appreciation for the world with a playful attitude toward organizations and |
| | | systems that is energizing and positive. Having the ability to see simplicity in complexity and |
| | | to be detached from the world as primarily material in nature. |
| | Skill: | Keeping on appropriate balance between work and play. |
| | | Relaxing by paying attention to your breathing; practicing meditation. |
| | | Being able to laugh at your own mistakes and help others to do the same. |
| | Skill Phrase: | To be supplied |
| | Skill Development: | To be supplied |
| 111M3 | Social Affirmation | Receiving personal respect and validation from the support and respect of your peers, which |
| | | is necessary for one to grow and succeed. |
| | Skill: | Affirming others, even when dealing with conflict. |
| | | Showing a genuine interest in others. |
| | Skill Phrase: | To be supplied |
| | Skill Development: | To be supplied |
| 112M3 | Support/Peer | Having persons, who are your equals, sustain one in both joyful and difficult times. |
| | Skill: | Sharing your experiences with friends or colleagues. |
| | | Seeking input from others and gaining their support and commitment. |
| | Skill Phrase: | To be supplied |
| | Skill Development: | To be supplied |
| 113M7 | Synergy | Experiencing the relationships within a group as harmonious and energized so that the |
| | | achievements of the group far surpass the predicted outcome based on the total abilities of |
| | | its individual members. |
| | Skill: | Suspending critical judgment and avoiding the notion that “it will not work.” |
| | | Recognizing that cooperating with others will enable you to achieve more than what you |
| | | could if acting alone. |
| | Skill Phrase: | To be supplied |
| | Skill Development: | To be supplied |
| 114M4 | Technology/Science | Understanding the physical or natural world and applying that knowledge through man-made |
| | | devices and tools. |
| | Skill: | Applying knowledge toward the creation of tangible products. |
| | | Seeking opportunities to work with others who are experts in your area. |
| | Skill Phrase: | To be supplied |
| | Skill Development: | To be supplied |
| 115M2 | Territory/Security | Providing for physical defense of property, personal domain, or territory. |
| | Skill: | Having skills in surveillance and personal protection. |
| | | Practicing the martial arts. |
| | Skill Phrase: | To be supplied |
| | Skill Development: | To be supplied |
| 116M3 | Tradition | Ritualizing family, religious and national history to enrich the meaning of life. |
| | Skill: | Organizing historic and values-oriented education programs. |
| | | Celebrating historic events and family milestones. |
| | Skill Phrase: | To be supplied |
| | Skill Development: | To be supplied |
| 117M7 | Transcendence/Solitude | Exercising spiritual discipline and detachment in order to experience a global and visionary |
| | | perspective. |
| | Skill: | Making creative use of silence, which allows for reflection and formulation of thoughts. |
| | | Being alert to non-verbal signals of rejection and withdrawal and showing compassion. |
| | | Recognizing the needs of others and trying to understand what they are seeking. |
| | Skill Phrase: | To be supplied |
| | Skill Development: | To be supplied |
| 118G7 | Truth/Wisdom | Pursuing and discovering ultimate truth above all else. This results in intimate knowledge of |
| | | objective and subjective realities, which converge into the capacity to clearly comprehend |
| | | persons and systems and their interrelationships. |
| | Behavior: | Examining knowledge to gain new insights and truths. |
| 119M6 | Unity/Diversity | Recognizing and acting on the belief that a group is creatively enhanced by giving equal |
| | | opportunity to persons from a variety of cultures, ethnic backgrounds, and education. This |
| | | includes the realization that differences are an advantage in a collaborative learning |
| | | environment. |
| | Skill: | Being sensitive to and welcoming gender, racial, and ethnic differences. |
| | | Recognizing and celebrating your own weaknesses. |
| | | Utilizing diverse opinions and viewpoints when making decisions. |
| | Skill Phrase: | To be supplied |
| | Skill Development: | To be supplied |
| 120M4 | Unity/Uniformity | Encouraging harmony and agreement in a group to achieve efficiency, order, loyalty, and |
| | | conformity with establishec norms. |
| | Skill: | Having an agenda and setting clear objectives. |
| | | Molding diverse opinions and viewpoints into clear rules for behavior and actions. |
| | | Searching for “win-win” solutions. |
| | Skill Phrase: | To be supplied |
| | Skill Development: | To be supplied |
| 121G1 | Wonder/Awe/Fate | Being filled with marvel, amazement, and fear when faced with the overwhelming grandeur |
| | | and power of your physical environment. |
| | Behavior: | Having a beautiful natural sight “take your breath away”. |
| 122M2 | Wonder/Curiosity | Sensing marvel and amazement about the physical world, while desiring to learn about it and |
| | | explore it personally. |
| | Skill: | Feeling an inner peace when alone in nature. |
| | | Knowing methods of survival in the wilderness. |
| | | Being competent in a particular outdoors activity such as hiking or sailing. |
| | Skill Phrase: | To be supplied |
| | Skill Development: | To be supplied |
| 123G8 | Word | Communicating universal truths so effectively that the hearer becomes conscious of his/her |
| | | limitations, yet their life and hope are renewed. |
| | Behavior: | Achieving clarity and being motivated and passionate in the presentation of ideas. |
| 124G4 | Work/Labor | Having skills and rights that allow you to produce a minimal living for yourself and your |
| | | family. |
| | Behavior: | Working at job that supports you and your family. |
| 125M4 | Workmanship/Art/Craft | Developing skills requiring manual dexterity that produce artifacts and modify or beautify the |
| | | hand-made environment. |
| | Skill: | Being an artisan or expert in your field. |
| | | Regularly discussing innovations with others of similar interest. |
| | Skill Phrase: | To be supplied |
| | Skill Development: | To be supplied |

Determining family values and creating a family mission statement preserves and communicates family values and purpose to future generations, provides a common touchstone that expresses what is most important to a family, serves as a guide for family decisions and interactions, and establishes clear direction for the management of a family's wealth, which enables preservation and growth of family assets for successive generations.

Identifying personal values of members of a family requires participants to answer questions to prioritize their core values. Values reports may then be created by a system hosting the values questions. The reports based on personal values may also be linked to different decision-making structures which may underlie the family's governance, the preferred basis and guides for decision-making, a report detailing what additional skills the respondent may need to develop, and their worldview.

The personal values are then compiled into a family Shared Values Report, The primary objective of the family Shared Values Report is to identify and help all family members understand and affirm their family's values which consist, of those core values that family members had in common with all or most other members of their family. After the family Shared Values Report is available, the family members may meet with the advisor to review and discuss the report and to make sure they all understand and agree with the presented family values.

Preparing a Personal Values Report

Personal values can be ascertained through a values survey. A respondent to the values survey will be asked to answer 125 questions. A raw score will be calculated based on the answers submitted to the 125-question survey of which a minimum of 119 valid answers (6 answers of Not Applicable are allowed) are required. Each of the questions in the 125 question Values Survey offers a choice among 4 different values. Each value occurs 4 times during the survey. Thus it is possible to select any one value a maximum of 4 times.

There are many ways to process the answers to the questions. According to the preferred embodiment of the present invention, commercially available software by for example, Values Technologies, Inc. may be used to process the answers. It uses a set of rules described below to process the answers to the questions. The processed answers yield raw statistical data and data groupings derived from the frequency of the values chosen by the person taking the survey. This data may then be used as input for many other reports.

### Exemplary Processing Logic

According to an exemplary embodiment of the present invention, processing of the Values Survey to extract the values selected by a respondent when taking the survey may follow the rules immediately below:
a. The values survey consists of 125 questions having 5 answers each.
b. Each question has four answers that each represent one of 125 values as listed in TABLE 1 above.
c. Each question also has one answer that is “not applicable at this time”
d. A respondent is restricted from selecting “not applicable at this time” more than six times.
e. At the completion of the values survey by a respondent, the values totals are aggregated using a key that maps the question answers to the value numbers. A sample key according to the exemplary embodiment is reproduced immediately below in TABLE 2. Also see TABLE 1 for a list for all definitions, skills and behaviors associated with each value.
   The aggregated results may be used for all further processing that involves values to identify or prioritize report data. If group calculations are needed then the individual scores are summed for each value prior to applying to the report logic. The list of value names mapped to value numbers is in the public domain. It is provided here for completeness.

### By way of example, a question on the values survey may be;

I am a person who:
puts a priority on self preservation.
is confident in my ability to excel and make positive contributions in my chosen occupation.
values being financially secure and comfortable that my basic needs will be met.
puts family first.
not applicable at this time

### A chosen answer would then be mapped according to the exemplary key in TABLE 2 immediately below.

TABLE 2
Sample Key

| Q # | Ans A | Ans B | Ans C | Ans D |
|---|---|---|---|---|
| 1 | 105 | 16 | 101 | 46 |
| 2 | 83 | 47 | 85 | 21 |
| 3 | 121 | 102 | 86 | 35 |
| 4 | 58 | 21 | 46 | 61 |
| 5 | 118 | 83 | 85 | 66 |
| 6 | 61 | 105 | 45 | 118 |
| 7 | 106 | 16 | 102 | 86 |
| 8 | 83 | 66 | 61 | 9 |
| 9 | 10 | 121 | 6 | 64 |
| 10 | 9 | 47 | 123 | 118 |
| 11 | 108 | 101 | 124 | 20 |
| 12 | 121 | 101 | 21 | 85 |
| 13 | 104 | 47 | 52 | 41 |
| 14 | 6 | 104 | 10 | 108 |
| 15 | 106 | 35 | 66 | 64 |
| 16 | 46 | 16 | 41 | 58 |
| 17 | 102 | 105 | 106 | 64 |
| 18 | 108 | 46 | 21 | 52 |
| 19 | 83 | 58 | 41 | 123 |
| 20 | 101 | 45 | 118 | 52 |
| 21 | 9 | 105 | 124 | 108 |
| 22 | 20 | 124 | 86 | 35 |
| 23 | 6 | 47 | 124 | 61 |
| 24 | 104 | 41 | 20 | 123 |
| 25 | 6 | 45 | 66 | 35 |
| 26 | 10 | 6 | 86 | 123 |
| 27 | 85 | 102 | 58 | 45 |
| 28 | 10 | 9 | 64 | 52 |
| 29 | 104 | 06 | 21 | 20 |
| 30 | 40 | 48 | 51 | 113 |
| 31 | 4 | 99 | 70 | 94 |
| 32 | 107 | 49 | 7 | 94 |
| 33 | 11 | 112 | 56 | 54 |
| 34 | 117 | 30 | 55 | 50 |
| 35 | 22 | 5 | 91 | 12 |
| 36 | 125 | 115 | 79 | 119 |
| 37 | 38 | 60 | 65 | 42 |
| 38 | 36 | 99 | 100 | 23 |
| 39 | 28 | 71 | 97 | 122 |
| 40 | 79 | 49 | 31 | 76 |
| 41 | 84 | 34 | 67 | 33 |
| 42 | 8 | 109 | 14 | 5 |
| 43 | 98 | 116 | 44 | 29 |
| 44 | 1 | 56 | 110 | 7 |
| 45 | 107 | 25 | 92 | 50 |
| 46 | 31 | 48 | 11 | 72 |
| 47 | 89 | 69 | 32 | 53 |
| 48 | 82 | 110 | 88 | 111 |
| 49 | 87 | 25 | 4 | 7 |
| 50 | 70 | 49 | 54 | 57 |
| 51 | 115 | 96 | 33 | 75 |
| 52 | 22 | 93 | 90 | 97 |
| 53 | 43 | 48 | 51 | 62 |
| 54 | 122 | 68 | 107 | 87 |
| 55 | 44 | 63 | 14 | 107 |
| 56 | 122 | 115 | 82 | 111 |
| 57 | 27 | 1 | 50 | 59 |
| 58 | 76 | 100 | 110 | 115 |
| 59 | 29 | 122 | 37 | 117 |
| 60 | 99 | 33 | 42 | 74 |
| 61 | 15 | 65 | 8 | 59 |
| 62 | 2 | 48 | 26 | 93 |
| 63 | 72 | 11 | 3 | 18 |
| 64 | 125 | 100 | 26 | 22 |
| 65 | 81 | 89 | 40 | 3 |
| 66 | 25 | 28 | 77 | 44 |
| 67 | 27 | 116 | 36 | 30 |
| 68 | 19 | 62 | 11 | 75 |
| 69 | 1 | 23 | 55 | 25 |
| 70 | 73 | 30 | 91 | 24 |
| 71 | 30 | 95 | 15 | 43 |
| 72 | 13 | 42 | 40 | 103 |
| 73 | 114 | 98 | 8 | 24 |
| 74 | 80 | 42 | 120 | 67 |
| 75 | 13 | 19 | 63 | 50 |
| 76 | 87 | 39 | 32 | 49 |
| 77 | 40 | 109 | 78 | 53 |
| 78 | 103 | 89 | 113 | 18 |
| 79 | 60 | 73 | 99 | 77 |
| 80 | 80 | 74 | 3 | 119 |
| 81 | 8 | 51 | 38 | 88 |
| 82 | 87 | 81 | 69 | 2 |
| 83 | 92 | 96 | 114 | 71 |
| 84 | 80 | 89 | 17 | 33 |
| 85 | 56 | 39 | 59 | 111 |
| 86 | 17 | 80 | 12 | 29 |
| 87 | 112 | 23 | 94 | 125 |
| 88 | 34 | 96 | 56 | 84 |
| 89 | 36 | 112 | 74 | 103 |
| 90 | 93 | 75 | 26 | 112 |
| 91 | 116 | 57 | 5 | 95 |
| 92 | 111 | 13 | 19 | 12 |
| 93 | 100 | 76 | 37 | 116 |
| 94 | 96 | 94 | 68 | 75 |
| 95 | 65 | 43 | 2 | 125 |
| 96 | 22 | 54 | 14 | 2 |
| 97 | 114 | 94 | 76 | 92 |
| 98 | 110 | 4 | 98 | 70 |
| 99 | 60 | 62 | 4 | 1 |
| 100 | 13 | 15 | 7 | 113 |
| 101 | 73 | 34 | 67 | 17 |
| 102 | 91 | 17 | 95 | 90 |
| 103 | 92 | 88 | 55 | 31 |
| 104 | 114 | 37 | 79 | 23 |
| 105 | 27 | 38 | 28 | 69 |
| 106 | 120 | 44 | 82 | 24 |
| 107 | 81 | 63 | 117 | 120 |
| 108 | 57 | 51 | 32 | 71 |
| 109 | 73 | 3 | 77 | 34 |
| 110 | 109 | 18 | 90 | 28 |
| 111 | 72 | 78 | 84 | 36 |
| 112 | 68 | 38 | 67 | 97 |
| 113 | 39 | 5 | 78 | 90 |
| 114 | 103 | 57 | 29 | 59 |
| 115 | 68 | 12 | 65 | 19 |
| 116 | 32 | 77 | 119 | 53 |
| 117 | 74 | 91 | 97 | 69 |
| 118 | 55 | 18 | 78 | 81 |
| 119 | 60 | 82 | 31 | 14 |
| 120 | 88 | 24 | 26 | 39 |
| 121 | 15 | 27 | 53 | 72 |
| 122 | 70 | 95 | 43 | 117 |
| 123 | 93 | 98 | 54 | 71 |
| 124 | 79 | 63 | 119 | 62 |
| 125 | 113 | 84 | 109 | 37 |

As previously stated, the processing rules for the 125 question questionnaire are available commercially from Values Technology, Inc. These calculations provide us with raw statistical data and data groupings derived from the frequency of the values chosen by the person taking the survey. This data is used as input for many other reports. The reports that use this data make reference to that fact in their logic descriptions. An indicator is calculated by the above rules to identify a group of values that are used by a person to make most of their day-to-day decisions. These values can be identified as focus values clusters. Values from other value groups are identified that will from time to time, if strongly held, be used to make daily decisions. These values data groupings are all provided from the above rules.

After the question answers have been processed, according to the exemplary embodiment, the wealth management system of the present invention will prepare the Person Values Report according to the following set of rules:
1. All values selected 4 times will be included in the Personal Values Report.
2. All values selected 3 times in the focus values cluster will be included in the report, as well.
3. The list of value names is sorted alphabetically A through Z for presentation in the Personal Values Report.
4. A report will be created for the Advisors that lists:
   a. The value name; value definition, sample behaviors
   b. The survey answers that may have been selected by the survey respondent. The unique (duplicates will not be displayed) question text will be presented as part of the information for the chosen value.
5. A report for the client family member will not contain the survey answer text.

Preparing a Family's Shared Values Report

The values that are listed on the family Shared Values Report are those values that were selected at least 2 times by at least 50% of family members in the value survey, whose purpose, logic, and parameters were discussed above with reference to preparing personal values reports. The number of times each of the values thus selected were chosen by all the respondents is summed. This list of values are separated into two lists, one of goal values and one of means values. The individual lists are sorted in highest to lowest number of times chosen. The top eight goal values are then selected. If there are not eight in the list then as many as there are, are used. Also, the top ten means values are selected. If there are not 10 in the list then as many as there are, are used. The two lists are then combined. For placement on the report the values are sorted in alphabetical order. The detail of the report may contain the: Value name; value definition; sample behaviors associated with the listed values.

The Draft Family Mission Statement

The family mission statement attaches non-economic meaning and purpose to family wealth through its expression of the family values. It also provides family members with representation in and ownership of family direction and purpose. The family mission statement also establishes a touchstone with which to evaluate family decisions and actions. It can be a working document accessible both to the family and the advisor of the wealth management process.

The process of determining the text pieces for the Draft Family Mission Statement is one of tabulating the individual values scores from the values survey, whose purpose, logic, and parameters were discussed above with reference to preparing personal values reports. These scores are then assigned to values groupings that are believed to embody the various purpose and goal statements that will be used to construct the Draft Family Mission Statement. The values groupings are then ordered from highest to lowest and, using a text template, inserted into the appropriate places in the template below. Once family shared values and the mission statement have been identified and prepared, respectively, the family is ready to move to the next phase.

### Family Mission Statement Template

Our family's purpose is centered around P1-A and P2-A. P1-B includes P1-V1(A), P1-V2(A), and P1-V3(A). P2-B is important because it reflects P2-V1(B), P2-V2(B), and P2-V3(B).
In support of our purpose, we will G1-A, G2-A, and G3-A. G1-B represents our commitment to G1-V1(A) and G1-V2(A). G2-B signifies the importance of G2-V1(A) and G2-V2(A). G3-B is important because it embodies G3-V1(B) and G3-V2(B).
Together, we do these things to meet our responsibilities to R1, R2, and R3.
We will treat one another with GRI1, GRI2, and GRI3. We promise to treat others with GRE1, GRE2, and GRE3.
We will GS1 in pursuit of this mission.

TABLE 3 below is an example of one of the purpose identities for the Draft Family Mission Statement.

TABLE 3

| Purpose Name | P1:2-A | P1:2-B | V # | Value Name | P1:2-V1:3(A) | P1:2-V1:3(B) |
|---|---|---|---|---|---|---|
| Enhancing | enhancing the | Enhancing the pursuit of | 9 | Being Self | acting independently and | the ability to act |
| Happiness | pursuit of | happiness of our members | | | cooperatively | independently and |
| | happiness of | | | | | cooperatively |
| | our members | | 11 | Care/Nurture | providing physical and | mutual physical and |
| | | | | | emotional support to one | emotional support |
| | | | | | another | |
| | | | 14 | Community/Personalist | maximizing member | maximization of |
| | | | | | creativity and interdependent | member creativity |
| | | | | | action | and interdependent |
| | | | | | | action |
| | | | 15 | Community/Supportive | providing an environment of | an environment of |
| | | | | | mutual support | mutual support |
| | | | 19 | Congruence | openly expressing and | open expression and |
| | | | | | demonstrating our true | demonstration of our |
| | | | | | thoughts and feelings | true thoughts and |
| | | | | | | feelings |
| | | | 41 | Equality/Liberation | recognizing and supporting | recognition and |
| | | | | | individual equality | support of |
| | | | | | | individual equality |
| | | | 44 | Expressiveness/Joy | expressing joy openly and | open and |
| | | | | | spontaneously | spontaneous |
| | | | | | | expression of joy |
| | | | 96 | Rights/Respect | giving and receiving mutual | the giving and |
| | | | | | respect | receiving of mutual |
| | | | | | | respect |
| | | | 103 | Self Assertion | stepping forward and | the ability to step |
| | | | | | asserting our individual views | forward and assert |
| | | | | | | our individual views |
| | | | 102 | Self Development | acting to maximize individual | maximization of |
| | | | | | potential | individual potential |
| | | | 106 | Self Worth | knowing that others value us | the knowledge that |
| | | | | | as individuals | others value us as |
| | | | | | | individuals |
| | | | 119 | Unity/Diversity | embracing our diversity | celebration of our |
| | | | | | | diversity |

If then the sum of the number of times the values selected by all participants would identify this purpose identity as having the highest aggregate score the text pieces would be inserted into the Draft Family Mission Statement. And if the values Care/Nurture; Community/Personalist; and Community/Supportive were the values with the highest individual scores (in descending order), their text pieces would be inserted into the statement in the appropriate places as well.

Example using the above data, P2-A not interpreted for this example:
Our family's purpose is centered around “enhancing the pursuit of happiness of our members” and P2-A “Enhancing the pursuit of happiness of our members includes providing physical and emotional support to one another, maximizing member creativity and interdependent action, and providing an environment of mutual support.”

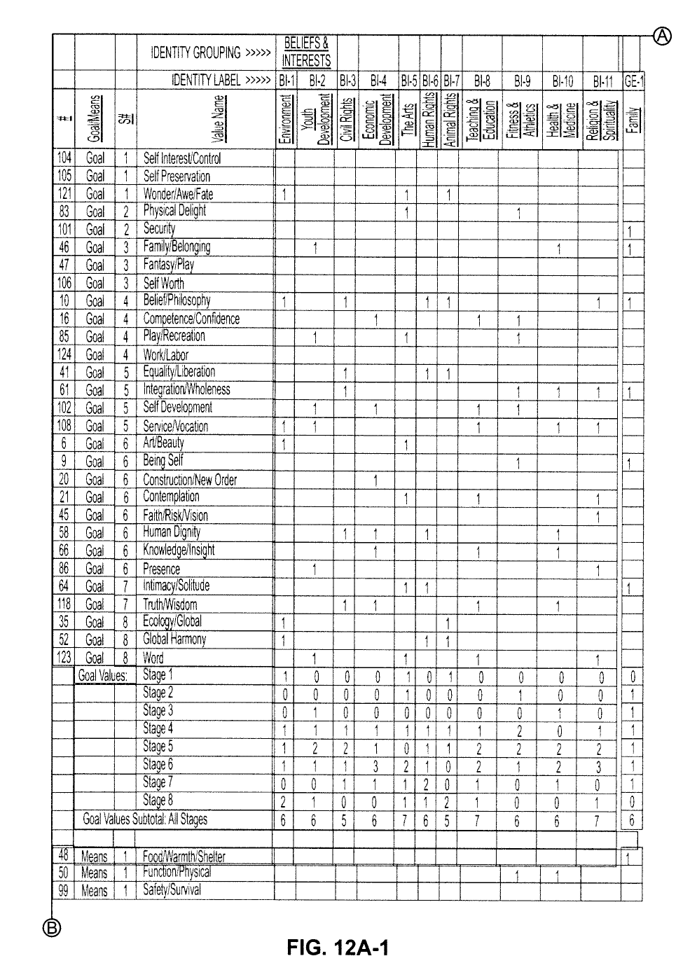

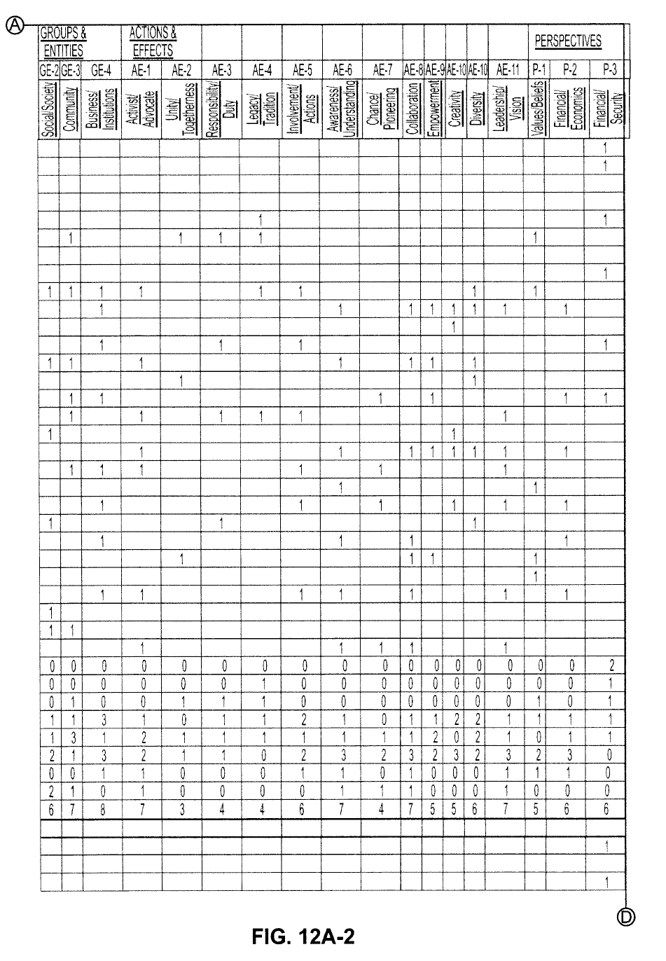

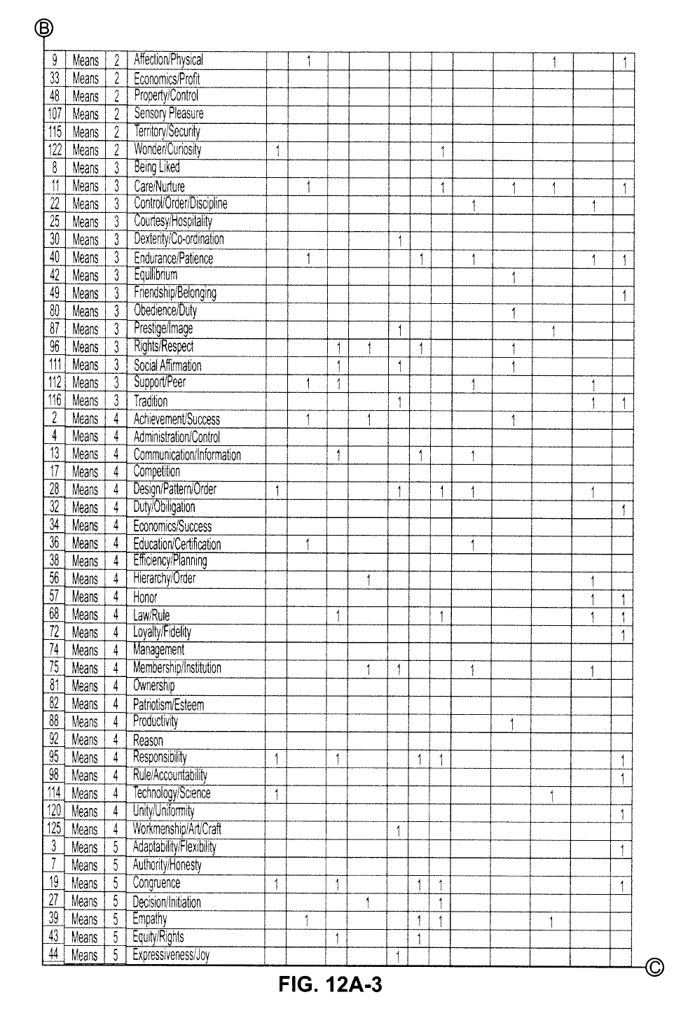

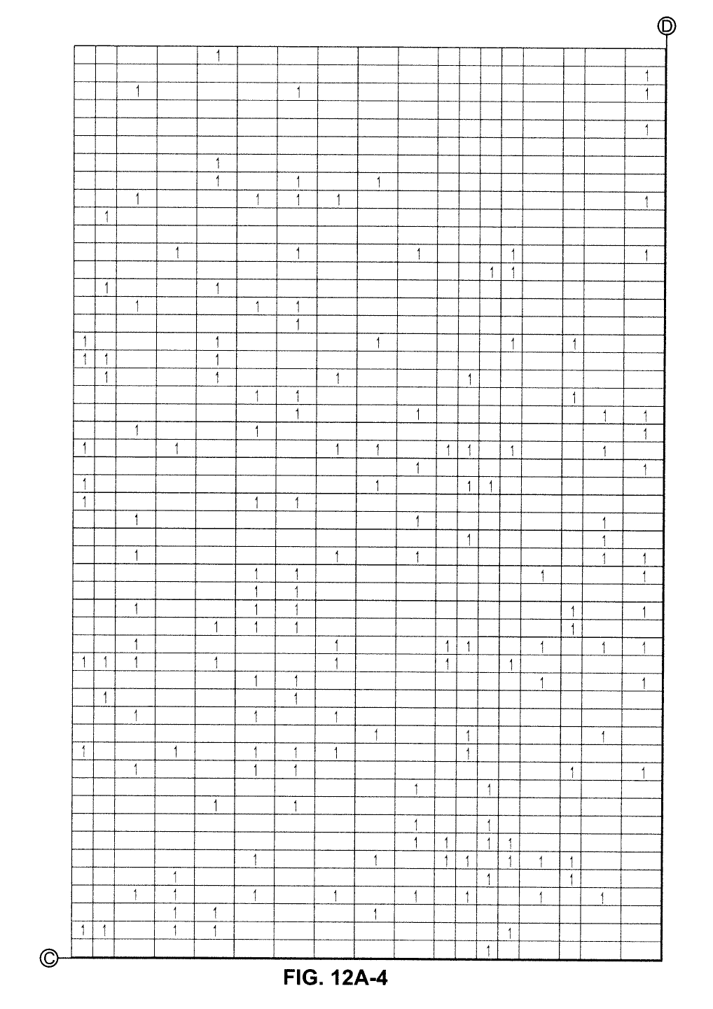

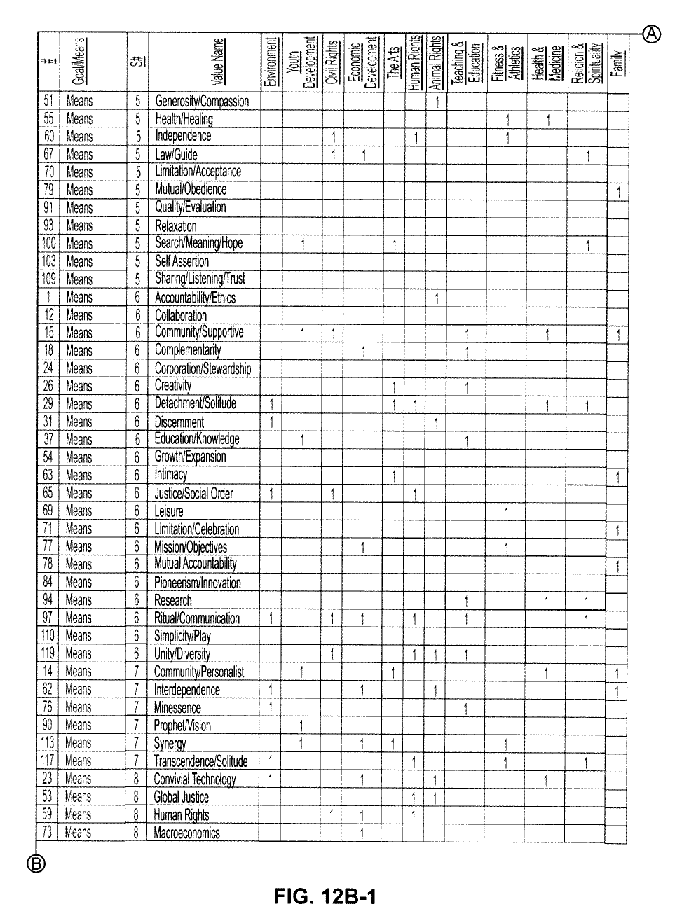

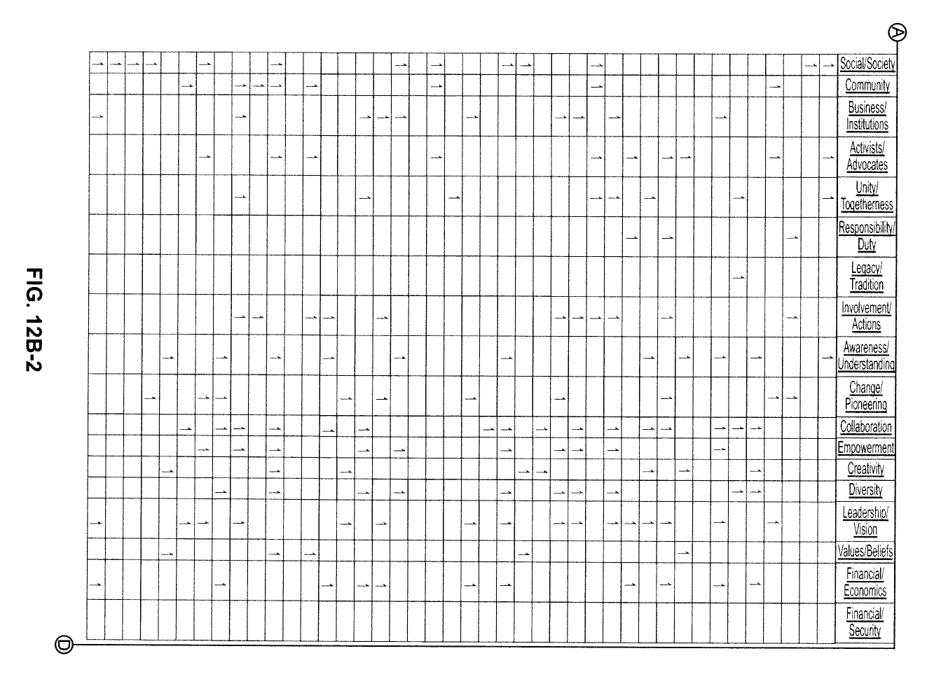

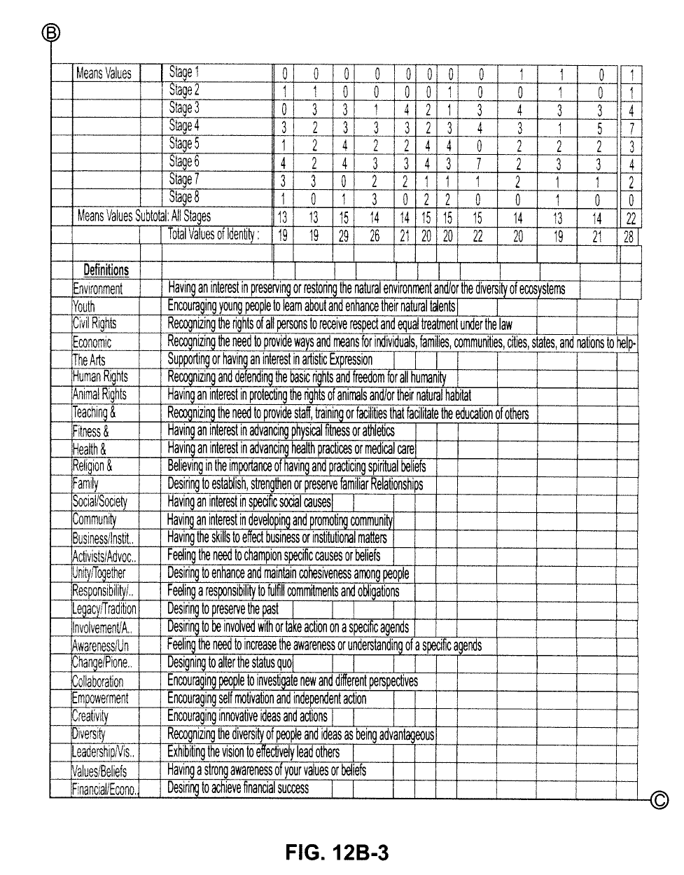

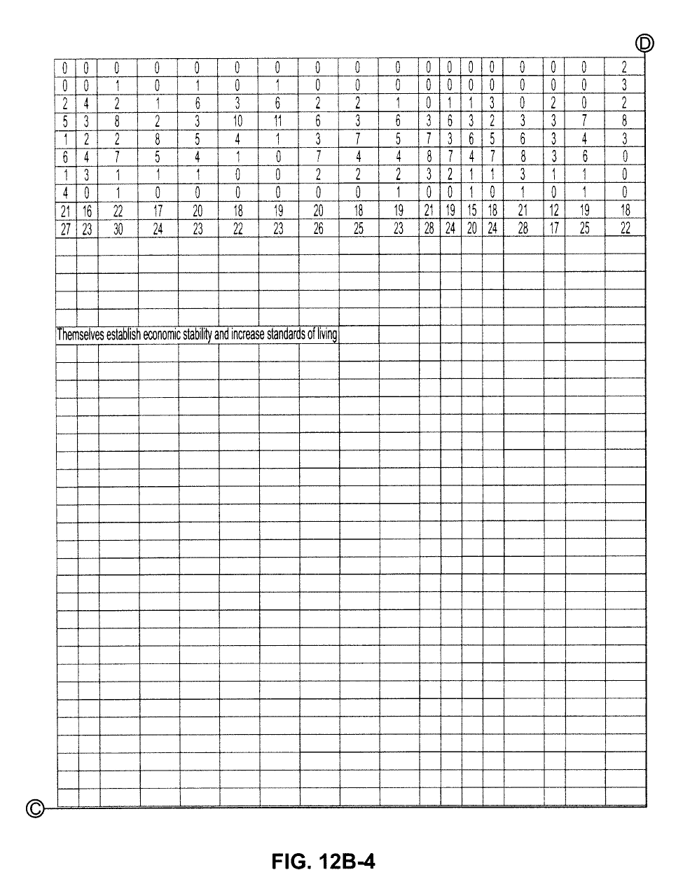

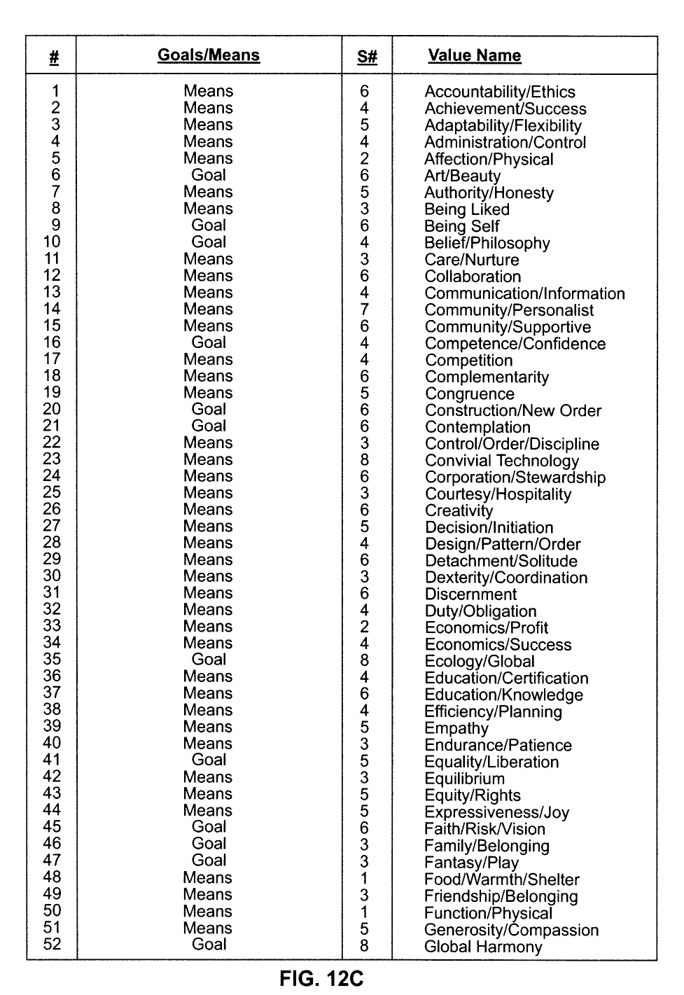

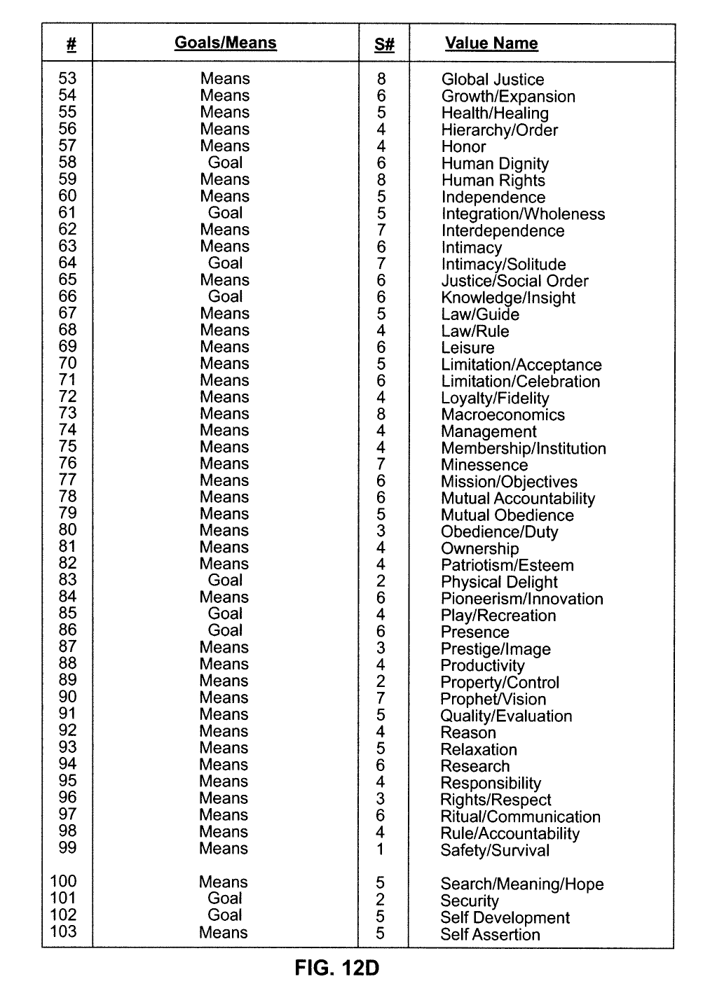

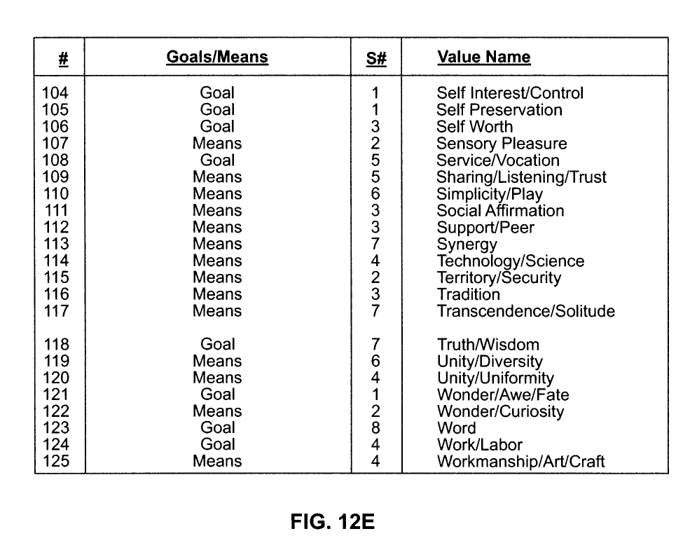

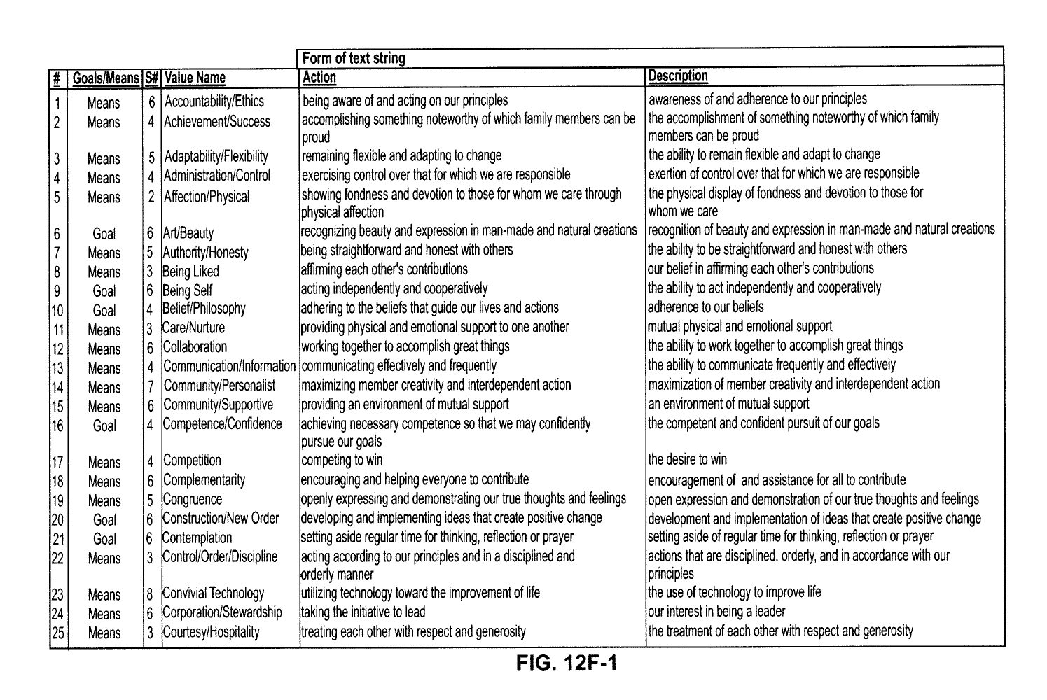

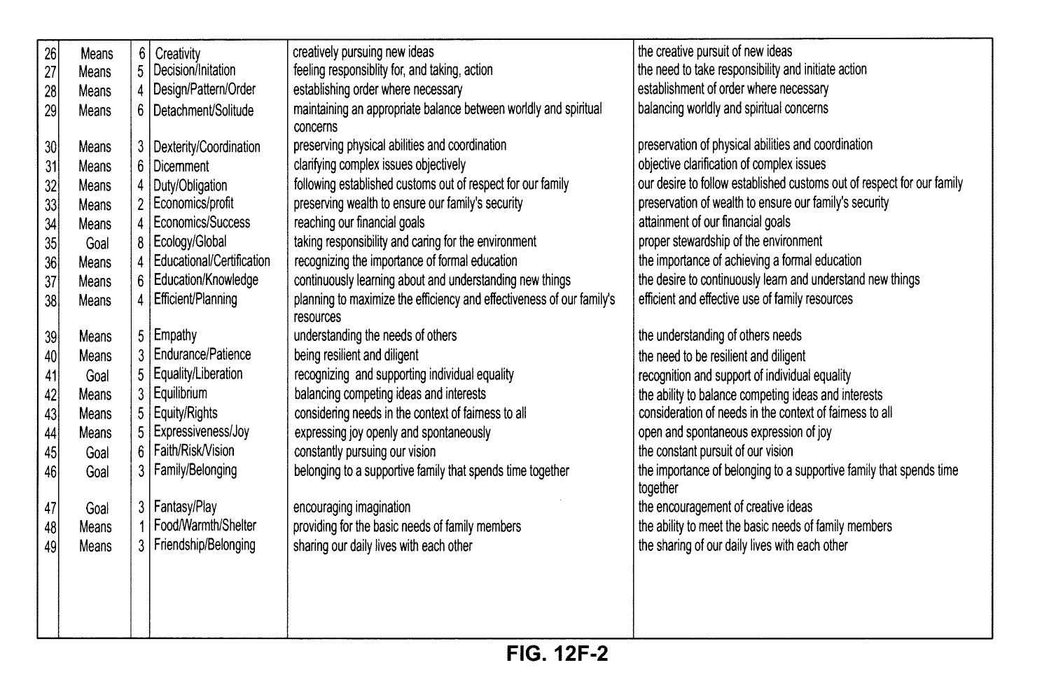

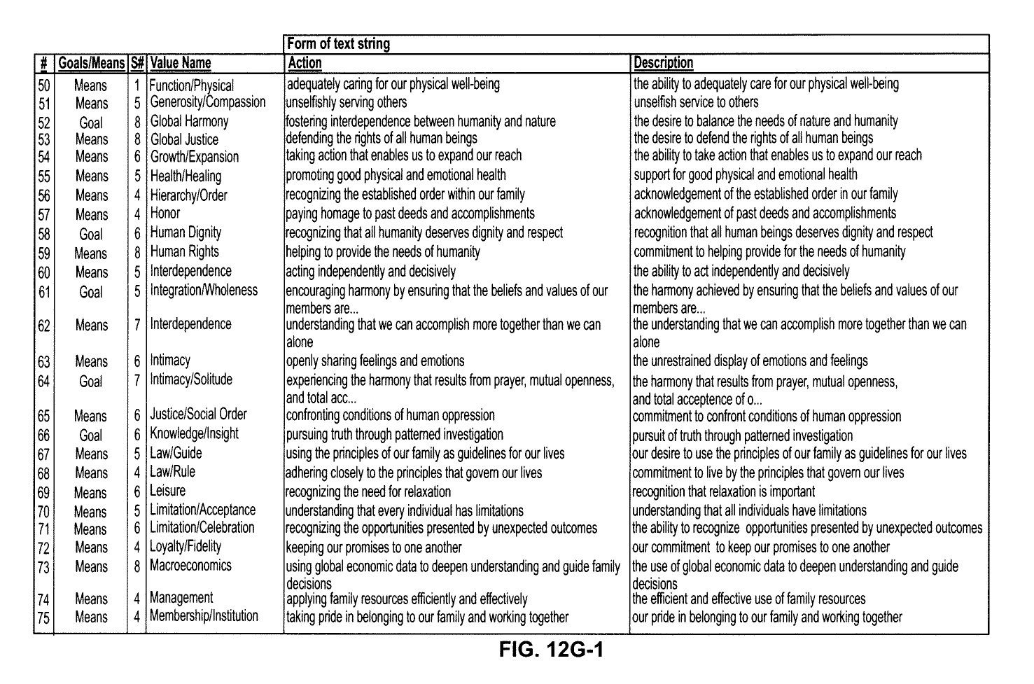

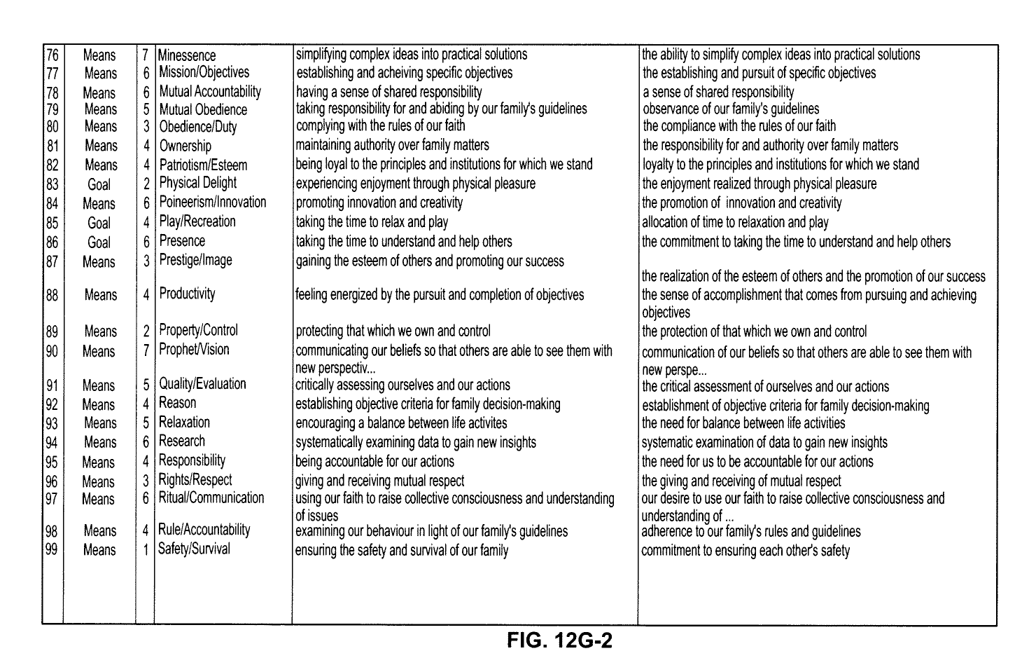

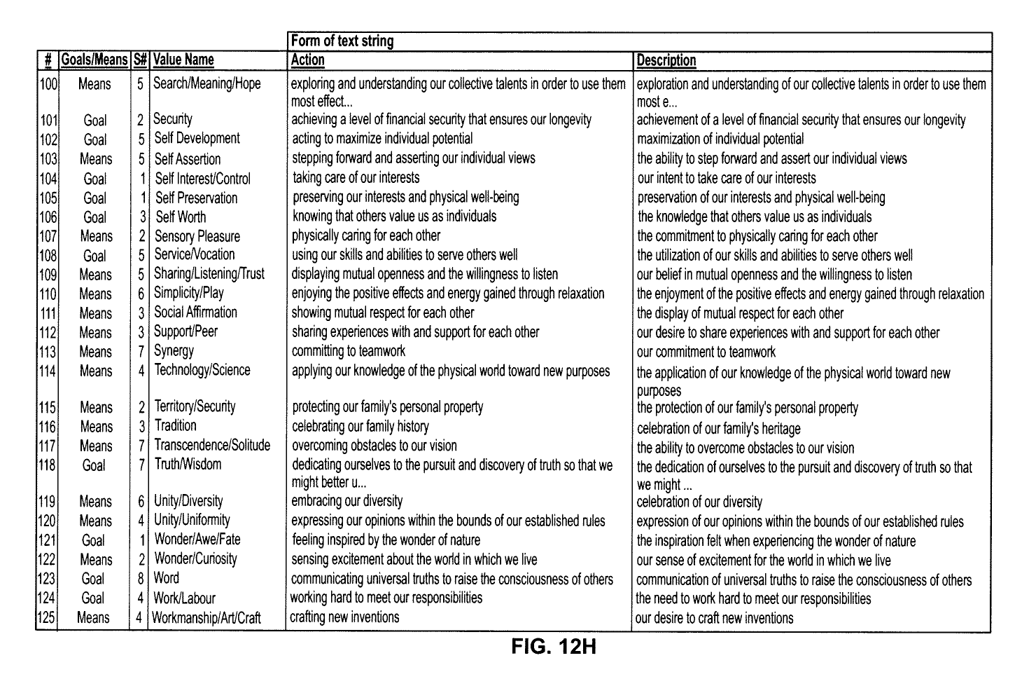

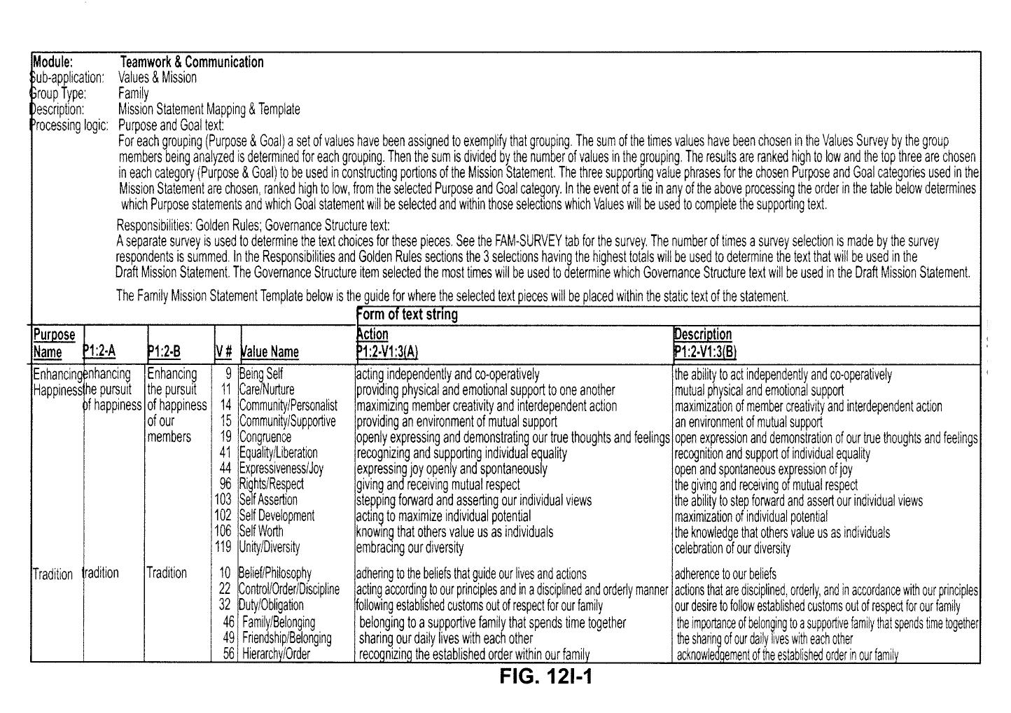

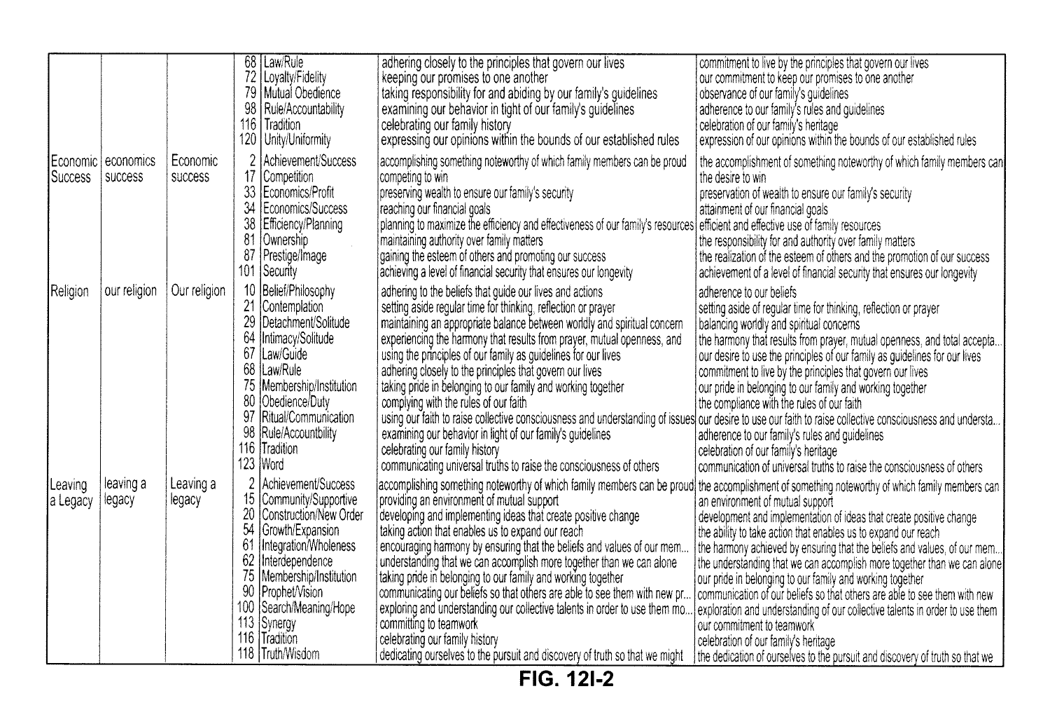

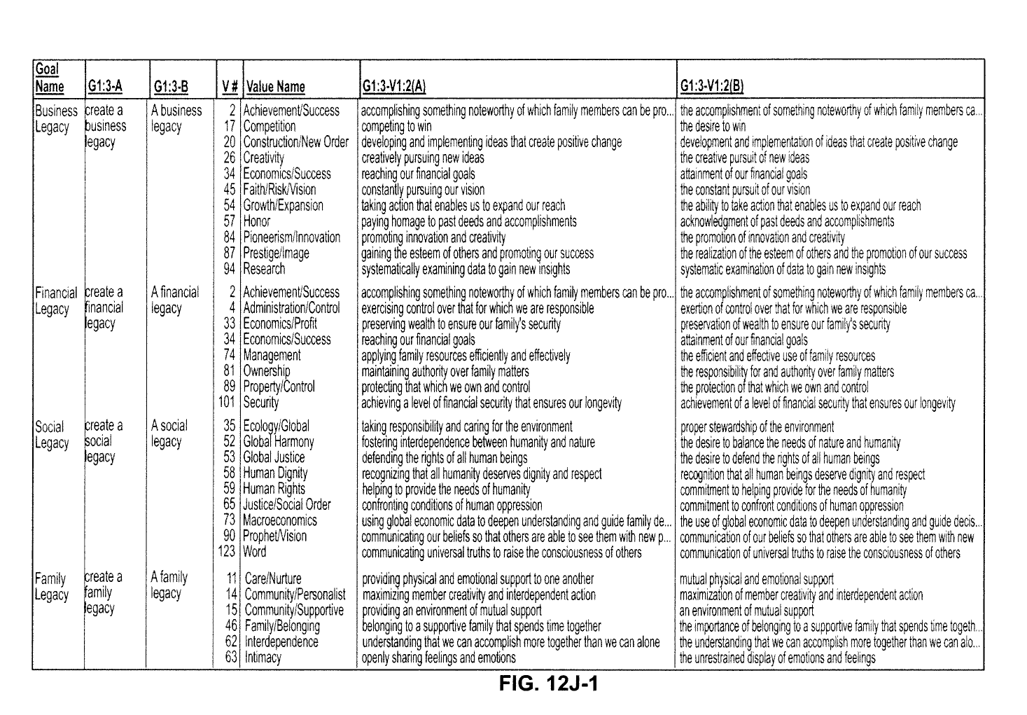

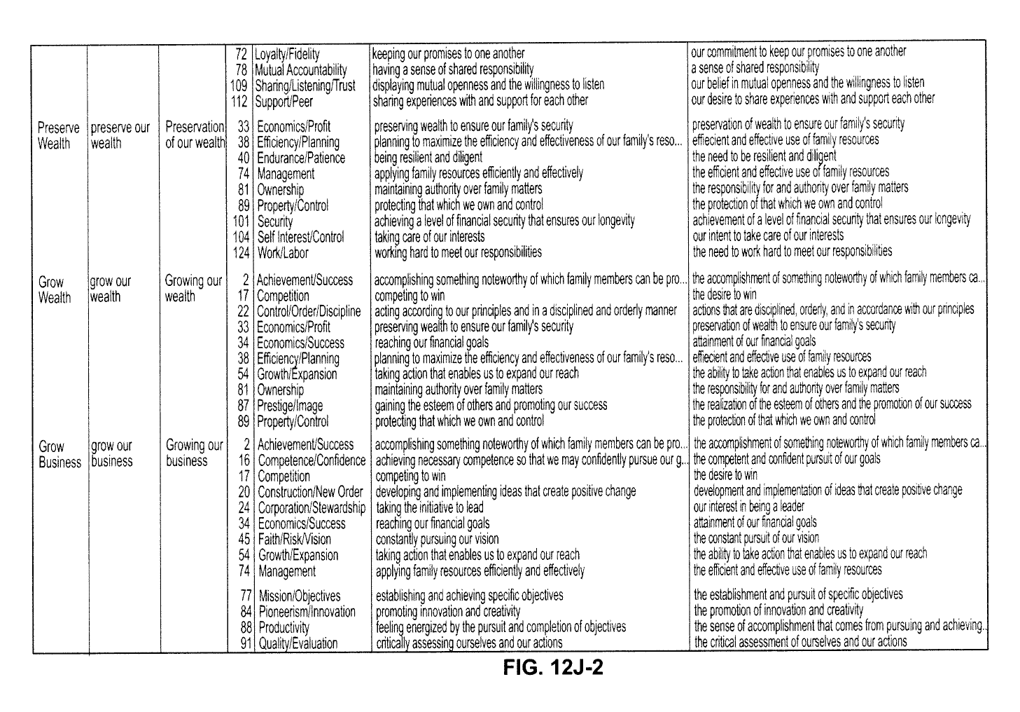

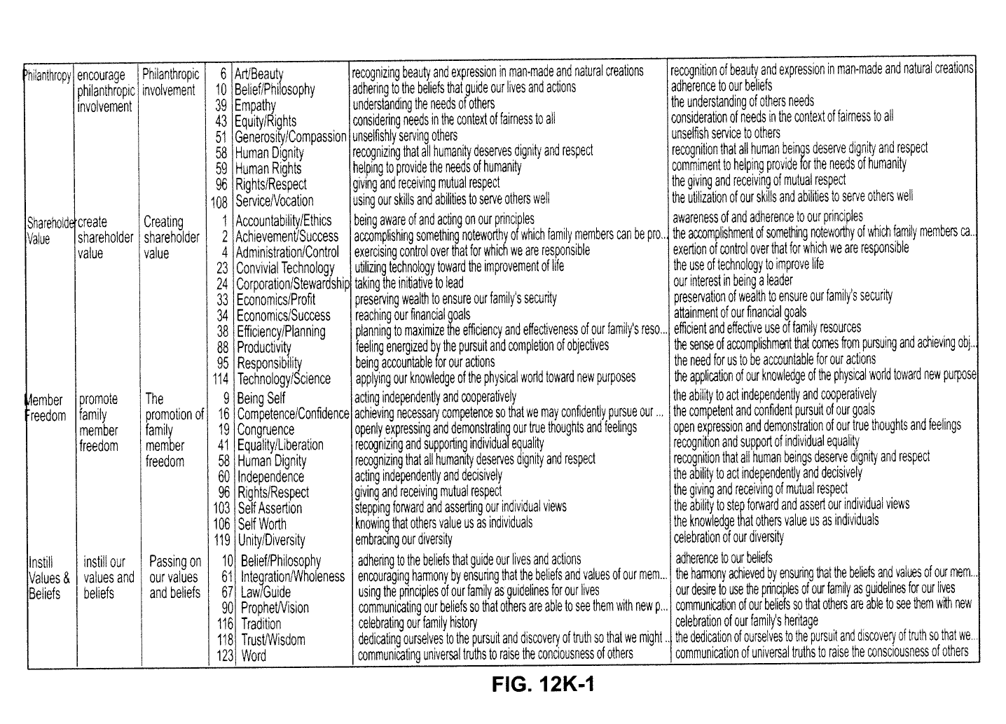

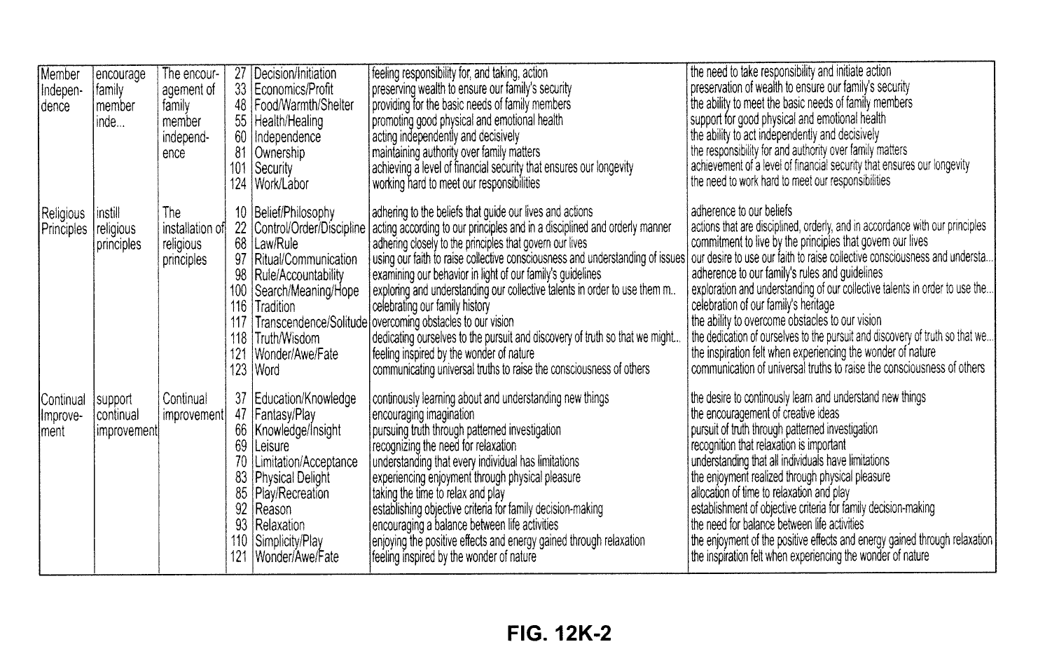

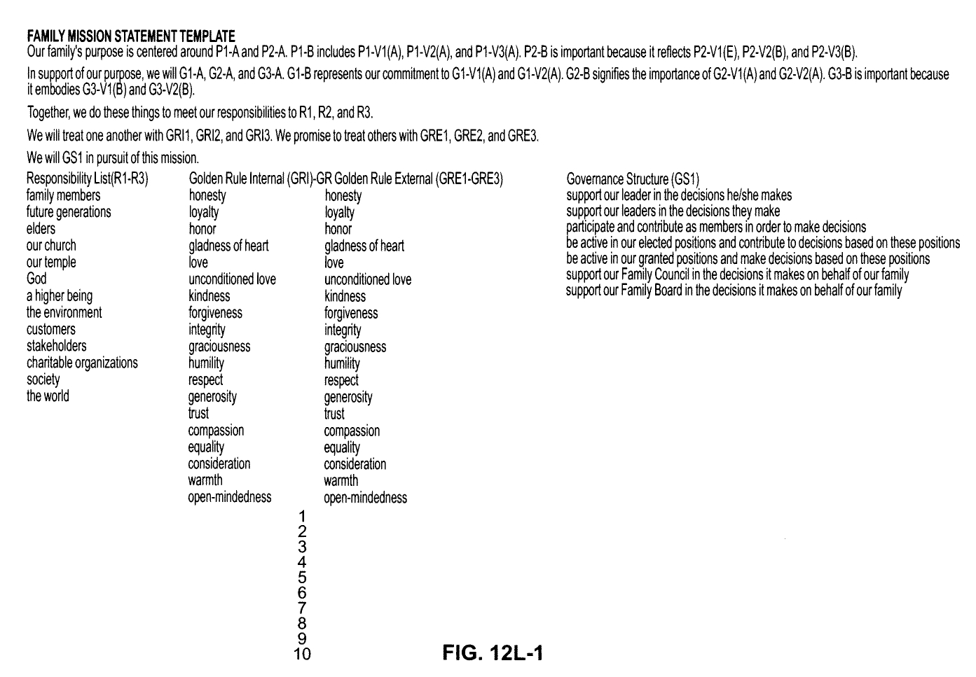

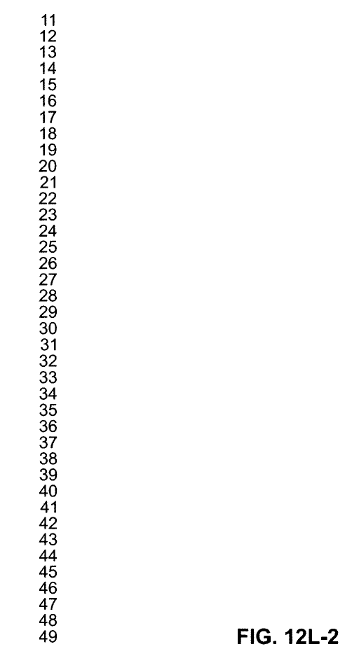

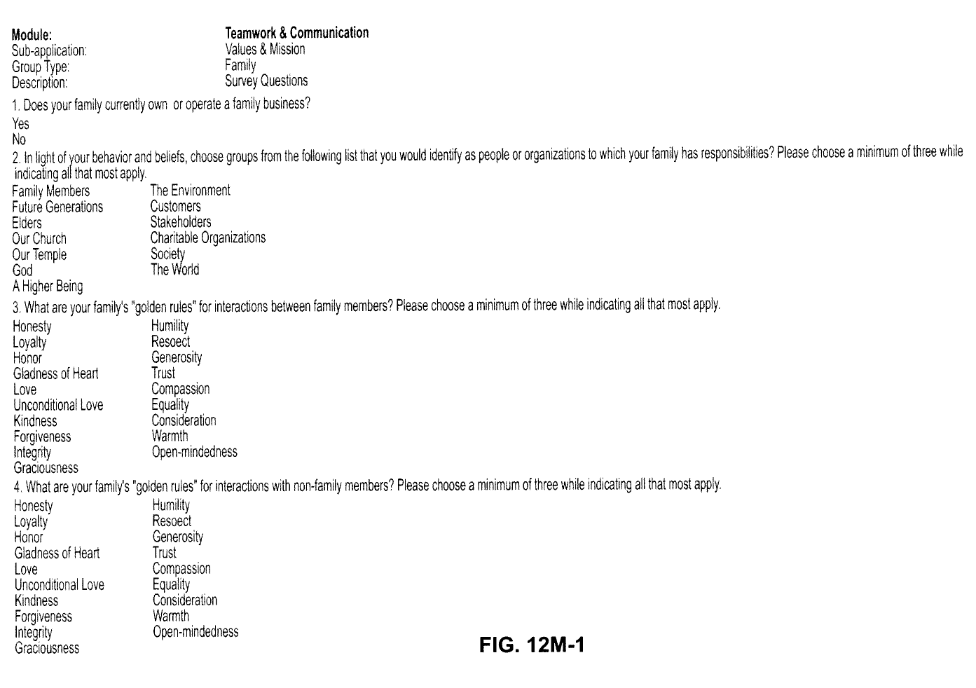

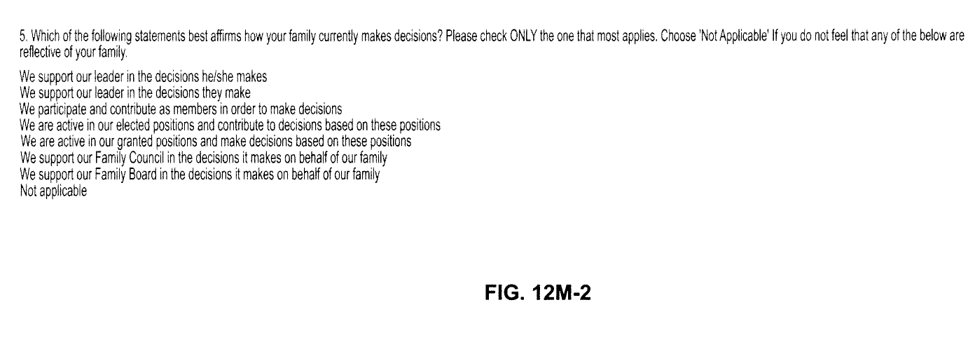

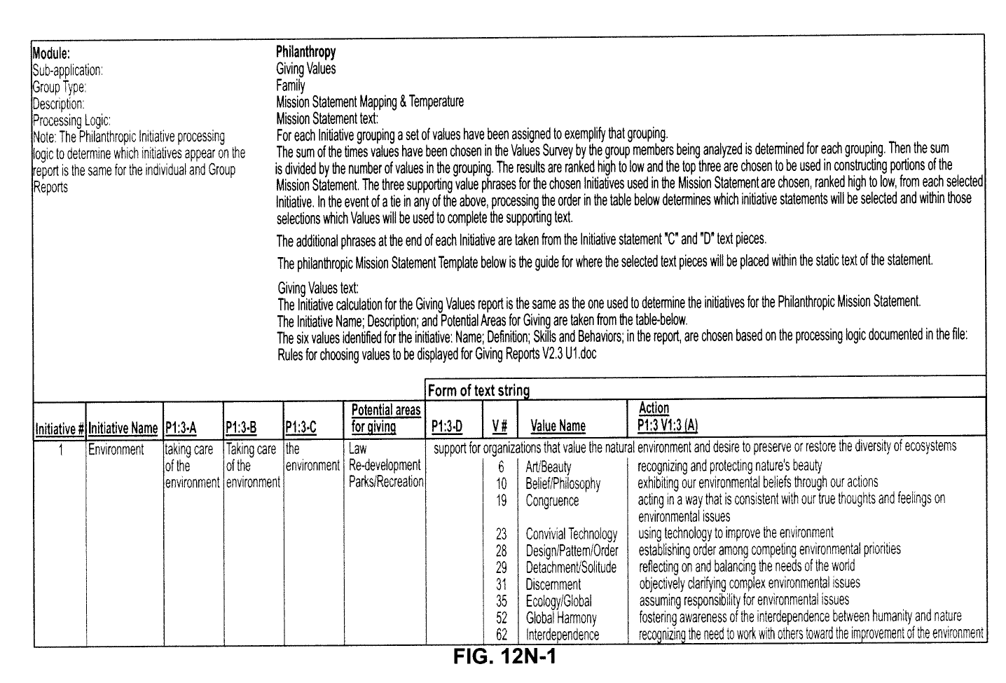

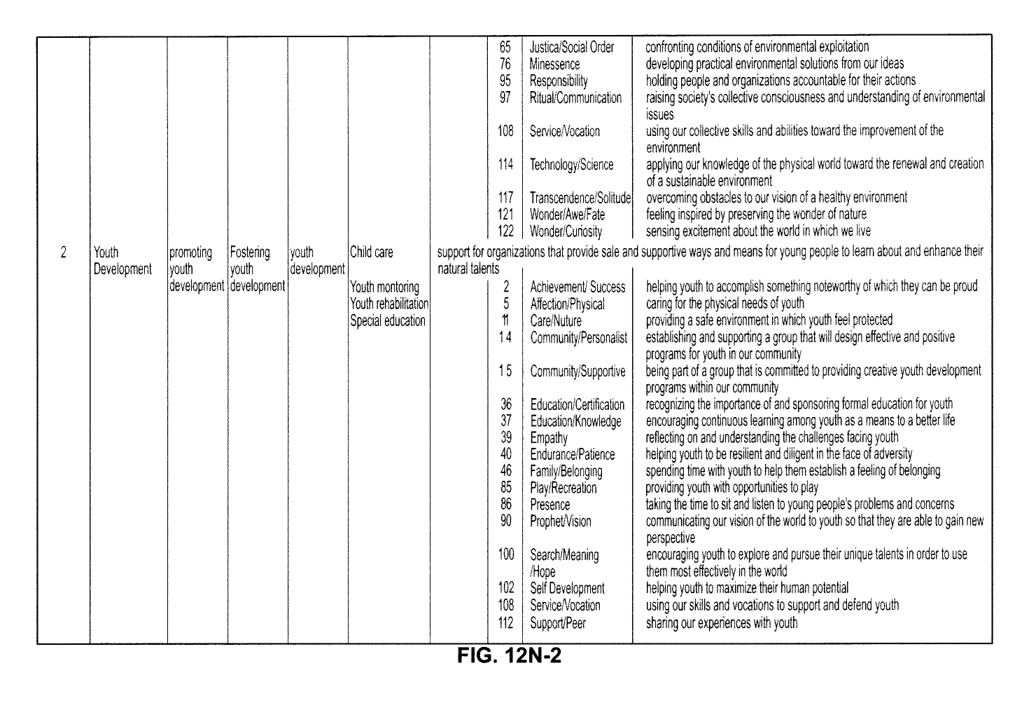

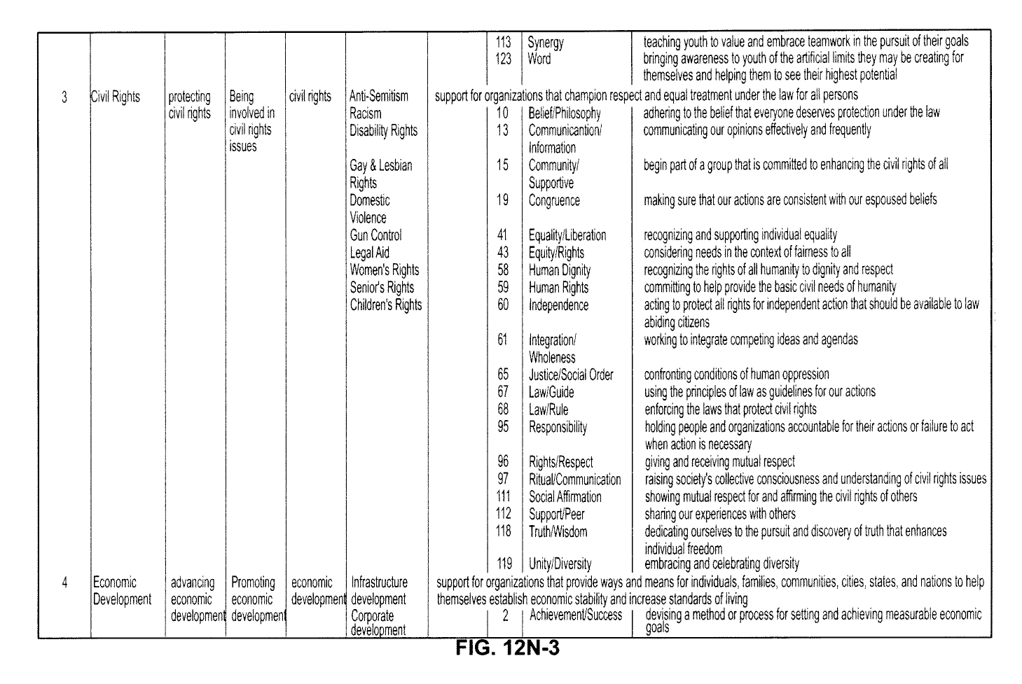

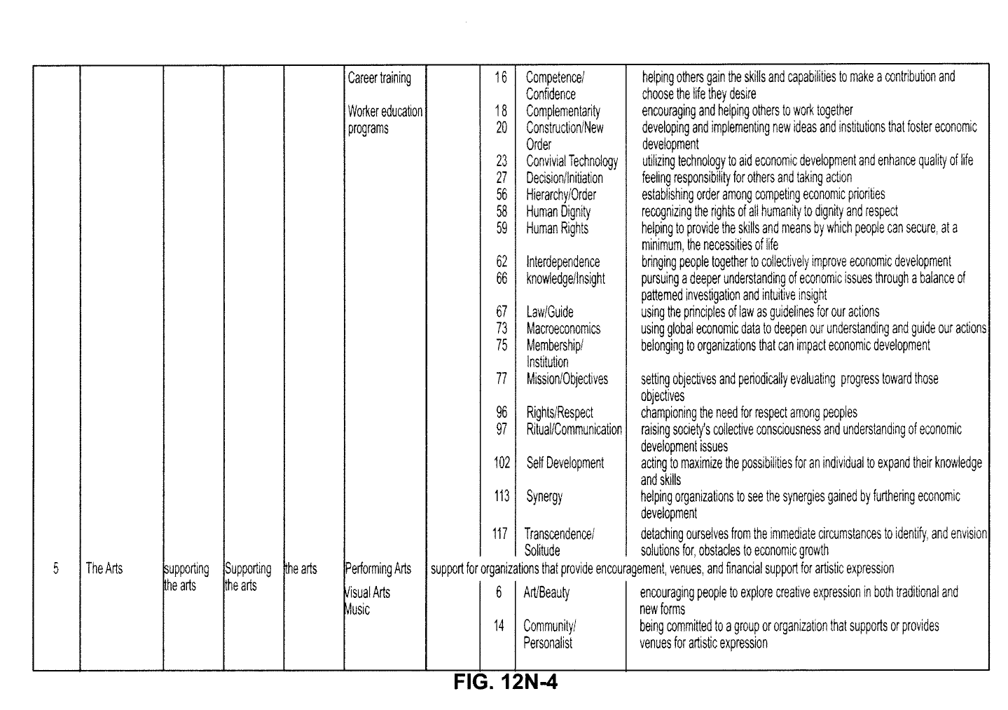

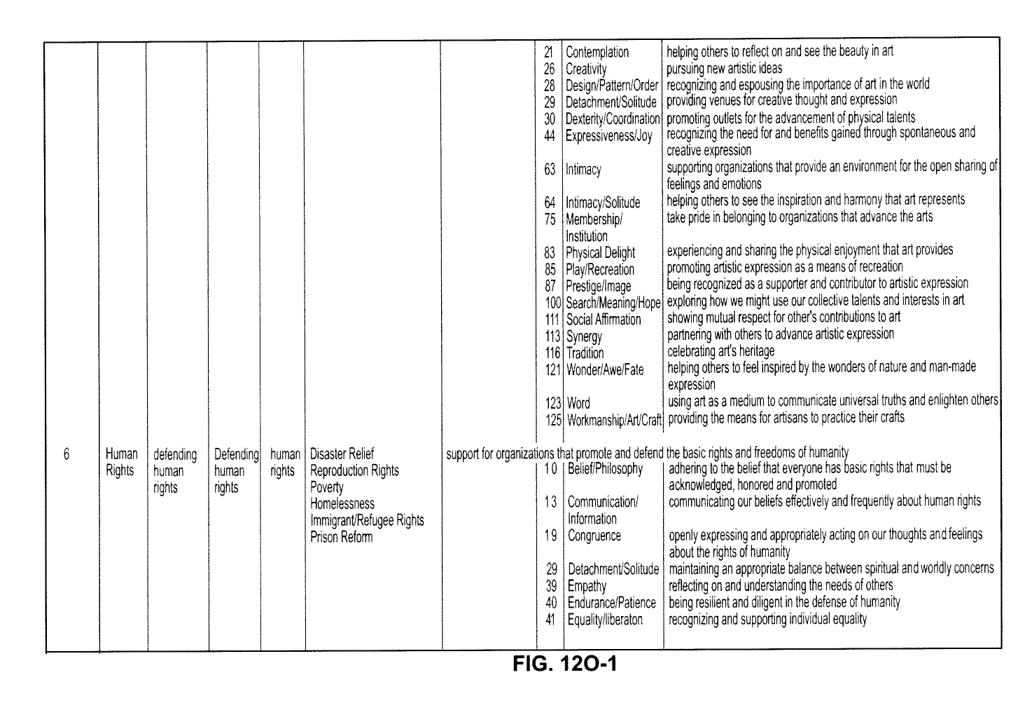

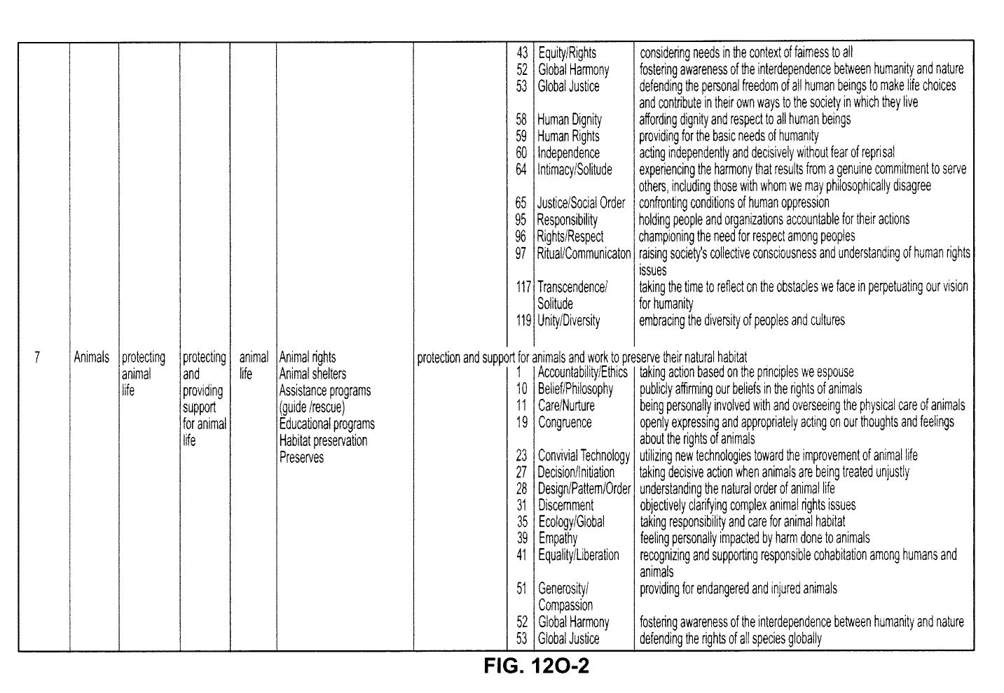

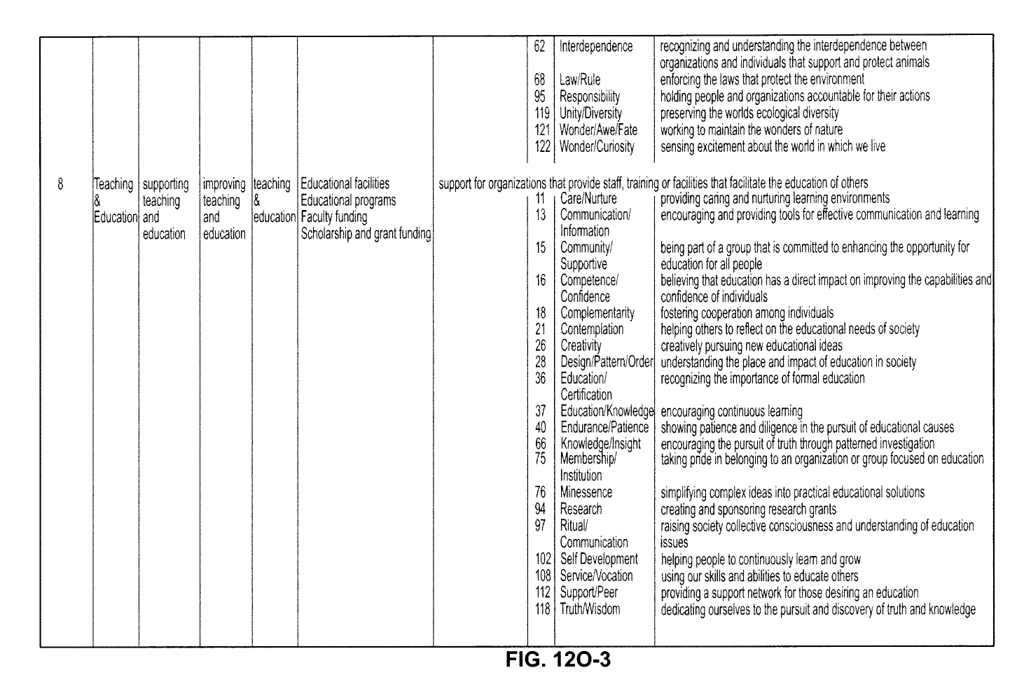

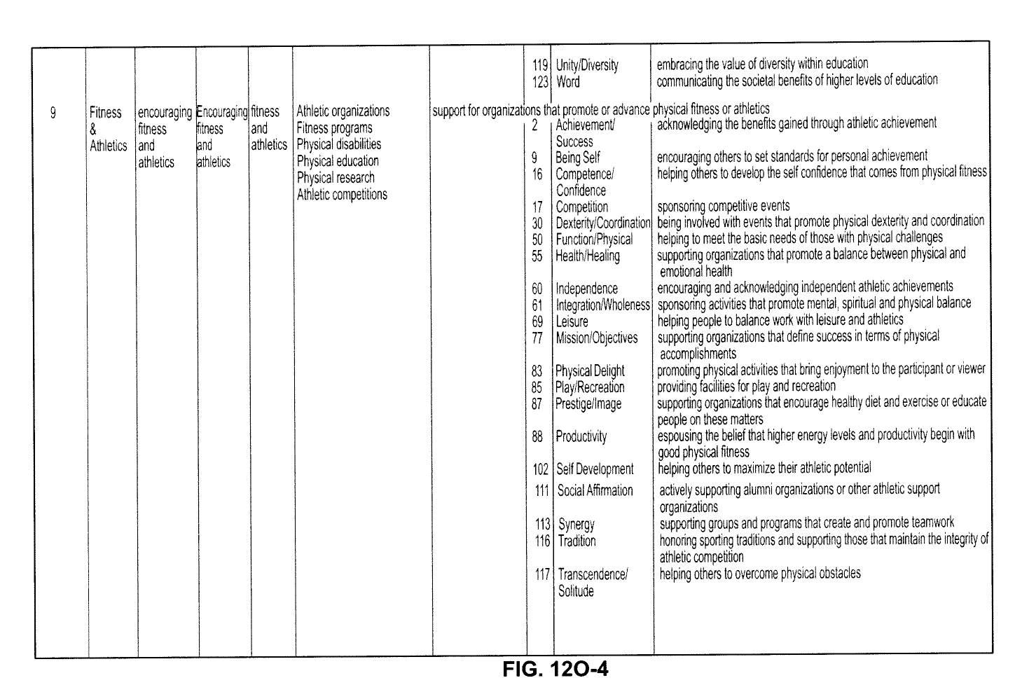

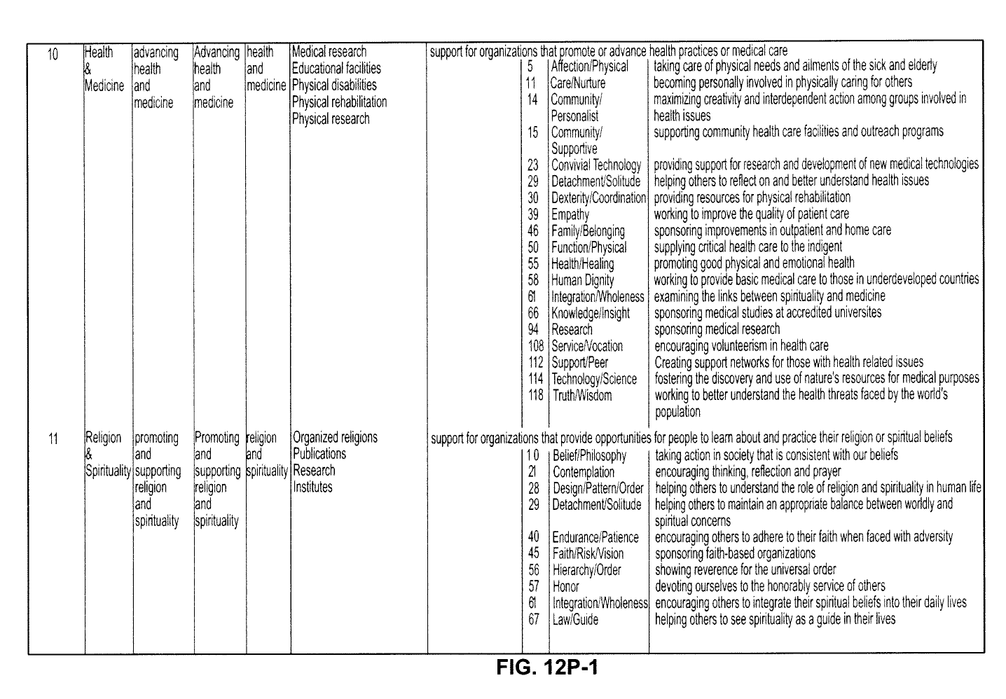

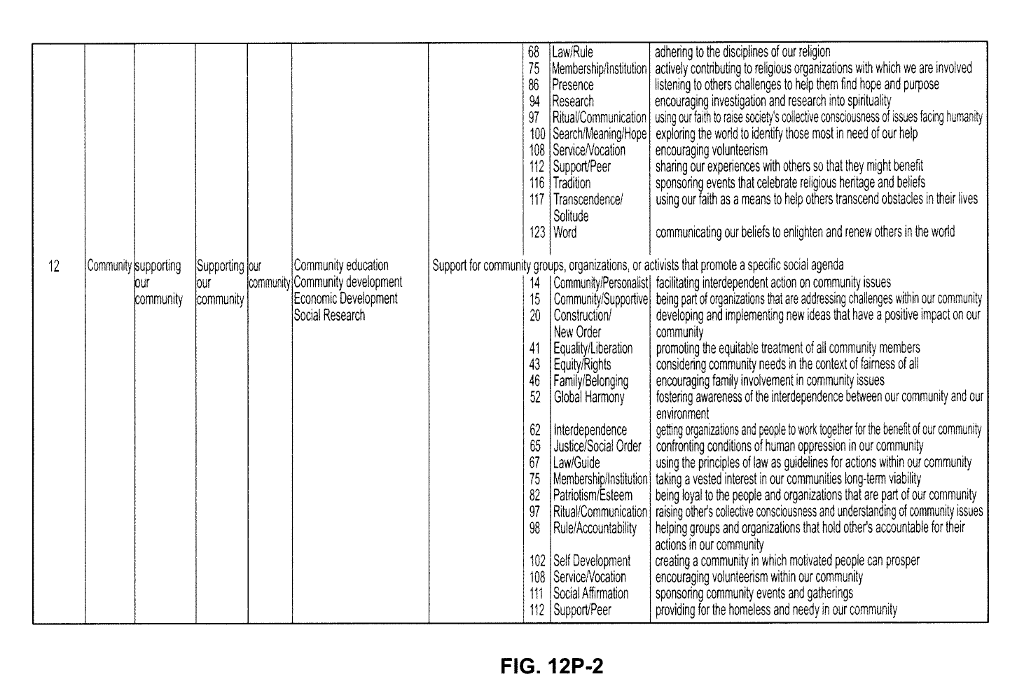

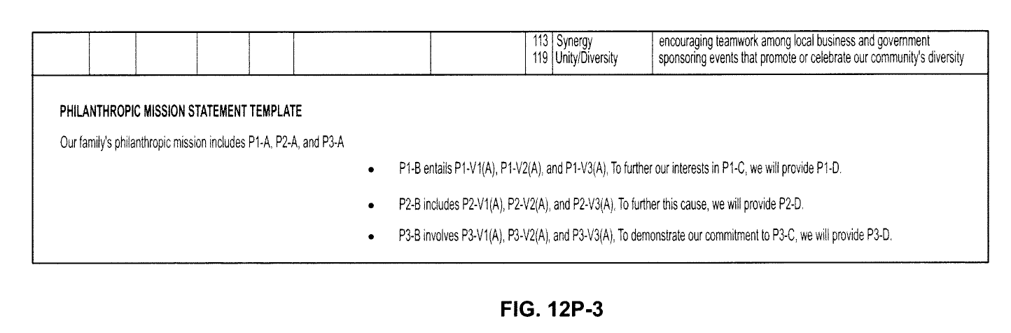

The Values and Mission Survey answers are tabulated for all respondents and the answers receiving the highest number of selections are chosen to be used for the Responsibility; Golden Rule Internal; and Golden Rule External parts of the Draft Family Mission Statement. See the FIG. 12, for all identities and text segments for the Draft Family Mission Statement

Once family shared values and the mission statement have been identified and prepared, respectively, the family is ready to move to the next phase.

Phase IV—Legacy

Referring to the drawings, FIG. 7 is a block diagram, depicting an exemplary method of providing wealth management services in accordance with Phase IV of an exemplary embodiment of the present invention. In this phase, the family legacy plan is developed. The family legacy plan is composed of four interrelated components: governance 710, philanthropy 720, mentoring 730, and estate planning 750. Governance 710 is a process by which a family makes decisions, organizes its activities, defines its future and creates ongoing entities to accomplish the family's goals. Although the governance process is addressed in all phases of this wealth management system, it is primarily developed in this last phase, Phase IV.

Governance may include education on governance and family assessment, selecting a decision-making style, defining family policies, creating a family constitution, implementing the family constitution, and creating a family council and a family board. Providing family members with education on family governance introduces the importance and benefits of family governance, defines current and future governance activities, determines gaps or critical issues related to governance, and identifies governance structures currently in place.

Selecting a decision-making style helps family members determine how the family's decisions are made, assess options for the future decision-making style, select a style for how the family wants to formalize decision-making, define family roles, and mitigate risks. For example and without limitation, the decision-making style may be hierarchical, collaborative, or partnership style.

Defining family policies and creating a family constitution help a family to begin formalizing its governance through documenting policies. The family constitution is the framework for creating a family legacy. The policies will, in turn, define how the family operates, communicates and works together. These policies are then outlined in the family constitution. Family council and family board may be created to implement and enforce the family constitution. They would also negotiate and enforce the family policies outlined in the family constitution.

The family board and council are much like any board or council in a corporation. Their roles and duties are similar to a business environment, only here, their roles and duties may be modified to fit the context of a family. The council is the voice of the family; it helps address issues facing the family in relation to its personal relationships, its assets, and its role in the community. The board is a legally empowered entity that oversees the financial and business decisions. It may be made up of a group of family and non-family representatives that understand and exercise oversight of the family's wealth management and enterprises.

Referring back to FIG. 7, the philanthropy component 720 addresses establishing a direction for effective philanthropy. The direction must be consistent with the family values. Part of the philanthropy component is researching recipients, administering grants, tracking performance, and training and education in philanthropy. To establish an effective direction, a formal giving plan may be devised. The formal giving plan preferably incorporates an philanthropy assessment, an introduction to philanthropy, a discussion of values and philanthropy, recipient selection process, charitable structure identification, implementation, and compliance, evaluation of gift effectiveness, and philanthropic networking. The formal giving plan helps a family to assess its giving aspirations and current giving activities, introduce the family to philanthropy, identify and examine the family's charitable values and goals, define a budget, and help the family agree on a vision statement. Strategic philanthropy forms the social legacy of the family.

Referring back to FIG. 7, the other components of a family's legacy plan are mentoring 730 and estate planning 740. Mentoring 730 helps prepare heirs in being responsible with the family's wealth. It is a long-term task, beginning with the early establishment of family values and developing individual attitudes toward wealth and responsibility. Mentoring 730 is crucial to sustaining family wealth because it is likely that families will value education and will want to enhance the intellectual capital of the family. It also helps set standards for the succeeding generations.

The final component of a family's legacy plan is estate planning 740. Family values and the mission statement created in Phase 311 help drive the more advanced planning and considerations of an estate plan. An additional element to estate planning 740 is a wealth transfer philosophy which helps further define what a family does with its wealth in the future generations.

In Phase IV of the process, other reports that aid in accomplishing successful wealth management may be created. It is preferable that during this wealth management process there is created for the family and for its individual members a group giving report and a personal giving report, respectively. The group giving report uses the values survey responses for all group members from Phase III to identify the three philanthropic initiatives that are most representative of the family values, as defined in Phase III.

Group and Personal Giving Reports, and Philanthropic Mission Statement

The process of determining the initiatives to be displayed in the Group and Personal Giving Reports is one of tabulating the individual values scores from the values surveys, whose purpose, logic, and parameters were discussed above with reference to preparing personal values reports. These scores are then assigned to values groupings that are believed to embody the various philanthropic initiative areas that will be used to construct the report. The values groupings are then ordered from highest to lowest and displayed in that order.

The initiative name to be displayed along with the initiative detail is chosen with logic similar to the Draft Family Mission Statement. See FIG. 12 for all the identities, text pieces, and templates. The logic identifies six of the values in the list of values that should be displayed for that philanthropic initiative by finding the six values with the highest number of times selected. For each philanthropic initiative, a values list, to be displayed below the philanthropic initiative description, is constructed using the following rules.
1. Those values that are members of the list for the selected Initiative will be selected for display as follows.
   a. A maximum number of 6 values will be displayed for any given initiative.
   b. Sort the Values that are part of the initiative:
      i. Highest number of times chosen
      ii. Within equal number of times chosen Goals first, Means second
      iii. Within equal number of times chosen and Goals or Means group, highest to lowest numbered Stage
      iv. Within equal number of times chosen and Goals or Means group, highest to lowest numbered Stage sort alphabetically
   c. Select the 6 highest on the list to be displayed
   d. Sort the list of selected values alphabetically by name this means that the values lists will be displayed with Goals and Means intermingled.

Although one or more initiatives may also be present on some personal giving reports, a family as a whole may have collectively prioritized different initiatives. Thus, the group initiatives may not always correspond to personal initiatives. For example, it may be that the family, as a group, identified youth development, civil rights, and economic development as its top three philanthropic initiatives. The group giving report, when listing, for example, youth development, will also describe the initiative, provide potential areas for giving, correlate this to the corresponding values, and define those values.

The personal giving report, uses an individual family member's responses to the values survey to identify the three philanthropic initiatives that are most representative of the member's values. The top initiatives in this report may or may not match the top initiatives in the group report.

The process of determining the text pieces for the Philanthropic Mission Statement is one of using the same calculation routines as are used for determining the initiatives to be presented in the Group Giving Report. In the instance of the Philanthropic Mission statement the results of the calculation are used to select and place in a text template the appropriate initiative text pieces. See FIG. 12, for the templates and text pieces to be inserted in the template.

The process of determining the text pieces for the Philanthropic Mission Statement is one of using the same calculation routines as are used for determining the initiatives to be presented in the Group Giving Report.

Group Personal Decision-Making Reports, Skills Development Report

After the surveying stage, the individual family members may be provided with a personal decision-making report, which identifies for the family members the decision-making styles most aligned with their personal values. It also helps the family identify the governance system in which he can best contribute. Likewise, the family may be provided with its own group decision-making report, which identifies for the family the decision-making styles most aligned with the family's family values. It also helps the family to understand how it collectively makes decisions.

Additionally, the members of the family may be asked to take a Decision Making™ survey. This survey asks the family members to express their preference for certain decision-making structures, such as autonomy, equality, collaboration, or shared responsibility, to name a few. The family members are asked to select 3 structures from a list of 9 and then prioritize their selections. The results of the Decision-Making Survey and the family's values surveys are used to produce the Group and Personal Decision-Making Reports as well as the Skills Development Report. Below are examples 1-9 of various decision-making styles according to a preferred embodiment of the present invention.

### 1) Traditional™

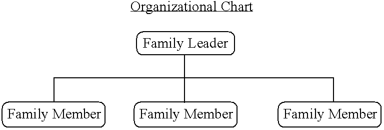 [0155] > This Framework represents the concentration of power behind an authoritative Family Leader.
> Decisions are made by the Family Leader and are not subject to review.
> Family members have minimal input (if any).

### Defined Roles

Family Leader: Makes decisions on behalf of the family,
Family Member: Defers all decision-making to the Family Leader, who has total authority and discretion; may offer input and ideas to the Family Leader without making demands or issuing ultimatums.

### Risks

Concentration: The family is highly dependent upon the leadership and decision-making abilities of one person, in the case of unforeseen loss, the family may be unable to act, due to a lack of knowledge, skills, or experience, or fail to rally around another leader.
Lack of Representation: It is not uncommon for some Family Members to leave the family if they cannot identify with the Family Leader's vision, or feel they have no voice within the family.

### 2) Power Sharing™

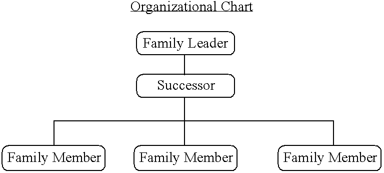 [0163] > This Framework provides for the transference of power from an authoritative Family Leader to an appointed Successor.
> Control and decision-making power is shared between the Family Leader and the Successor, but Family Members should view the Successor as having primary authority for family decision-making.

### Defined Roles

Family Leader Provides guidance and direction to the Successor without usurping his/her authority.
Successor: Makes decisions on behalf of the family, yet seeks guidance from the Family Leader.
Family Member: Defers all decision-making to the Successor; may offer input and ideas to the Successor without, making demands or issuing ultimatums.

### Risks

Concentration: The family is highly dependent upon the leadership and decision-making abilities of a limited number of people. In the case of unforeseen loss, the family may be unable to act, due to a lack of knowledge, skills, or experience, or fail to rally around another leader.
Lack of Representation: It is not uncommon for some Family Members to leave the family if they do not feel represented by the Successor or feel they have no voice within the family.
Interference: The Family Leader may attempt to impose excessive influence over the Successor's decisions or otherwise usurp his/her authority, which could permanently damage the Successor's credibility and authority.
Rivalry: One or more Family Members may harbor resentment over the selection of the Successor and pursue their own ‘hidden agendas’, which may result in dysfunction or disintegration of the family.

### 3) Autonomy™

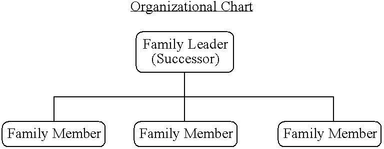 [0173] > This Framework represents the concentration of power behind an appointed Successor that is a peer of other Family Members.
> Decisions are made the Successor and are not subject to review.
> Family members have minimal input (if any).

### Defined Roles

Successor: An appointed Family Leader that makes decisions on behalf of the family.
Family Member: Defers all decision-making to the Successor; may offer input and ideas to the Successor without making demands or issuing ultimatums.

### Risks

Concentration: The family is highly dependent upon the leadership and decision-making abilities of one person. In the case of unforeseen loss, the family may be unable to act, due to a lack of knowledge, skills, or experience, or fail to rally around another leader.
Lack of Representation: It is not uncommon for some Family Members to leave the family if they do not feel represented by the Successor or feel they have no voice within the family.
Rivalry: One or more Family Members may harbor resentment over the selection of the Successor and pursue their own ‘hidden agendas’, which may result in dysfunction or disintegration of the family.
   4) 1^{st} Among Equals™

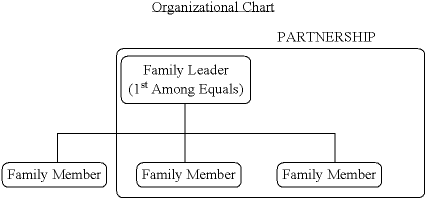

> This Framework involves the formation of a Partnership of Family Members that relate to each other as equals but concentrates power behind an elected Family Leader (the “1^{st} Among Equals”) that is a peer of other Family Members.
> Family Members within the Partnership have substantial input into decisions.

### Defined Roles

1^{st} Among Equals: Makes representative decisions on behalf of the family, yet actively seeks guidance from Family Members with a goal of balancing competing Family Member priorities and views.
Family Member: Defers ultimate decision-making to the 1^{st} Among Equals, hut actively participates in the decision-making process by offering ideas and feedback.

### Risks

Concentration: The family is highly dependent upon the leadership and decision-making abilities of one person. In the case of unforeseen loss, the family may be unable to act, due to a lack of knowledge, skills, or experience, or fail to rally around another leader.
Interference: Family Members may attempt to impose excessive influence over the 1^{st} Among Equals decisions or otherwise usurp his/her authority, which could permanently damage his/her ability to govern.
Rivalry: One or more Family Members may harbor resentment over the election of the 1^{st} Among Equals and pursue their own “hidden agendas”, which may result in dysfunction or disintegration of the family.

### 5) Interdependence™

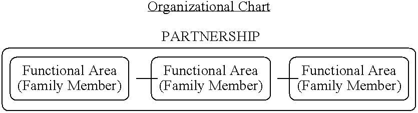 [0189] > This Framework involves the formation of a Partnership of Family Members that relate to each other as equals but allocate decision-making authority to interdependent Functional Areas.
> Each Functional Area has autonomy but is subject to oversight by other Family Members.
> Participating Family Members are aligned with Functional Areas based on their individual proficiencies, talents, and interests.

### Defined Roles

Functional Area: A specific aspect of family interaction or decision-making, such as Administration, Governance, Philanthropy or Investments, in which decision-making authority is vested in one or more Family Members.
Family Member May participate in decision-making within a Functional Area in which he or she has expertise; votes equally on family matters brought before the Partnership.

### Risks

Power Imbalance: The assignment of more importance to certain Functional Areas may lead to a perceived or real power imbalance within the Partnership.
Paralysis: The decision-making process will become increasingly difficult (and may ultimately become paralyzed) as the number of Family Members participating in the Functional Areas and Partnership increases.
Interference: Family Members may attempt to impose excessive influence over Functional Areas in which they do not have authority, which may result in dysfunction or disintegration of the Partnership.

### 6) Equality™

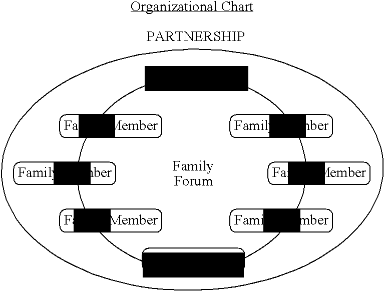 [0198] > This Framework involves the formation of a Partnership that is based on total equality.
> Family Members share equal decision-making and veto power with a goal of reaching unanimous decisions.
> All Family Members contribute equally to all family matters across all Functional Areas.

### Defined Roles

Family Forum: A periodic collecting in which all participating Family Members discuss family matters and vote.
Family Member: Contributes to and votes equally on all family matters brought before the Partnership; each Family Member has veto power over all decisions made by the Partnership.

### Risks

Paralysis: The decision-making process will become increasingly difficult, (and may ultimately become paralyzed) as the number of Family Members participating in the Partnership increases.
Tyranny: Family Members may become dominated and subjected to tyranny by a radical minority, which may result in dysfunction or disintegration of the family.
Apathy: Family Member involvement may decline substantially if the Family Forum becomes a medium foe issuing ultimatums or is characterized by the frequent use of veto powers.

### 7) Accordance™

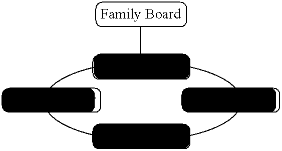 [0207] > This Framework involves the election of a Family Board, which has decision-making authority yet submits major issues and proposals to all Family Members for a vote.
> Board Members may govern collectively or vest authority to the role of a President, which each Board Member would occupy on a rotational basis for a fixed period of time.
> Branch Leaders represent a distinct branch of the family and are selected by the Family Board or a nominating committee chosen by the Family Board (and confirmed by the family).
> Family Members relate to one another as equals, share equal voting power and a philosophy that the ‘majority rules’.

### Defined Roles

Family Board: An elected group of Family Members that is responsible for all family matters and appoints Branch Leaders.
Branch Leader: An appointed Family Member, representing a distinct branch of the family, that is delegated specific responsibilities by the Family Board; Branch Leaders may appoint committees to conduct, family matters.
Family Member: Votes equally on the election of the Family Board and all issues and proposals submitted to the family; may participate on committees formed by Branch Leaders.

### Risks

Popular Decisions: It may be challenging for the family or Family Board to make the “best” decisions rather than those that are most popular.
Power Struggle: Reaching decisions will be difficult if Branch Leaders and the Family Board have competing agendas, which may result in dysfunction or disintegration of the family.

### 8) Representation™

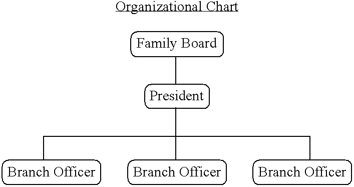 [0217] > This Framework is based on Family Member representation, voting and elections.
> Family Members elect a President and Branch Officers to make decisions on behalf of the family.
> Family Members vote to elect a Family Board to oversee the actions of the President and Branch Officers.

### Defined Roles

Family Board: A non-voting group of elected Family Members that oversee the family's policies and practices, and reports to the family on the performance of the President and Branch Officers; the Family Board may utilize an independent panel of non-family members to provide objective oversight of all activities.
President: An elected Family Member that is responsible for all family matters and has veto power over decisions made by Branch Officers.
Branch Leader: An elected Family Member, representing a distinct branch of the family, that is delegated specific responsibilities by the Family Board; Branch Leaders may appoint committees to conduct family matters.
Family Member: Nominates and votes equally on die election of the Family Board, President and applicable Branch Officers.

### Risks

Power Struggle: Making decisions will be difficult if the President and Branch Officers have competing agendas.
Silenced Minority: Family Members may not feel adequately represented by the President or Branch Officers if they are part of a minority contingent which may result in dysfunction or disintegration of the family.

### 9) Collaboration™

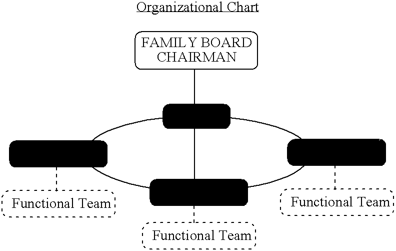

This Framework involves extensive collaboration between Family Members and Non-Family Members. Family Members elect a President and Family Officers to make decisions on behalf of the family. Family Members elect a Family Board that is responsible for overseeing the President and has veto power over all decisions.

### Defined Roles

Family Board: An independent, voting group of Family Members and non-family members (led by a Chairman) that oversee the family's policies and practices and reports to Family Members on the performance of the President.
President: An elected Family Member that presides over all family matters, has veto power over decisions made by Family Officers, and reports to the Family Board.
Family Officer: An elected Family Member with expertise in and decision-making authority for a specific Functional Team, such as Administration, Governance, Philanthropy or Investments, that includes Family Members and non-family members.
Family Member: Nominates and votes equally on the election of the Family Board, President, and Family Officers.

### Risks

Power Struggle: Making decisions will be difficult if the President and Family Officers have competing agendas.
Figurehead: The benefits of collaboration will be minimized if the Family Board is composed of Family Members and non-family members that are not independent and unbiased in their oversight of family matters.

For the Group Decision-Making Report the family's values survey answers are summed to and the results are used to select rate each of the 9 governance frameworks. The results are displayed in a graph that identifies the relative strengths of each framework based on the values choices of the family members. The results of the family members' preference choices are shown on the same graph. The bar chart below the graph indicates the group preferences for each of the categories: Type of Governance; Basis for Decisions; and Decision-Making guide. The individual's results may only be displayed if they have explicitly given permission.

See below for the Framework descriptions, the values for each Framework and the detail calculation description used to determine the strength of each Framework for a set of Values Survey answers.
Governance Decision-Making Frameworks Values Lists
Calculations for Group and Individual Decision-Making reports, and Skill Development report

| | Framework # | | | | | | | | |
|---|---|---|---|---|---|---|---|---|---|
| Value Name | 1 | 2 | 3 | 4 | 5 | 6 | 7 | 8 | 9 |
| Accountability/Ethics | | | X | | | | | | |
| Achievement/Success | X | X | X | X | X | X | X | X | X |
| Administration/Control | | X | X | X | X | X | X | X | X |
| Authority/Honesty | X | | X | X | X | X | X | X | X |
| Being Liked | | X | X | X | X | | | | |
| Being Self | | | | | | | X | X | X |
| Belief/Philosophy | X | X | X | X | X | X | X | X | X |
| Care/Nurture | X | X | X | X | | | | | |
| Collaboration | | | | X | X | X | X | X | X |
| Communication/Information | | | | X | X | X | X | X | X |
| Community/Supportive | | | | X | X | X | X | X | X |
| Competence/Confidence | | | X | | | | | | |
| Complementarity | | | | | | | | | X |
| Congruence | | | | | | | X | X | X |
| Construction/New Order | | | | X | X | X | X | X | X |
| Control/Order/Discipline | X | X | X | X | X | X | | | |
| Corporation/Stewardship | | | | | | | | X | X |
| Decision/Initiation | | X | X | | | | | | |
| Design/Pattern/Order | | | | | X | X | | X | X |
| Duty/Obligation | X | | | | | | | | |
| Economics/Profit | X | X | X | | | | | | |
| Economics/Success | | | | X | X | X | X | X | X |
| Efficiency/Planning | X | | | X | X | | | | |
| Endurance/Patience | X | X | | | | | | | |
| Equality/Liberation | | | | | | X | X | X | X |
| Equilibrium | | X | X | | | | | | |
| Equity/Rights | | | | | | X | X | X | X |
| Faith/Risk/Vision | | X | X | X | X | X | X | X | X |
| Family/Belonging | X | X | X | X | X | X | | | |
| Food/Warmth/Shelter | X | | | | | | | | |
| Function/Physical | X | | | | | | | | |
| Growth/Expansion | | | | | | | | | X |
| Hierarchy/Order | X | X | | | | | | X | X |
| Honor | X | X | | | | | | | |
| Independence | | | X | X | | | | | |
| Interdependence | | | | | X | X | X | X | X |
| Law/Rule | X | X | X | | | | | | |
| Limitation/Acceptance | | | | X | X | X | X | X | |
| Limitation/Celebration | | | | | | | | | X |
| Loyalty/Fidelity | | X | X | | | | | | |
| Management | X | X | X | X | X | | | | |
| Membership/Institution | | | | X | X | X | X | | |
| Mutual Accountability | | | | X | X | X | X | X | X |
| Obedience/Duty | X | X | X | | | | | | |
| Ownership | X | | | X | X | X | X | | |
| Productivity | X | | | | | | X | X | X |
| Property/Control | X | X | X | X | X | X | | | |
| Quality/Evaluation | | | | | | | | X | X |
| Reason | | | | | | X | X | X | |
| Responsibility | X | X | X | X | X | X | X | X | X |
| Rights/Respect | | | X | | | | | | |
| Rule/Accountability | | X | | X | X | X | X | X | |
| Safety/Survival | X | X | | | | | | | |
| Search/Meaning/Hope | | | | | | | X | X | X |
| Security | X | X | X | X | X | | | | |
| Self Assertion | | X | X | | | | X | X | X |
| Self Development | | X | X | X | X | X | X | X | X |
| Self Interest/Control | X | X | X | | | | | | |
| Self Preservation | X | | | | | | | | |
| Self Worth | X | | | | | | | | |
| Service/Vocation | | | | X | X | X | X | X | X |
| Sharing/Listening/Trust | | | | | | X | X | X | X |
| Social Affirmation | | X | | X | X | X | | | |
| Support/Peer | | | X | X | X | X | X | | |
| Territory/Security | X | | | | | | | | |
| Tradition | X | X | X | X | X | X | X | | |
| Unity/Uniformity | X | X | X | | | | | | |
| Work/Labor | X | X | X | | | | | | |
| Maximum number of times | 88 | 87 | 83 | 86 | 87 | 87 | 84 | 84 | 83 |
| values can be chosen | | | | | | | | | |
| for each framework | | | | | | | | | |

To obtain the number to be used for rating the Frameworks priorities, divide the total of the times the values in a Framework were chosen by the maximum number of times values can be chosen that is listed for the specific Framework. This calculation will yield the percentage of possible values chosen for each Framework. Prioritize the Frameworks from the highest to lowest percentage of values chosen. These percentages, rather than the actual number of times the values were chosen, will then be used as input to the Decision Making reports routines.

The towers on the report are normalized so that each tower color group will have at least one full height and one minimum height tower. Each Values Survey computed Framework value is displayed as a red tower in the report. The green towers on the report are the results of a survey of the respondents that asks the respondents to choose the three Frameworks they would prefer to have as a Governance Decision-Making framework for their group. They are then asked to rank these three choices. The results of these choices are then summed (for each respondent's choices a value of 1 is given to the third ranked choice, 2 to the second ranked choice, and 3 to the first ranked choice) and displayed on the report. The dark blue arrow and boxed 1 indicates the group preferences for each of the categories: Type of Governance; Basis for Decisions; and Decision-Making guide. The light blue arrow and boxed numbers 2 through n, when n is the number of respondents minus 1, indicates the individual preferences for each of the categories: Type of Governance; Basis for Decisions; and Decision-Making guide. The individual indicators are not displayed if permission has not been granted by the respondent.

Calculations for the Decision-Making Framework towers on the Individual Report are the same as are used for the green towers on the Group Report. The dark blue arrow and boxed 1 indicates the group preferences for each of the categories: Type of Governance; Basis for Decisions; and Decision-Making guide. The light blue arrow and boxed number 2 indicates the individual's preferences for each of the categories: Type of Governance; Basis for Decisions; and Decision-Making guide.

This report is for a specific survey respondent in the group and cannot be generated until the group has made a Framework selection that best represents the Decision-Making structure they want to use. The respondent's Values Survey results indicate the greatest alignment with the Autonomy Decision-Making Framework. This is represented by the red tower on the report. If two or more towers should be red and another color, or colors, the priority tower color to be used is red. The Example group chose the 1^{st} Among Equals Decision-Making Framework. This is represented by the green tower on the report. The respondent ranked the Traditional Decision-Making Framework as their first choice when doing the Decision-Making preference survey. This is represented by the blue tower on the report.

The “What skills do I need to develop” values list generated from the group selected framework and the respondent's values aligned framework, are generated by comparing the values in each framework. The comparison selects those values to display based on the value being a value in the rightmost identified framework and not a value in the leftmost identified framework. These frameworks are identified by the bracketing lines on the report. In the event that both the Values Survey aligned framework and the group selected framework are the same, no values are identified and a recommendation is made to the respondent to review their Personal Values report to identify skills that might need strengthening.

The Personal Decision-Making Report uses the same calculation routines to calculate the relative strength of the governance frameworks and preferences for each of the categories: Type of Governance; Basis for Decisions; and Decision-Making guide from the member's values survey answers.

The Skill Development Report is available for a participating family member after the family has decided which governance framework they would most like to use for their family. The Skill Development Report then helps identify what skills may need to be enhanced by the family member to participate more effectively in a group using that governance framework.

Preparing the Family Plan

During Phase I: Discovery, the family begins to capture its strategy, wealth objectives and strategic plan for their wealth in the family's Multi-generational Family Plan. The strategic plan is co-created between the family and its advisor to accomplish their wealth objectives, or long-term strategic goals as well as shorter term, tactical goals. The strategic plan captures the progress and initiatives undertaken by the family and their advisors. The strategic, plan integrates all the components of the four phases of the wealth management process and is housed in the client's Multi-generational Family Plan. The family plan, which is a multi-generational family plan, begins to exist immediately upon a client engaging in the wealth management process and is constantly iterated and expanded as they progress throughout the four phases.

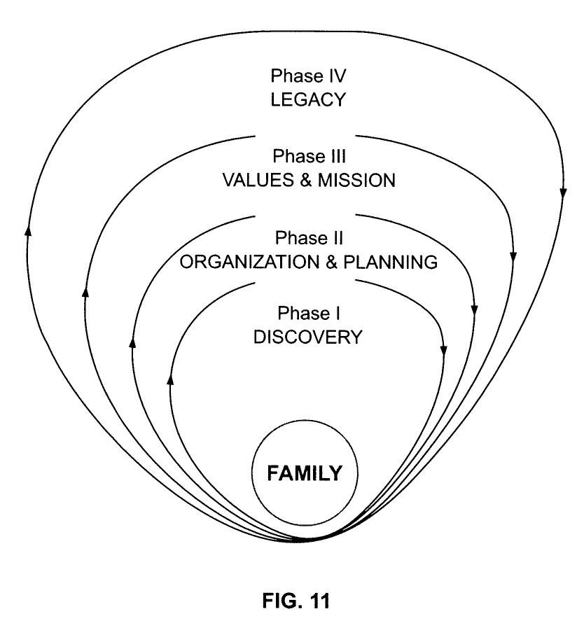

It is important to note that the process itself is iterative and continual, as shown in FIG. 11. It is also preferred but not required that the phases and steps within the phases be carried out in the described order. Families are not static—they grow and evolve. As these changes occur within the family structures, the elements in Phase I are updated through revising the generational and legal structures. These changes also impact the family's financial plan, estate plan, risk, and investments and may require that Phase II is revisited. As families evolve the priorities of families may change and need to he adjusted as do the family's values and mission. Since it is the family's value system that drives the family and social legacies, it is understandable that the process is iterative and continual lasting from one generation to the next. Through each phase, this new wealth management process increases exponentially the chances for families to sustain their wealth across generations.

### CONCLUSION

An exemplary embodiment of the present invention has been described above. Those skilled in the art will understand, however, that changes and modifications may be made to this embodiment without departing from the true scope and spirit of the present invention, which is defined by the claims.

We claim:

1. A method for providing family wealth management services comprising the steps of:
collecting family information;
collecting information about legal entities where family members are involved;
performing a plurality of wealth management reviews;
surveying a plurality of considerations related to wealth management;
establishing a family governance system; and
developing a family plan for wealth preservation during the course of performing the preceding step.

2. The method of claim 1, wherein performing a plurality of wealth management reviews based comprises:
performing a financial review;
performing an estate plan review;
performing a risk management assessment, wherein the assessment addresses exposure to future liability;
performing an at least one investment policy statement; and
performing an investment portfolio review.

3. The method of claim 2, wherein the financial review is a review of current financial situation and future savings and spending.

4. The method of claim 2, wherein the estate plan review is an illustration including financial projections, of estate plan based on assumed events.

5. The method of claim 2, wherein the risk management assessment addresses exposure to future liability.

6. The method of claim 5, wherein the risk management assessment further comprises a list of current insurance.

7. The method of claim 2, wherein the at least one investment policy statement comprises written policies that govern investment decisions.

8. The method of claim 2, wherein performing an investment portfolio review comprises preparing reports detailing performance and status of the investment portfolio.

9. The method claim 1, wherein family information comprises historic and current information about members of the family.

10. The method of claim 9, wherein the historical and current information comprises a generational structure of the family, wherein the generational structure reflects data about individual family members and their relationships to each other.

11. The method of claim 1, wherein information about legal entities where family members are involved, comprises information about trusts, individual retirement accounts, foundations, donor advised funds, family investment vehicles, and family businesses.

12. The method of claim 1, wherein establishing the family governance system comprises:
identifying personal values of family members;
compiling a shared values report for the family based on the personal values of family members;
drafting a family mission statement based on the shared values report.

13. The method of claim 12, wherein the shared values report comprises personal values that family members had in common with at least a majority of family members.

14. The method of claim 13, wherein the majority of family members comprises at least 50% of family members.

15. The method of claim 12, wherein the shared values report comprising personal values that family members had in common with at least a majority of family members further comprises personal values that were selected at least two times by at least 50% of family members.

16. The method of claim 12, wherein the mission statement guides family decisions and family interactions.

17. The method of claim 12, wherein the mission statement establishes direction of management of family wealth.

18. The method of claim 12, wherein the mission statement enables preservation and growth of family wealth for successive generations.

19. The method of claim 1, wherein establishing the family governance system further comprises establishing a family constitution.

20. The method of claim 1, wherein establishing the family governance system further comprises creating family entities to support the family constitution.

21. The method of claim 20, wherein family entities comprise:
family counsel; and
family board.

22. The method of claim 1, wherein establishing a family governance system further comprises developing a legacy.

23. The method of claim 22, wherein the legacy is comprised of family legacy and social legacy.

24. The method of claim 23, wherein social legacy incorporates strategic philanthropy.

25. The method of claim 23, wherein family legacy incorporates the family constitution.

26. The method of claim 1, further comprising engaging family members in family learning programs, wherein family learning programs are programs where family members develop skills for supervising family wealth.

27. The method of claim 26, wherein the family learning programs are built on values of family members, dimensions of wellness of family members, and family business models.

28. The method of claim 1, wherein the plurality of considerations related to wealth management is not exclusively financial in nature.

29. The method of claim 1, wherein the plurality of considerations related to wealth management are recognized non-investment related practices that help sustain family and wealth.

30. The method of claim 1, wherein the plurality of considerations comprises considerations related to family cohesiveness, family governance, mentoring, philanthropy, strategic issues and wealth objectives, and trusts and estates.

31. The method of claim 30, wherein family cohesiveness considerations comprise:
family history;
family culture;
family mission statement;
shared values;
teamwork;
communication; and
member well-being.

32. The method of claim 30, wherein family governance considerations comprise:
family governance;
family meetings;
family policies;
conflict resolution; and
succession planning.

33. The method of claim 32, wherein succession planning is omitted for families without heirs.

34. The method of claim 30, wherein mentoring considerations comprise:
financial education;
parenting skills;
support for entrepreneurship;
family support network; and
money-related education.

35. The method of claim 34, wherein financial education, parenting skills, and support for entrepreneurship are omitted for families without heirs.

36. The method of claim 30, wherein philanthropy considerations comprise:
support for philanthropy;
shared philanthropy; and
strategic philanthropy.

37. The method of claim 30, wherein strategic issues and wealth objectives considerations comprise:
understanding of economics;
wealth objectives; and
planning for major life events.

38. The method of claim 30, wherein trusts and estates considerations comprise:
communicating intentions;
grantor and beneficiary mentoring;
selection of trustees and advisors; and
trustee and beneficiary relationships.

39. The method of claim 38, wherein grantor and beneficiary mentoring is omitted for families without heirs.

40. The method of claim 1, wherein surveying a plurality of considerations related to wealth management comprises:
identifying to what degree family members agree or disagrees that the plurality of considerations related to wealth management are important to the family members;
identifying to what degree family members agree or disagree that the plurality of considerations related to wealth are consistent with the family's current practices; and
identifying whether family members perceive the family's current practices as having a beneficial or detrimental impact on the family.

41. The method of claim 40, wherein surveying a plurality of considerations related to wealth management further comprises identifying contingent liabilities, wherein contingent liabilities are situations where according to the family members the current practice could be materially impacted by future changes.

42. The method of claim 1, wherein surveying a plurality of considerations related to wealth management further comprises defining family wealth objectives.

43. The method of claim 1, wherein surveying a plurality of considerations related to wealth management further comprises prioritizing the family wealth objectives.

44. The method of claim 1, wherein surveying a plurality of considerations related to wealth management further comprises preparing a series of reports based on the surveyed considerations.

45. The method of claim 1, wherein surveying a plurality of considerations related to wealth management further comprises creating a family balance sheet.

46. The method of claim 1, wherein the method steps are iterative.

47. The method of claim 1, wherein the strategic action plan is partially formulated at each step of the method.

48. A method for providing family wealth management services comprising the steps of:
collecting family information;
collecting information about legal entities where family members are involved;
performing a financial review;
performing an estate plan review;
performing a risk management assessment, wherein the assessment addresses exposure to future liability;
performing an at least one investment policy statement;
performing an investment portfolio review;
identifying personal values of family members;
compiling a shared values report for the family based on the personal values of family members;
drafting a family mission statement based on the shared values report;
surveying a plurality of considerations related to wealth management, wherein the plurality of considerations related to wealth management is not exclusively financial in nature, and wherein the plurality of considerations comprises considerations related to family cohesiveness, family governance, mentoring, philanthropy, strategic issues and wealth objectives, and trusts and estates;
establishing a family constitution;
creating family entities to support the family constitution;
developing a legacy;
engaging family members in family learning programs, wherein family learning programs are programs where family members develop skills for supervising family wealth; and
developing a family plan for wealth preservation during the course of performing the preceding steps.

49. The method of claim 48, wherein the financial review is a review of current financial situation and future savings and spending.

50. The method of claim 48, wherein the estate plan review is an illustration including financial projections, of estate plan based on assumed events.

51. The method of claim 48, wherein the risk management assessment addresses exposure to future liability.

52. The method of claim 51, wherein the risk management assessment further comprises a list of current insurance.

53. The method of claim 48, wherein the at least one investment policy statement comprises written policies that govern investment decisions.

54. The method of claim 48, wherein performing an investment portfolio review comprises preparing reports detailing performance and status of the investment portfolio.

55. The method of claim 48, wherein family information comprises historic and current information about members of the family.

56. The method of claim 55, wherein the historical and current information comprises a generational structure of the family, wherein the generational structure reflects data about individual family members and their relationships to each other.

57. The method of claim 48, wherein information about legal entities where family members are involved comprises information about trusts, individual retirement accounts, foundations, donor advised funds, family investment, vehicles, and family businesses.

58. The method of claim 48, wherein the shared values report comprises personal values that family members had in common with at least a majority of family members.

59. The method of claim 58, wherein personal values that family members had in common with at least a majority of family members comprise values that were selected at least two times by at least 50% of family members.

60. The method of claim 48 wherein compiling a shared values report for the family based on the personal values of family members, drafting a family mission statement based on the shared values report, establishing a family constitution, creating family entities to support the family constitution, and developing a legacy establish a family governance system.

61. The method of claim 48, wherein the mission statement guides family decisions and family interactions.

62. The method of claim 48, wherein the mission statement establishes direction of management of family wealth.

63. The method of claim 48, wherein the mission statement enables preservation and growth of family wealth for successive generations.

64. The method of claim 48, wherein family entities comprise:
family counsel; and
family board.

65. The method of claim 48, wherein the legacy is comprised of family legacy and social legacy.

66. The method of claim 65, wherein social legacy incorporates strategic philanthropy.

67. The method of claim 65, wherein family legacy incorporates the family constitution.

68. The method of claim 48, wherein the family learning programs are built on wherein the family learning programs are built on values of family members, dimensions of wellness of family members, and family business models.

69. The method of claim 48, wherein the plurality of considerations related to wealth management are recognized non-investment related practices that help sustain family and wealth.

70. The method of claim 48, wherein family cohesiveness considerations comprise:
family history;
family culture;
family mission statement;
shared values;
teamwork;
communication; and
member well-being.

71. The method of claim 48, wherein family governance considerations comprise:
family governance;
family meetings;
family policies;
conflict resolution; and
succession planning.

72. The method of claim 71, wherein succession planning is omitted for families without heirs.

73. The method of claim 48, wherein mentoring considerations comprise:
financial education;
parenting skills;
support for entrepreneurship;
family support network; and
money-related education.

74. The method of claim 73, wherein financial education, parenting skills, and support for entrepreneurship are omitted for families without heirs.

75. The method of claim 48, wherein philanthropy considerations comprise:
support for philanthropy;
shared philanthropy; and
strategic philanthropy.

76. The method of claim 48, wherein strategic issues and wealth objectives considerations comprise:
understanding of economics;
wealth objectives; and
planning for major life events.

77. The method of claim 48, wherein trusts and estates considerations comprise:
communication intentions;
grantor and beneficiary mentoring;
selection of trustees and advisors; and
trustee and beneficiary relationships.

78. The method of claim 77, wherein grantor and beneficiary mentoring is omitted for families without heirs.

79. The method of claim 48, wherein surveying a plurality of considerations related to wealth management comprises:
identifying to what degree family members agree or disagrees that the plurality of considerations related to wealth management are important to the family members;
identifying to what degree family members agree or disagree that the plurality of considerations related to wealth are consistent with the family's current practices; and
identifying whether family members perceive the family's current practices as having a beneficial or detrimental impact on the family.

80. The method of claim 79, wherein surveying a plurality of considerations related to wealth management further comprises identifying contingent liabilities, wherein contingent liabilities are situations where according to the family members the current practice could be materially impacted by future changes.

81. The method of claim 48, wherein surveying a plurality of considerations related to wealth management further comprises defining family wealth objectives.

82. The method of claim 48, wherein surveying a plurality of considerations related to wealth management further comprises prioritizing the family wealth objectives.

83. The method of claim 48, wherein surveying a plurality of considerations related to wealth management further comprises preparing a series of reports based on the surveyed considerations.

84. The method of claim 48, wherein surveying a plurality of considerations related to wealth management further comprises creating a family balance sheet.

85. The method of claim 48, wherein the method steps are iterative.

86. The method of claim 48, wherein the strategic action plan is partially formulated at each step of the method.

87. A method for providing wealth management services to a family comprising the steps of:
collecting family member information;
collecting information about legal entities where family members are involved;
assessing already-existing financial wealth management factors, wherein the already existing wealth management factors comprise financial plans, estate plans, risk assessments, and investment policies;
assessing non-financial wealth management considerations;
assessing family financial goals;
integrating family financial goals with the non-financial wealth management considerations;
establishing a family constitution;
developing a legacy; and
formulating a family plan for wealth preservation based on the integrated financial goals of the family and the non-financial wealth management considerations, wherein the family plan is a multi-generational plan.

88. The method of claim 87, wherein the non-financial wealth management considerations comprise:
personal values of the family members;
family shared values;
a mission statement; and
considerations related to family cohesiveness, family governance, mentoring, philanthropy, strategic issues and wealth objectives, and trusts and estates.

89. The method of claim 87, further comprising engaging family members in family learning programs, wherein family learning programs are programs where family members develop skills for supervising family wealth.
